(19) United States
(12) Patent Application Publication
(10) Pub. No.: US 2025/0343329 A1
(43) Pub. Date: Nov. 6, 2025

(54) ELASTICALLY DEFORMABLE BATTERY MODULE CONNECTOR SYSTEM

(71) Applicant: EATON INTELLIGENT POWER LIMITED, Dublin 4 (IE)

(72) Inventors: James Dawson, West Chicago, IL (US); Jason Degen, Plymouth, MI (US)

(21) Appl. No.: 18/862,351

(22) PCT Filed: May 2, 2023
(86) PCT No.: PCT/EP2023/025203

§ 371 Date: Nov. 1, 2024

Related U.S. Application Data
(60) Provisional application No. 63/337,596, filed on May 2, 2022.

(51) Int. Cl. H01M 50/503; B60L 50/64; H01M 50/505; H01M 50/526; H01R 35/02

(52) U.S. Cl. CPC H01M 50/503; H01M 50/505; H01M 50/526; H01R 35/02; B60L 50/64

(57) ABSTRACT

An elastically deformable connector system for use in connecting battery modules in a battery pack. The elastically deformable connector system comprising busbar assembly having a busbar with a plurality of individual conductors vertically arranged to provide a first peripheral portion, a second peripheral portion, and an elastically deformable intermediate portion located between the first and second peripheral portions. The busbar assembly also includes a first male connector assembly coupled to the first peripheral portion of the busbar, a second male connector assembly coupled to the second peripheral portion of the busbar, and a busbar housing that encloses a substantial extent of the busbar. Wherein after the busbar assembly is electrically connected to a pair of battery modules in the battery pack, the intermediate portion is configured to elastically deform to compensate for each of compression movement and expansion movement of the pair of battery modules.

### CROSS-REFERENCE TO RELATED APPLICATIONS

This application claims the benefit of U.S. Provisional Patent Application 63/337,596, the disclosure of which is hereby incorporated by reference in their entirety for all purposes.

### FIELD OF DISCLOSURE

The present disclosure relates to an elastically deformable connector system for use in connecting modules in a battery pack that is included in a power distribution system of a vehicle. The battery pack includes a plurality of battery modules that are electrically connected to one another using at least one elastically deformable connector system having: (i) a busbar with an elastically deformable intermediate portion located between peripheral connecting portions, and (ii) a busbar housing.

### BACKGROUND

Over the past several decades, the number of electrical components used in automobiles, and other on-road and off-road vehicles such as pick-up trucks, commercial vans and trucks, semi-trucks, motorcycles, all-terrain vehicles, and sports utility vehicles (collectively “motor vehicles”) has increased dramatically. Electrical components are used in motor vehicles for a variety of reasons, including but not limited to, monitoring, improving and/or controlling vehicle performance, emissions, safety and creates comforts to the occupants of the motor vehicles. Considerable time, resources, and energy have been expended to develop power distribution components that meet the varied needs and complexities of the motor vehicle market; however, conventional power distribution components suffer from a variety of shortcomings.

Motor vehicles are challenging electrical environments for both the electrical components and the connector assemblies due to a number of conditions, including but not limited to, space constraints that make initial installation difficult, harsh operating conditions, large ambient temperature ranges, prolonged vibration, heat loads, and longevity, all of which can lead to component and/or connector failure. For example, incorrectly installed connectors, which typically occur in the assembly plant, and dislodged connectors, which typically occur in the field, are two significant failure modes for the electrical components and motor vehicles. Each of these failure modes leads to significant repair and warranty costs. For example, the combined annual accrual for warranty by all of the automotive manufacturers and their direct suppliers is estimated to be between $50 billion and $150 billion, worldwide. In light of these challenging electrical environments, considerable time, money, and energy have been expended to find power distribution components that meet the needs of the markets. This disclosure addresses the shortcomings of conventional power distribution components. A full discussion of the features and advantages of the present disclosure is deferred to the following detailed description, which proceeds with reference to the accompanying drawings.

### SUMMARY

This disclosure generally relate to an elastically deformable connector system designed to electrically couple: (i) a first battery module within the plurality of battery modules to a second battery module within the plurality of battery modules, (ii) the first battery module within the plurality of battery modules to an extent of the battery pack housing, (iii) an extent of the battery pack housing to an extent of an external component, or (iv) an extent of a first external component to an extent of a second external component. The elastically deformable connector system is designed and configured to compensate for: (i) material conditions associated with the modules, battery pack, power distribution system and/or application, and/or (ii) dynamic movement of the battery modules caused by: (a) charging and discharging the battery modules, (b) aging of the battery modules, (c) changes in temperatures, including temperature changes of the modules, battery pack, power distribution system and/or application, (d) movement of the modules within the battery pack while using or operating the power distribution system and/or the application, (e) battery cell failures, and (f) other known reasons for the movement of the battery modules within the battery pack.

To compensate for the material conditions and/or dynamic movement of the battery modules, the disclosed elastically deformable battery module connector system includes a busbar with a plurality of individual conductors vertically arranged to provide a first peripheral portion, a second peripheral portion, and an elastically deformable intermediate portion located between the first and second peripheral portions. The busbar assembly also includes a first male connector assembly coupled to the first peripheral portion of the busbar, a second male connector assembly coupled to the second peripheral portion of the busbar, and a busbar housing that encloses a substantial extent of the busbar. Wherein after the busbar assembly is electrically connected to a pair of battery modules in the battery pack, the intermediate portion is capable of elastically deforming to compensate for each of compression movement and expansion movement of the pair of battery modules.

In another embodiment, the busbar includes a plurality of individual conductors that have undergone a fusion process to form a solid single conductor in select regions of the busbar, wherein said busbar includes a first peripheral portion, a second peripheral portion, and an elastically deformable intermediate portion located between the first and second peripheral portions. A majority of the elastically deformable intermediate portion is not coplanar with either of the first or second peripheral portions and instead includes a curvilinear extent. This configuration of the elastically deformable intermediate portion allows an activation force that is less 50 Newtons or less to deform its total length by over deform over 5%. As such, the connector system improves the reliability, performance and operating life of the modules, battery pack, power distribution system and application.

### BRIEF DESCRIPTION OF THE DRAWINGS

The accompanying drawings or figures, which are included to provide further understanding and are incorporated in and constitute a part of this specification, illustrate disclosed embodiments and together with the description serve to explain the principles of the disclosed embodiments. In the Figures, like reference numerals refer to the same or similar elements throughout the Figures. In the drawings:

FIG. 1 is a perspective view of a first embodiment of an elastically deformable battery module connector system, wherein an extent of the busbar housing has been omitted to show the busbar;

FIG. 2 is a top view of a plurality of electrical conductors that have been cut to the specified length;

FIG. 3 is a zoomed-in view of FIG. 2 showing the staggered end configuration of the plurality of electrical conductors;

FIGS. 4 and 5 are perspective views of the plurality of electrical conductors shown in FIG. 2, which are in the process of being selectively welded together using a laser welding machine to form a busbar with a first connecting segment;

FIG. 6 is a top view of the busbar after it has undergone the selective welding process shown in FIGS. 4-5;

FIG. 7 is a bottom view of the busbar of FIG. 6;

FIG. 8 is a first side view of the busbar of FIG. 6;

FIG. 9 is a second side view of the busbar of FIG. 6;

FIG. 10 is a first end view of the busbar of FIG. 6;

FIG. 11 is a second end view of the busbar of FIG. 6;

FIG. 12 is a bottom view of the busbar of FIG. 6;

FIG. 13 is a cross-sectional view of view of the busbar taken along line 13-13 of FIG. 12 showing an unfused segment having an unsolidified region;

FIG. 14 is a bottom view of the busbar of FIG. 6;

FIG. 15 is a cross-sectional view of view of the busbar taken along line 15-15 of FIG. 14 showing a fused segment including: (i) two laterally solidified regions, and (ii) an unsolidified region;

FIG. 16 is a bottom view of the busbar of FIG. 6;

FIG. 17 is a cross-sectional view of view of the busbar taken along line 17-17 of FIG. 14 showing a fused segment including a fully solidified region;

FIG. 18 is a perspective view of the busbar shown in FIGS. 6-11, wherein the busbar has undergone a process to form an elastically deformable intermediate portion of the busbar;

FIG. 19 is a perspective view of the busbar of FIG. 18, wherein the second end of the busbar is in the process of being selectively welded together using a laser welding machine to form a second connecting segment;

FIG. 20 is a perspective view of the busbar after it has undergone the selective welding process shown in FIG. 19, wherein said busbar is configured to be integrated into the elastically deformable battery module connector system of FIG. 1;

FIG. 21 is a side view of the busbar of FIG. 20;

FIG. 22 is a bottom view of the busbar of FIG. 20;

FIG. 23 is an end view of the busbar of FIG. 20;

FIG. 24 is a top view of the busbar of FIG. 20;

FIG. 25 is an exploded view of a male conductor assembly of the elastically deformable battery module connector system of FIG. 1, wherein the male conductor assembly includes a male terminal assembly with a male terminal body, a spring member, and a male terminal housing;

FIG. 26 is a perspective view of the spring member of the male terminal assembly of FIG. 25;

FIG. 27 is a perspective view of the male terminal body of the male terminal assembly of FIG. 25;

FIG. 28 is a perspective view of the male terminal assembly in a partially assembled state S_{PA};

FIG. 29 is a side view of the male terminal assembly in a fully assembled state S_{FA};

FIG. 30 is a cross-sectional view of the male terminal assembly taken along line 30-30 of FIG. 29;

FIG. 31 is a top perspective view of an elastically deformable electrical conductive assembly of the elastically deformable battery module connector system, wherein the elastically deformable electrical conductive assembly includes opposed male terminal assemblies of FIG. 29 coupled to the busbar of FIGS. 20-24;

FIG. 32 is a side view of the elastically deformable electrical conductive assembly of FIG. 31;

FIG. 33 is a top view of the elastically deformable electrical conductive assembly of FIG. 31;

FIG. 34 is an end view of the elastically deformable electrical conductive assembly of FIG. 31;

FIG. 35 is a bottom view of the elastically deformable electrical conductive assembly of FIG. 31;

FIG. 36 is a perspective view of the elastically deformable battery module connector system, where the busbar housing has been omitted to show an extent of the busbar;

FIG. 37 is a side view of an extent of the elastically deformable battery module connector system of FIG. 36;

FIG. 38 is a cross-sectional view of the elastically deformable battery module connector system taken along line 38-38 of FIG. 37;

FIG. 39 is a top view of an extent of the elastically deformable battery module connector system of FIG. 36;

FIG. 40 is a cross-sectional view of the elastically deformable battery module connector system taken along line 40-40 of FIG. 39;

FIG. 41 is a perspective view of the busbar housing, wherein said housing is formed from first and second portions that are removably coupled together;

FIG. 42 is a side view of the busbar housing of FIG. 41;

FIG. 43 is a bottom view of the busbar housing of FIG. 41;

FIG. 44 is an end view of the busbar housing of FIG. 41;

FIG. 45 is a top view of the busbar housing of FIG. 41;

FIG. 46 is a perspective view of the first component of the busbar housing of FIG. 41;

FIG. 47 is a side view of the first component of the busbar housing of FIG. 46;

FIG. 48 is a perspective view of the elastically deformable battery module connector system;

FIG. 49 is a side view of the elastically deformable battery module connector system of FIG. 48;

FIG. 50 is a top view of the elastically deformable battery module connector system of FIG. 48;

FIG. 51 is an end view of the elastically deformable battery module connector system of FIG. 48;

FIG. 52 is a bottom view of the elastically deformable battery module connector system of FIG. 48;

FIG. 53 is a perspective view of a first embodiment of a battery pack that includes a plurality of battery modules that are electrically coupled together with a plurality of elastically deformable battery module connector systems;

FIG. 54 is a top view of the first embodiment of the battery pack of FIG. 53;

FIG. 55 is a perspective view of two battery modules and one elastically deformable battery module connector system that have been isolated from the battery pack shown in FIGS. 53 and 54;

FIG. 56 is an elevated perspective view of the battery modules of FIG. 55 that are coupled together by the elastically deformable battery module connector system, wherein the battery module housing has been omitted to reveal the battery cells and electrical transport structure;

FIG. 57 is a side view of the battery modules of FIG. 56 that are coupled together by the elastically deformable battery module connector system;

FIG. 58 is a top view of the battery modules of FIG. 56 that are coupled together by the elastically deformable battery module connector system;

FIG. 59 is a cross-sectional view of the battery modules and the elastically deformable battery module connector system taken along line 59-59 of FIG. 56;

FIG. 60 is a zoomed-in view of FIG. 59, showing the interface between the battery module and the elastically deformable battery module connector system;

FIG. 61 is a zoomed-in perspective cross-sectional view of the battery modules and the elastically deformable battery module connector system taken along line 61-61 of FIG. 56, showing the interface between the battery module and the elastically deformable battery module connector system;

FIG. 62 is a cross-sectional view of the battery modules of the battery modules and the elastically deformable battery module connector system taken along line 62-62 of FIG. 58, wherein the battery cells are at a 50% charge level and the elastically deformable battery module connector system is in a neutral state S_{N};

FIG. 63 is a zoomed-in view of FIG. 62, showing the elastically deformable battery module connector system in a neutral state S_{N};

FIG. 64 is a schematic view of the expansion and contraction of the cylindrical battery cells due to charging and discharging of said battery cells;

FIG. 65 is a schematic view of the irreversible expansion of the cylindrical battery cells due to aging of said battery cells;

FIG. 66 is a zoomed-in cross-sectional view of the battery modules of the battery modules and the elastically deformable battery module connector system taken along line 66-66 of FIG. 58, wherein the battery cells are at a 100% charge level and the elastically deformable battery module connector system is in a compressed state S_{C};

FIG. 67 is a zoomed-in cross-sectional view of the battery modules of the battery modules and the elastically deformable battery module connector system taken along line 67-67 of FIG. 58, wherein the battery cells are at a 0% charge level and the elastically deformable battery module connector system is in an extended state S_{E};

FIG. 68 is a zoomed-in view of FIG. 62 showing the elastically deformable battery module connector system in the compressed state S_{C};

FIG. 69 is a zoomed-in view of FIG. 66 showing the elastically deformable battery module connector system in the neutral state S_{N};

FIG. 70 is a zoomed-in view of FIG. 67 showing the elastically deformable battery module connector system in the extended state S_{E};

FIG. 71 is a zoomed-in perspective cross-sectional view of the battery modules and the elastically deformable battery module connector system taken along line 71-71 of FIG. 56, showing the elastically deformable battery module connector system absorb lateral movement of between the battery modules;

FIG. 72 is a side view of an extent of the battery module and an extent of the elastically deformable battery module connector system;

FIG. 73 is a cross-sectional view of the extent of the battery module and the extent of the elastically deformable battery module connector system taken along line 73-73 of FIG. 72;

FIG. 74 is a perspective view of a second embodiment of two battery modules that are coupled together by a second embodiment of the elastically deformable battery module connector system;

FIG. 75 is a exploded view of a battery module shown in FIG. 74;

FIG. 76A is a cross-sectional view of the battery modules and the elastically deformable battery module connector system taken along line 76A-76A of FIG. 74, wherein the battery cells are at a 50% charge level and the elastically deformable battery module connector system is in a neutral state S_{N};

FIG. 76B is a zoomed-in view of FIG. 76A, showing the elastically deformable battery module connector system in a neutral state S_{N};

FIG. 77 is a schematic view of the expansion and contraction of the pouch battery cells due to charging and discharging of said battery cells;

FIG. 78 is a schematic view of the irreversible expansion of the pouch battery cells due to aging of said battery cells;

FIG. 79 is a zoomed-in cross-sectional view of the battery modules of the battery modules and the elastically deformable battery module connector system taken along line 79-79 of FIG. 74, wherein the battery cells are at a 100% charge level and the elastically deformable battery module connector system is in a compressed state S_{C};

FIG. 80 is a zoomed-in cross-sectional view of the battery modules of the battery modules and the elastically deformable battery module connector system taken along line 80-80 of FIG. 74, wherein the battery cells are at a 0% charge level and the elastically deformable battery module connector system is in an extended state S_{E};

FIG. 81 is a zoomed-in view of FIG. 79 showing the elastically deformable battery module connector system in the compressed state S_{C};

FIG. 82 is a zoomed-in view of FIG. 76A, B showing the elastically deformable battery module connector system in the neutral state S_{N};

FIG. 83 is a zoomed-in view of FIG. 80 showing the elastically deformable battery module connector system in the extended state S_{E};

FIG. 84 is a perspective view of a third embodiment of two battery modules that are coupled together by the first embodiment of the elastically deformable battery module connector system;

FIG. 85 is a perspective view of the battery modules of FIG. 84 that are coupled together by the elastically deformable battery module connector system, wherein the battery module housing is transparent to reveal the battery cells and electrical transport structure;

FIG. 86 is a cross-sectional view of the battery modules of the battery modules and the elastically deformable battery module connector system taken along line 86-86 of FIG. 85, wherein the battery modules are in a nominal material condition and the elastically deformable battery module connector system is in a neutral state S_{N};

FIG. 87 is a cross-sectional view of the battery modules of the battery modules and the elastically deformable battery module connector system taken along line 87-87 of FIG. 85, wherein the battery modules are in a minimum material condition and the elastically deformable battery module connector system is in a compressed state S_{C};

FIG. 88 is a cross-sectional view of the battery modules of the battery modules and the elastically deformable battery module connector system taken along line 88-88 of FIG. 85, wherein the battery modules are in a maximum material condition and the elastically deformable battery module connector system is in an extended state S_{E};

FIGS. 89-102 show alternative configurations of the busbar that are configured to be integrated into the elastically deformable battery module connector system, wherein each busbar includes at least one elastically deformable segment;

FIG. 103 is a bottom perspective view of a fourth embodiment of the elastically deformable battery module connector system;

FIG. 104 is a top perspective view of the fourth embodiment of the elastically deformable battery module connector system of FIG. 103;

FIGS. 105-109 show alternative configurations of the male terminal assemblies that may be used in connection with the elastically deformable battery module connector system;

FIG. 110 is a perspective view of a second embodiment of a battery pack installed within a skateboard mounting platform of a vehicle, wherein said battery pack includes a plurality of battery modules that are electrically coupled together with a plurality of elastically deformable battery module connector systems;

FIG. 111 is a perspective view of a vehicle that includes the skateboard mounting platform of FIG. 110;

FIG. 112 is a perspective view of a passenger bus including a third embodiment of a battery pack having a plurality of elastically deformable battery module connector systems that couple the battery modules to each other;

FIG. 113 is a perspective view of a large ship including a fourth embodiment of a battery pack having a plurality of elastically deformable battery module connector systems that couple the battery modules to each other; and

FIG. 114 is a perspective view of a ship including a fifth embodiment of a battery pack having a plurality of elastically deformable battery module connector systems that couple the battery modules to each other.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well-known methods, procedures, components, and/or circuitry have been described at a relatively high-level, without detail, in order to avoid unnecessarily obscuring aspects of the present teachings.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspects of the disclosed concepts to the embodiments illustrated. As will be realized, the disclosed methods and systems are capable of other and different configurations and several details are capable of being modified all without departing from the scope of the disclosed methods and systems. For example, one or more of the following embodiments, in part or whole, may be combined consistently with the disclosed methods and systems. Accordingly, the drawings and detailed descriptions are to be regarded as illustrative in nature, not restrictive or limiting.

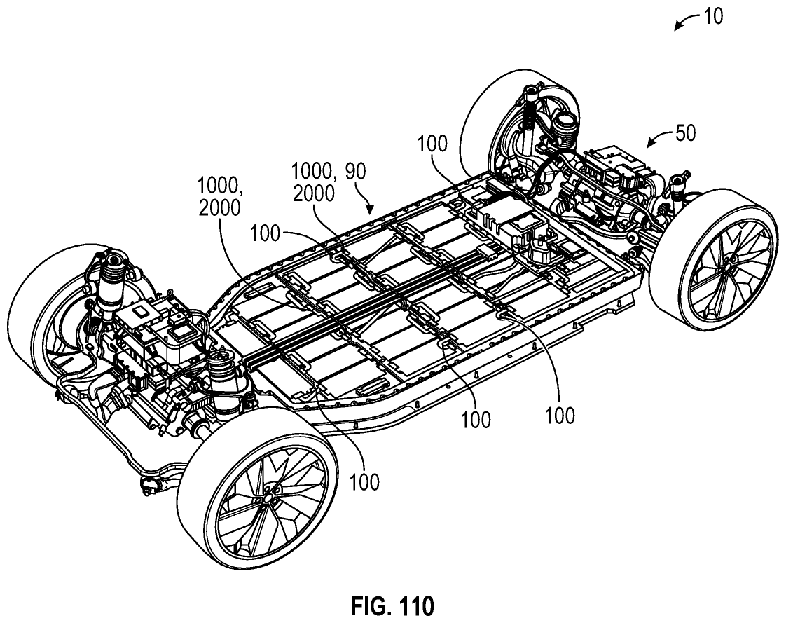

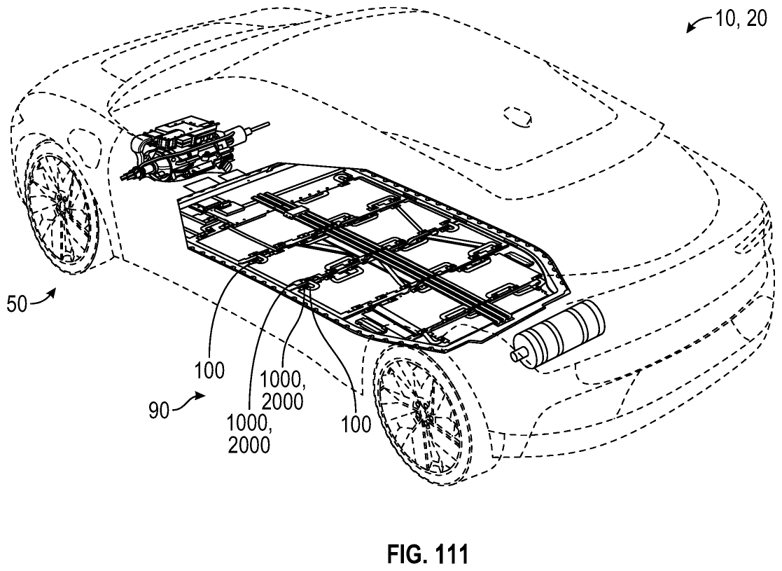

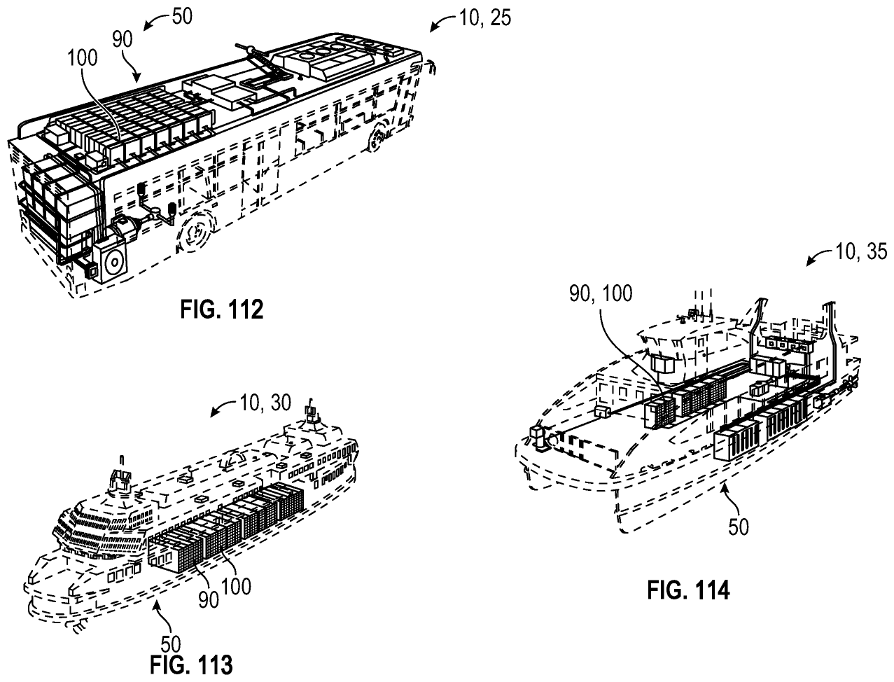

For background and context, FIGS. 110-114 show various products and applications 10 having at least one power distribution system 50. The applications 10 include, but are not limited to: an airplane, motor vehicle 20 (FIG. 111), a military vehicle (e.g., tank, personnel carrier, heavy-duty truck, and troop transport), a bus 25 (FIG. 112), a locomotive, a tractor, a bulldozer, an excavator, a tractor, marine vessels (e.g., a boat, cargo ship, tanker, a submarine, passenger ship 30 (FIGS. 113 and 114), tanker, sailing yacht), mining equipment, forestry equipment, agricultural equipment (e.g., tractor, cutters, planters, combines, threshers, harvesters), telecommunications hardware (e.g., server), a power storage system (e.g., backup power storage), renewable energy hardware (e.g., wind turbines and solar cell arrays), a 24-48 volt system, for a high-power application, for a high-current application, for a high-voltage application. In these applications 10, the power distribution system 50 is configured to meet industry standards, production, and performance requirements.

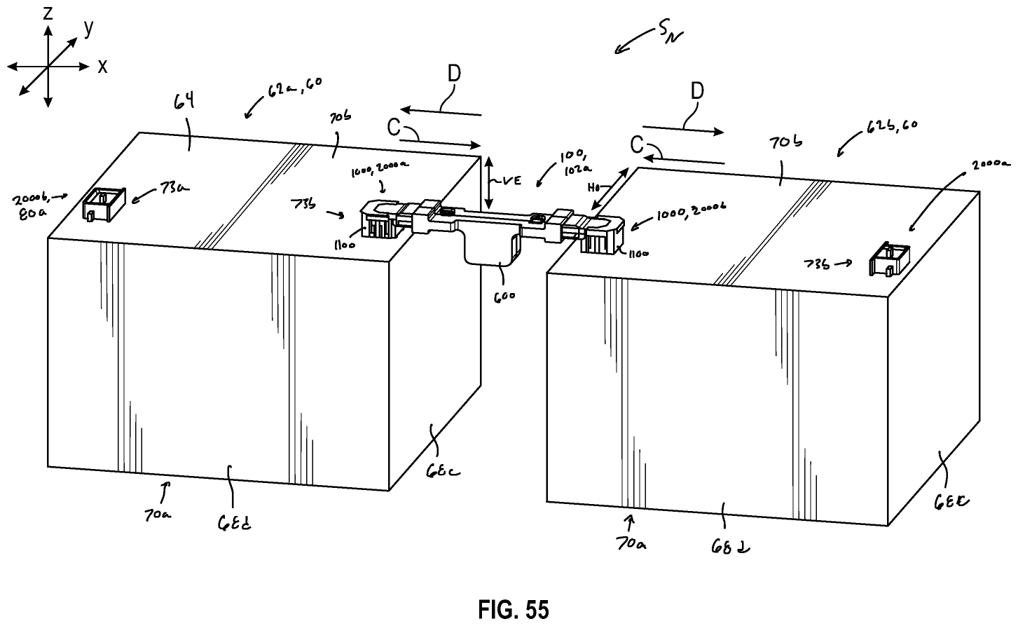

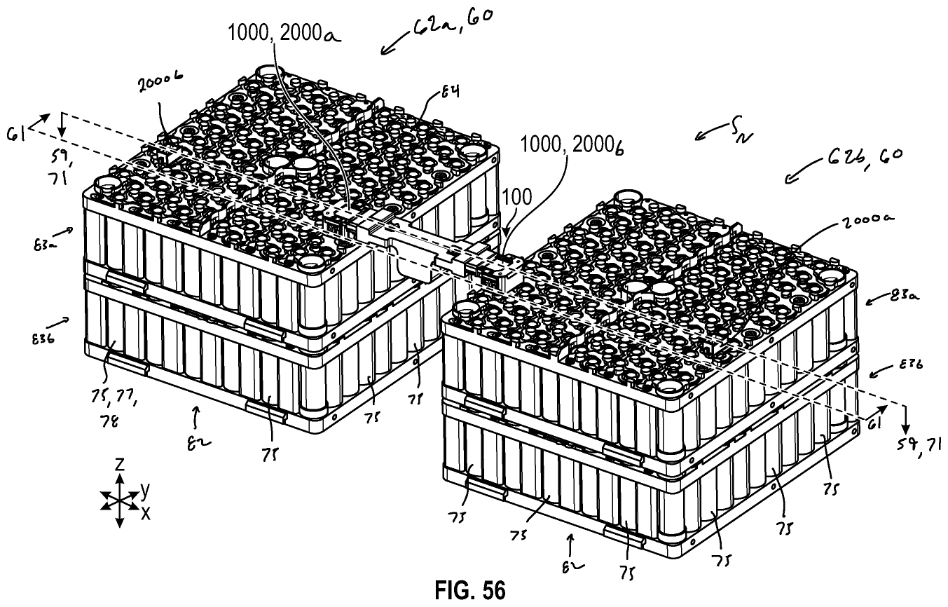

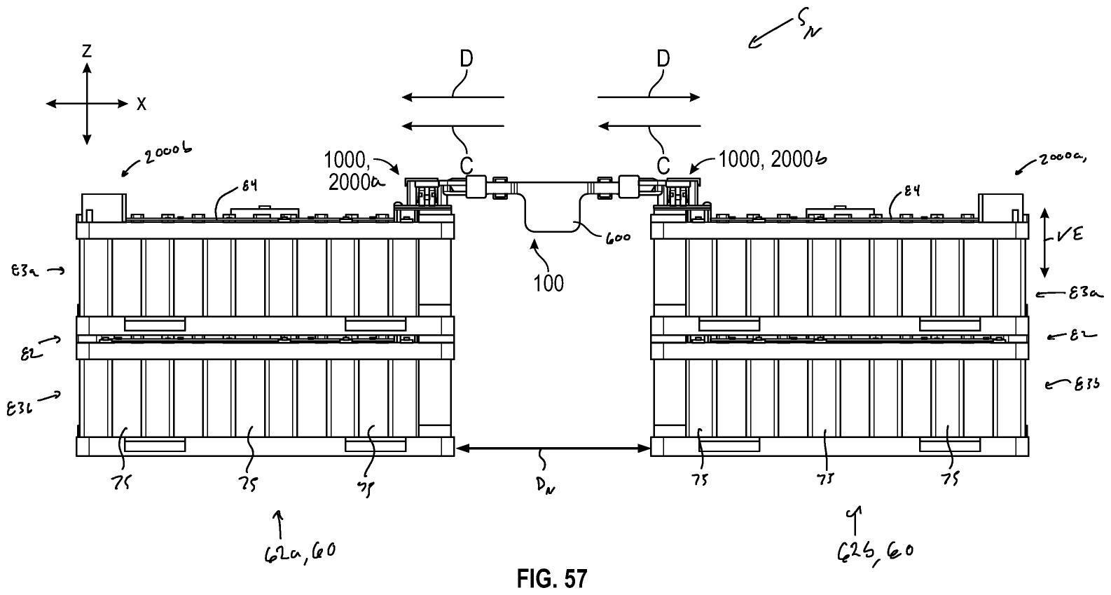

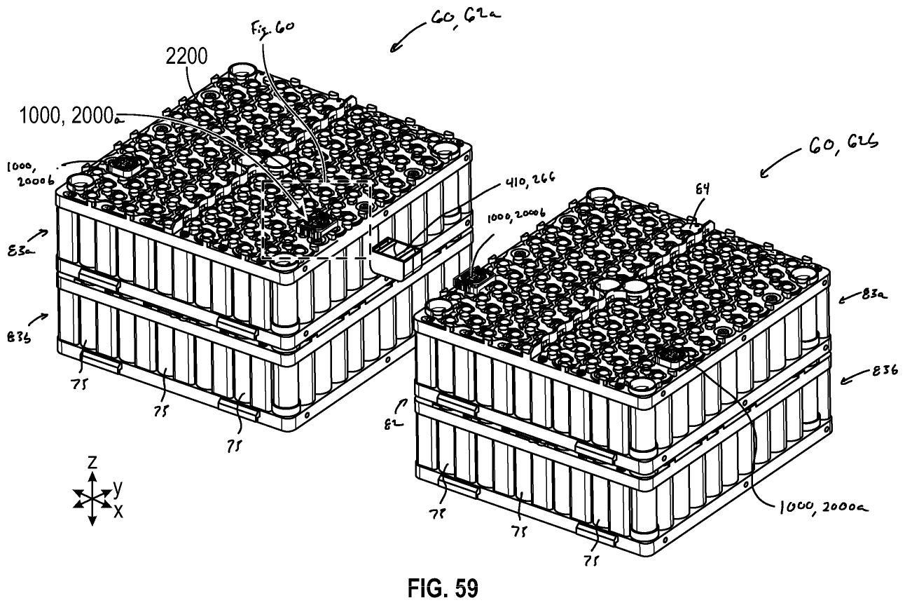

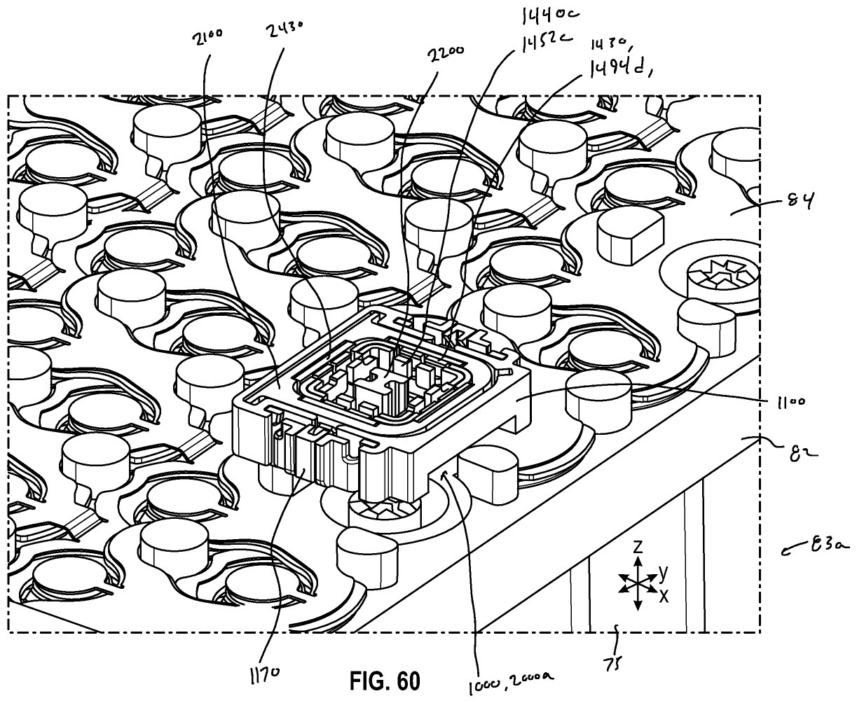

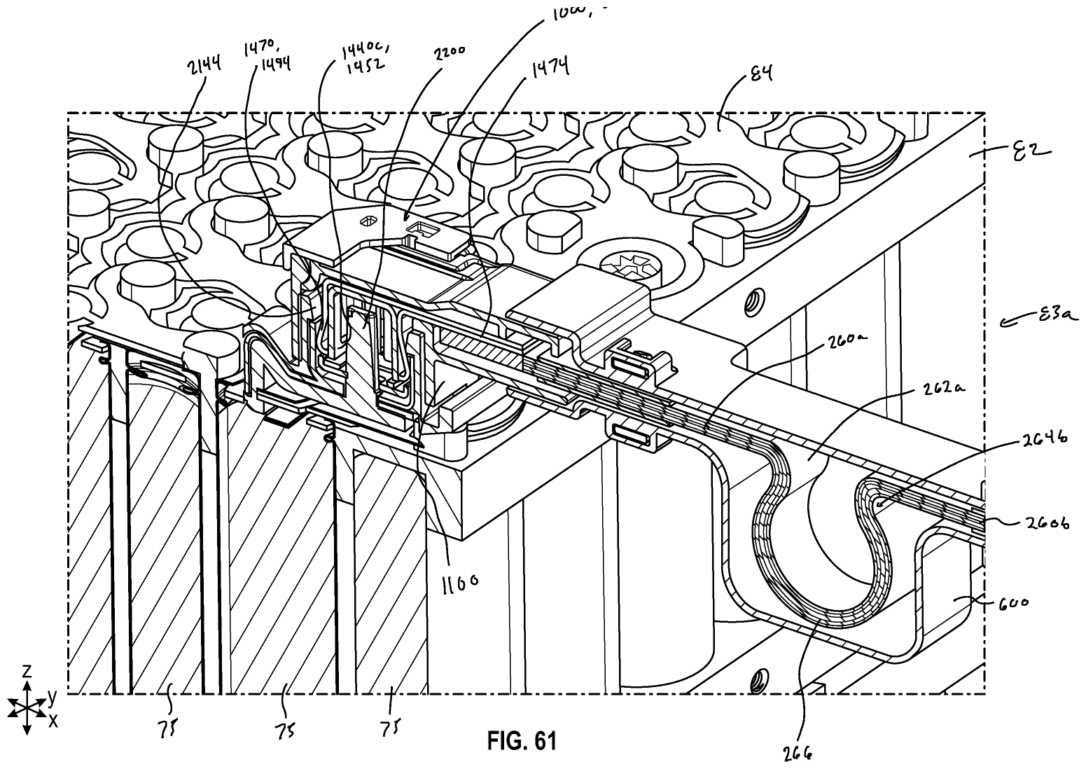

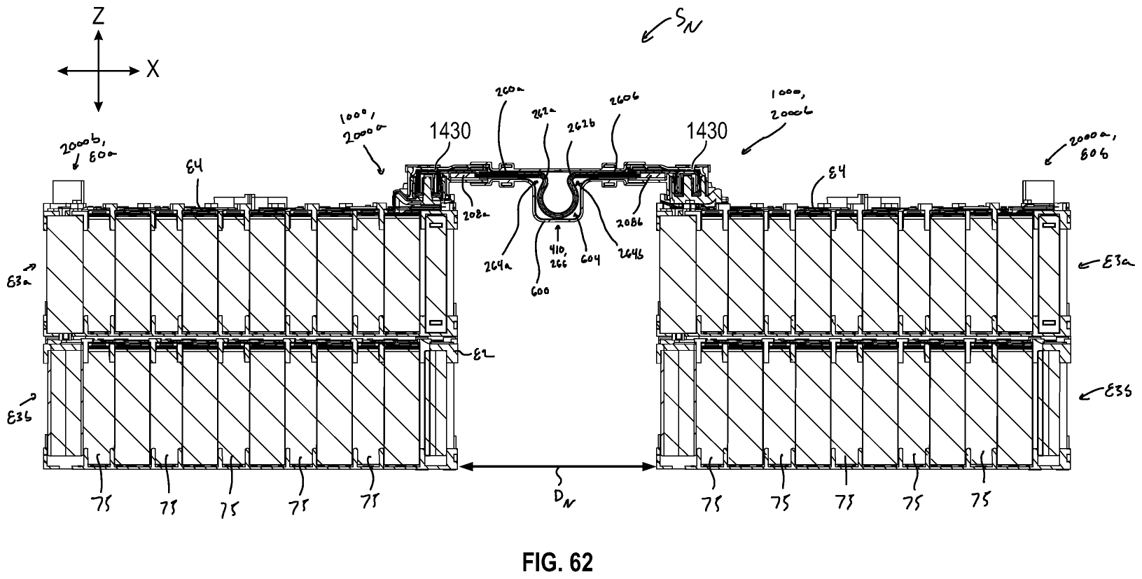

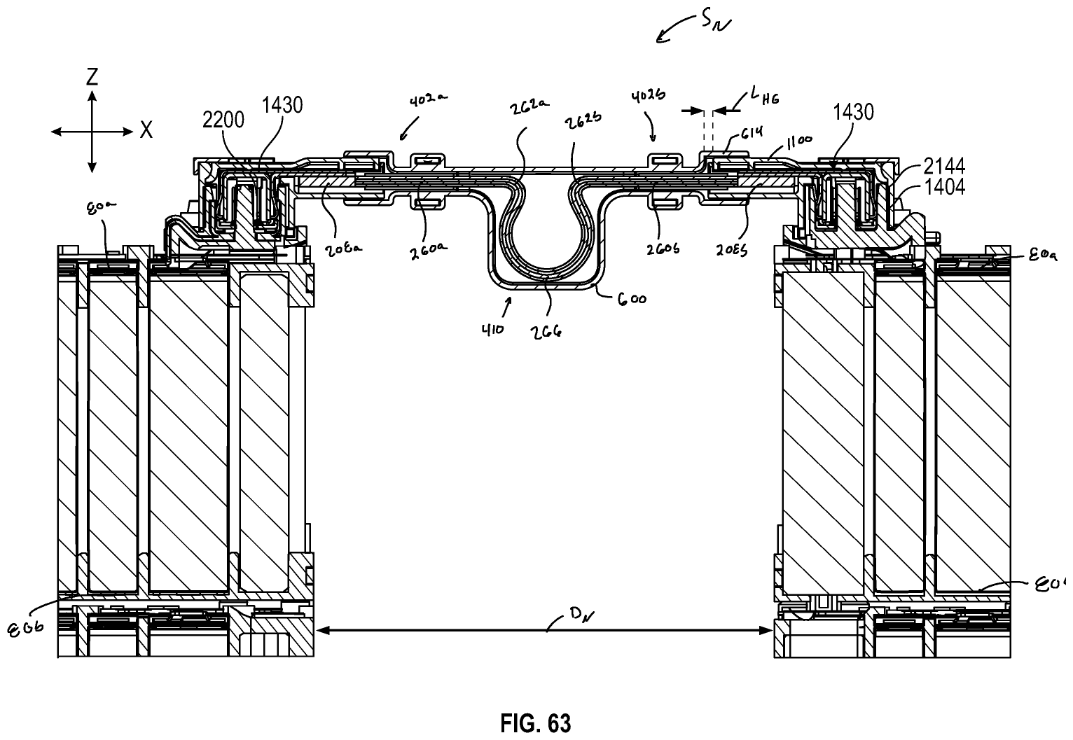

Each power distribution system 50 includes a battery pack 90 having: (i) a plurality of battery modules 60, and (ii) at least one elastically deformable battery module connector system 100 that electrically couples: (a) a first battery module 62a within the plurality of battery modules 60 to a second battery module 62b within the plurality of battery modules 60, (b) the first battery module 62a within the plurality of battery modules 60 to an extent of the battery pack housing 92, (c) an extent of the battery pack housing 92 to an extent of an external component, or (d) an extent of a first external component to an extent of a second external component. As explained in detail below, the elastically deformable battery module connector system 100 is configured to compensate for: (i) material conditions associated with the modules 60, battery pack 90, power distribution system 50 and/or application 10, and/or (ii) dynamic movement of the battery modules 60 caused by: (a) charging and discharging the battery modules 60, (b) aging of the battery modules 60, (c) changes in temperatures, including temperature changes of the modules 60, battery pack 90, power distribution system 50 and/or application 10, (d) movement of the modules 60 within the battery pack 90 while using or operating the power distribution system 50 and/or the application 10—such as the bus 25 (see FIG. 112) driving on a street having numerous potholes or a ship 30 (see FIG. 113) sailing in rough or choppy water that causes the ship 30 to pitch, heave or maneuver aggressively, (e) battery cell failures, and (f) other known reasons for the movement of the battery modules 60 within the battery pack 90. It should be understood that the material conditions and/or dynamic movement of the battery modules 60 can occur in all directions (i.e., X, Y, Z, and rotational). For example, the dynamic movement of the battery modules 60 in FIG. 55-70: (i) include expansion and/or contraction in the X-Y plane due to movement of lithium ions within the individual battery cells 75, and (ii) may include expansion and/or contraction in the X-Z or the Y-Z planes due to CTE or other known reasons.

To compensate for the material conditions and/or dynamic movement of the battery modules 60, the disclosed elastically deformable battery module connector system 100 includes a busbar 200 with an elastically deformable intermediate portion 410. This elastically deformable intermediate portion 410 allows for the system 100 to: (i) be compressed an appreciable amount—namely, up to 4 mm—from the unstressed or neutral state S_{N}, (ii) be expanded an appreciable amount-namely, up to 4 mm from the unstressed or neutral state S_{N}, and (iii) adjust to minor displacements in other planes (e.g., X-Z plane or the Y-Z). Because the battery module connector system 100 is designed and configured to allow and accommodate the material conditions and/or dynamic movement of the battery modules 60, the connector system 100 minimizes, and potentially eliminates, failure modes that could damage or reduce the performance of the power distribution system 50, the modules 60 and/or the battery pack 90. Thus, the connector system 100 improves the reliability, performance and operating life of the modules 60 and the battery pack 90.

Accordingly, the above benefits of the disclosed connector system 100 are to be regarded as illustrative in nature, not restrictive or limiting. As such, other benefits may be disclosed within the pictorial or written disclosure contained herein or may be known to one of skill in the art based on the pictorial or written disclosure.

Numerous terms are introduced and utilized in this Application and are defined below. While some of the following terms overlap or are not mutually exclusive of other terms, the following provides a general organizational hierarchy, the terms “busbar” and “bar” is located at a top level of the hierarchy, the terms “end(s),” “end sector(s),” “central,” and “central sector(s)” are located at an upper middle level of the hierarchy, the terms “portion(s),” “peripheral portion(s)”, and “intermediate portion” are located at a lower middle level of the hierarchy, the terms “zone(s)” are located a lower level of the hierarchy, and the term “region(s)” is located at a lowest level of the hierarchy.

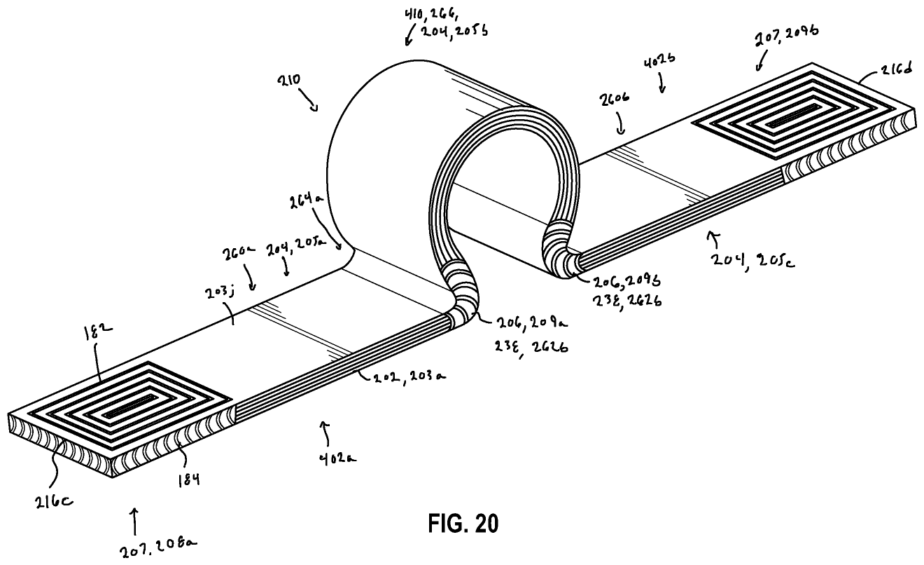

The term “busbar” means at least one conductor that extends from a first end edge to a second end edge and can carry electrical current from a first location to a second location. For example, FIG. 20 shows a perspective view of the busbar 200.

The term “end sector” is an extent of the busbar designed to facilitate the coupling of the busbar 200 to an external device or component.

The term “central sector” is an extent of the busbar that extends between the end sectors 207 of the busbar 200. It should be understood that a single conductor 202 of the busbar 200 spans from a first end sector 208a, across the central sector 210, and to a second end sector 208b. In other words, before any modifications of the conductor 202, the end sectors 208a, 208b of the conductor 202 are integrally formed with the central sector 210 of the conductor 202. Stated another way, the end sectors 208a, 208b of the conductor 202 are not separate structures that are coupled to the central sector 210 of the conductor 202 using a weldment, fusion, or securement process.

The term “peripheral portion” is an extent of the busbar designed to position the intermediate portion in a location between either: (i) a pair of battery modules, (ii) a battery module and an extent of the battery pack housing, (iii) an extent of the battery pack housing and an extent of an external component, (iv) a pair of external components.

The term “intermediate portion” is an extent of the busbar that extends between the peripheral portions 402a, 402b of the busbar 200 and is designed to be elastically deformable.

The term “segment” is an extent of the central sector of the busbar that receives either: (i) a segment fusion pattern, or (ii) lacks a segment fusion pattern. It should be understood that adjoining segments of a single conductor of the busbar are integrally formed with one another and are not secured to one another using a weldment, fusion, or securement process. It should also be understood that adjoining busbar segments typically have different mechanical property (e.g., different Young's modulus).

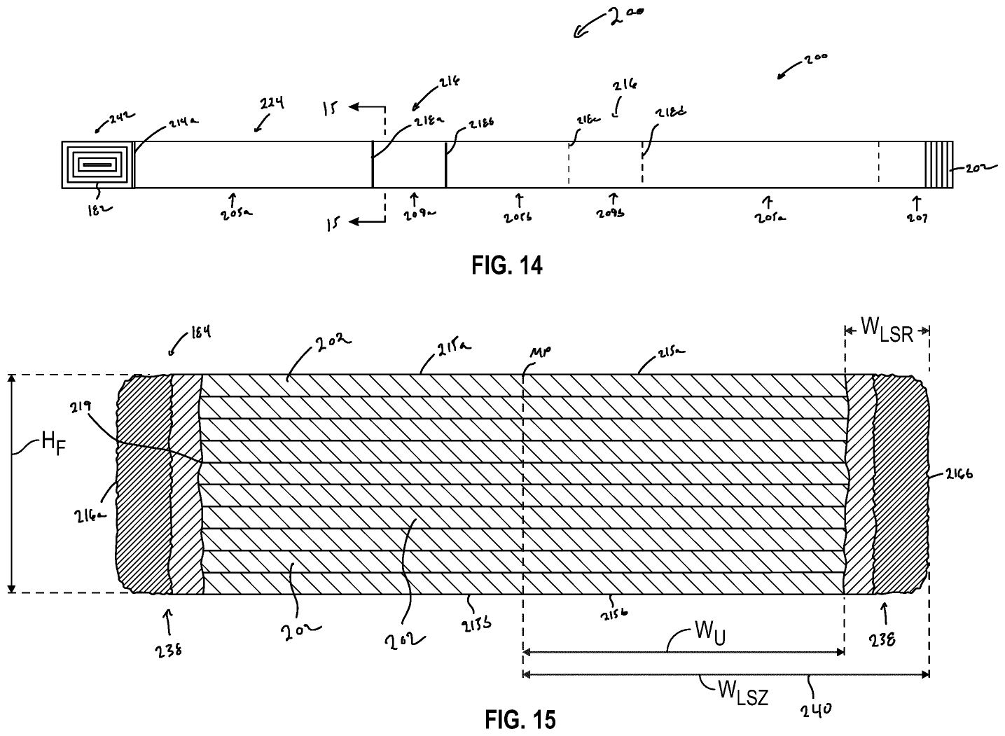

The term “fused segment” is an extent of the busbar that contains at least one of: (i) a partially solidified region, (ii) a laterally solidified region, or (iii) a fully solidified region. The fused segment may also include an unsolidified region. For example, FIGS. 14-17 shows fused segments 206 that includes: (i) unsolidified regions 230, and (ii) laterally solidified regions 238.

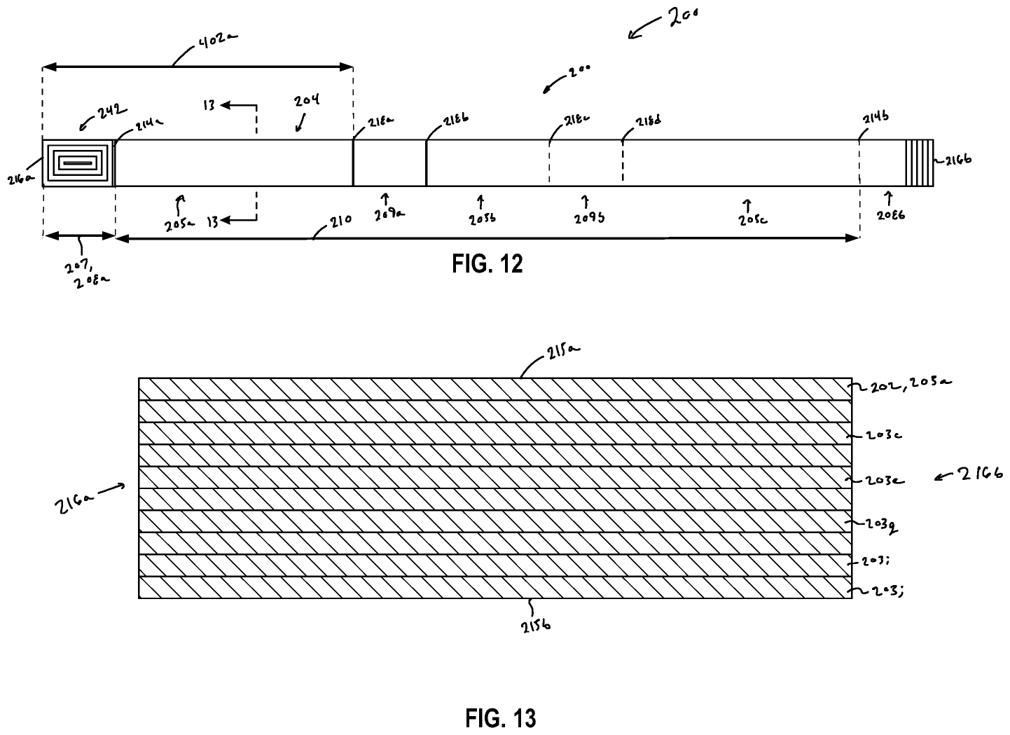

The term “unfused segment” is an extent of the busbar that only contains an unsolidified or unfused distinct region(s) of conductors. Thus, the unfused segment does not contain: (i) a partially solidified region, (ii) a limitedly or laterally solidified region, or (iii) a fully solidified region. For example, FIGS. 12-13 show the unfused segment 204 of the central sector 210 of the busbar 200, the unfused segment 204 having an unsolidified region 230 with distinct, unfused conductors 202.

The term “partial solidification zone” is an area of the fused segment 206 of the central sector 210 of the busbar, where the zone: (i) extends, in the fused segment, from the lowermost or bottom conductor to the uppermost or top conductor, and (ii) includes a partially solidified region.

The term “partially solidified region” means an area of the partial solidification zone of the busbar that has undergone a surface-based fusion process (e.g., vertically oriented, partial penetration weldment process 182). This surface-based fusion process combines or fuses all extents of conductors in this partially solidified region to form a single consolidated conductor. A significant (e.g., approximately 70%) number of the conductors 202 in the partially solidified zone are combined or fused into a single consolidated conductor to form a partially solidified region. In contrast, a lesser (e.g., approximately 30%) number of the conductors 202 in the partial solidification zone and beyond the partially solidified region remain as individual, distinct conductors 202—meaning that they are not combined or fused into a single combined conductor—in an unsolidified region 230.

The term “partial solidification volume” is a volume of the central sector 210 of the busbar 200, where the volume: (i) extends in the fused segment from the lowermost or bottom conductor to the uppermost or top conductor, (ii) along the entire length of the fused segment 206, and (iii) has a width that encapsulates a partially solidified volume.

The term “partially solidified volume” means an extent of the partial solidification volume of the busbar that has undergone a surface-based fusion process (e.g., vertically oriented partial penetration weldment process 182). This surface-based fusion process combines or fuses all extents of conductors in this partially solidified volume to form a single consolidated conductor.

The term “limited solidification zone” is an area of the fused segment 206 of the busbar, where the zone: (i) extends between: (a) a midpoint or middle of the width or depth as defined between the outermost edges of the fused segment, and (b) one of the outermost edges of the fused segment 206, and (ii) includes laterally solidified region. For example, FIGS. 14-15 shows a limited solidification zone 240 that extends between the lateral edge 216b and the midpoint MP of the busbar 200, which includes an extent that has undergone a lateral partial penetration weldment process 184 or a cold forming process.

The term “laterally solidified region” means an area of the limited solidification zone of the busbar that has undergone an edge-based fusion process (e.g., a lateral partial penetration weldment process 184 or a cold forming process). This edge-based fusion process combines or fuses all extents of conductors in this laterally solidified region to form a single consolidated conductor. For example, FIGS. 14-15 show the laterally solidified region 238: (i) adjacent to the unsolidified region 230, both of which are located in the limited solidification zone 240 of the fused segment 206 of the central sector 210 of the busbar 200, and (ii) extending from the lowermost or bottom conductor to the uppermost or top conductor. A minor extent (e.g., approximately 5%) of the busbar 200 in the limited solidification zone 240 are combined or fused into a single consolidated conductor to form a laterally solidified region 238. In contrast, a major extent (e.g., approximately 95%) of the busbar 200 in the limited solidification zone 240 and beyond the laterally solidified region 238 remain as individual, distinct conductors 202—meaning that they are not combined or fused into a single combined conductor—in an unsolidified region 230.

The term “limited solidification volume” is a volume of the fused segment 206 of the busbar, where that volume: (i) extends between: (a) a midpoint or middle of the width or depth as defined between the outermost edges of the fused segment 206, and (b) one of the outermost edges of the fused segment 206, (ii) along the entire length of the fused segment 206, and (ii) has a width that encapsulates a laterally solidified region.

The term “laterally solidified volume” means a volume of the limited solidification volume of the busbar that has undergone an edge-based fusion process (e.g., a lateral partial penetration weldment process 184 or a cold forming process). This edge-based fusion process combines or fuses all extents of conductors in this laterally solidified volume to form a single consolidated conductor.

The term “unsolidified region” means an area of the busbar that has not undergone a weldment process 180 to combine or fuse any of the conductors in that region of the busbar. Likewise, term “unsolidified volume” means a volume of the busbar that has not undergone a weldment process to combine or fuse any of the conductors in that volume of the busbar 200. As such, all of the conductors 202 located in an unsolidified region 230 remain as individual, discrete conductors. For example, FIG. 13 shows an unsolidified region 230.

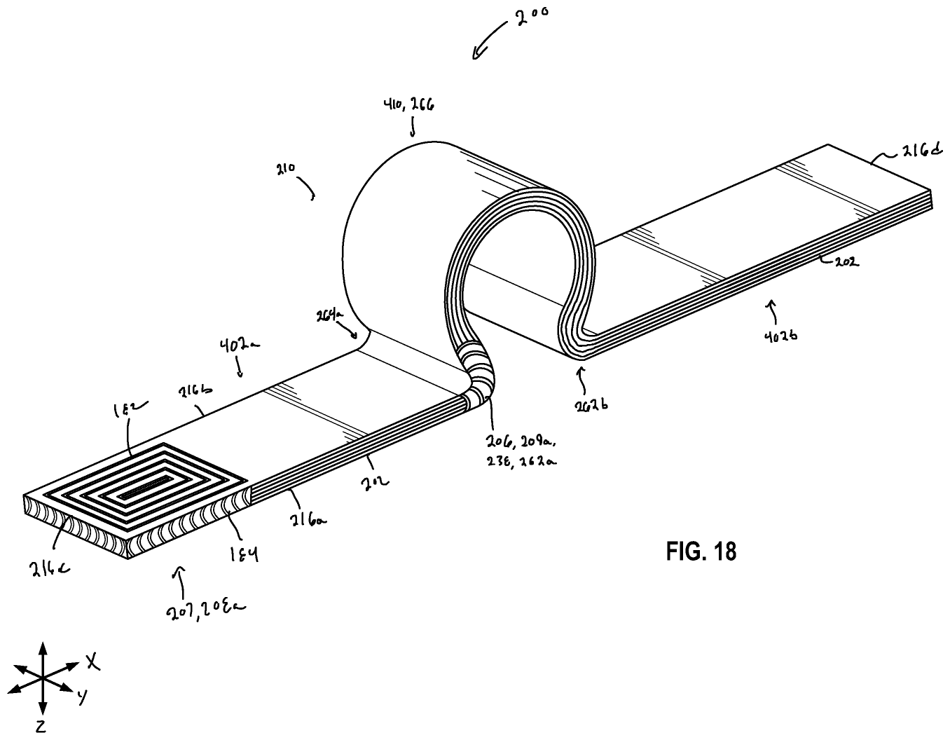

The term “fully solidified region” means an extent of the busbar that has undergone a fusing process (e.g., lateral weldment process 184 or vertical weldment process 182) to combine or fuse all conductors 202 contained in that extent of the busbar into a single consolidated conductor. For example, FIG. 17 shows a fully solidified region 242 that extends across the end sector 208a, 208b of the busbar 200.

The general term “solidified region” means a partially solidified region, a laterally solidified region 238, or a fully solidified region 242.

The term “flexible section” is an extent of the busbar that does not contain: (i) a partially solidified region, (ii) a laterally solidified region formed using a lateral partial penetration weldment process 184, or (iii) a fully solidified region. The rigidity of the flexible section 224 of the busbar 200 is less than 25% of the rigidity of a corresponding section of a solid reference busbar having the same geometry and being formed from a similar solid material.

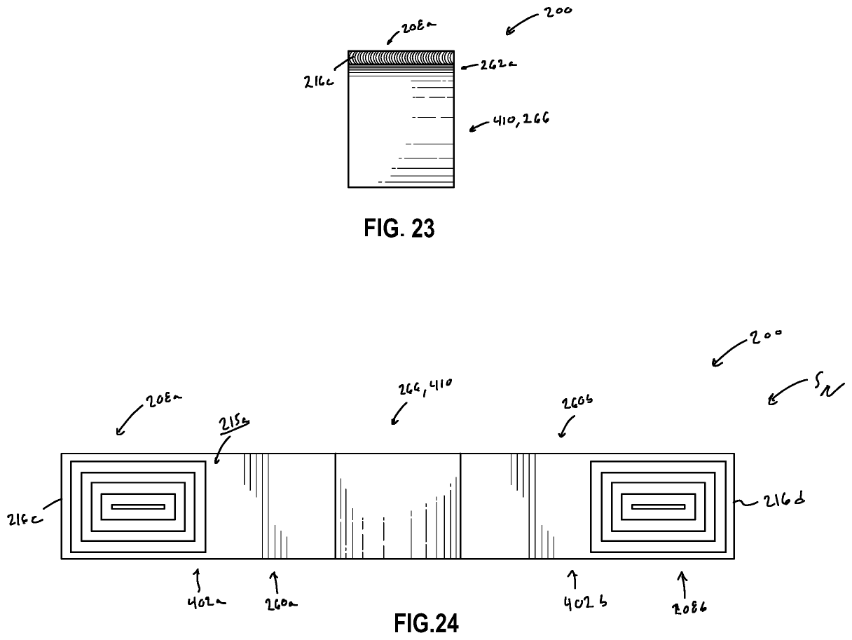

The term “bend section” is an extent of the busbar that contains at least one of: (i) a partially solidified region, (ii) a laterally solidified region, or (iii) a fully solidified region. For example, FIGS. 18-24, show a bend section 226 that includes unsolidified region(s) 230 of conductors 202 and one or more partially solidified region(s) 234 formed using two laterally solidified region(s) 238 formed using a lateral partial penetration weldment process 184. The rigidity of the bend section is greater than 35% of the rigidity of a corresponding section of a reference busbar having the same geometry and being formed from a similar solid material.

The term “maximum material condition” refers to a feature-of-size that contains the greatest amount of material, yet remains within its specified tolerance. For example, said maximum material condition occurs when utilizing the largest pin dimeter or the smallest hole size within the specified tolerance.

The term “minimum material condition” mean refers to a feature of size containing the least amount of material, yet remains within its specified tolerance. For example, said maximum material condition occurs when utilizing the smallest pin dimeter or the largest hole size within the specified tolerance.

The term “nominal material condition” refers to a material condition between the maximum material condition and minimum material condition.

The term “in-plane” refers to a plane defined by the X and Y axes in a three dimensional Cartesian X, Y and Z coordinate system. In this frame of reference, a longitudinal axis A-A of the busbar 200 is coplanar and in-plane with the X-Y planes.

The term “out-of-plane” refers to a plane defined by the Y and Z axes in the three dimensional Cartesian X, Y and Z coordinate system. In this frame of reference, the longitudinal axis A-A of the busbar 200 is oriented perpendicular and out-of-plane to the Y-Z plane.

The term “high power” means (i) voltage between 20 volts to 600 volts regardless of current or (ii) at any current greater than or equal to 80 amps regardless of voltage. The term “high current” means current greater than or equal to 80 amps regardless of voltage. The term “high voltage” means a voltage between 20 volts to 600 volts regardless of current.

### I. First Embodiment of an Elastically Deformable Battery Module Connector System

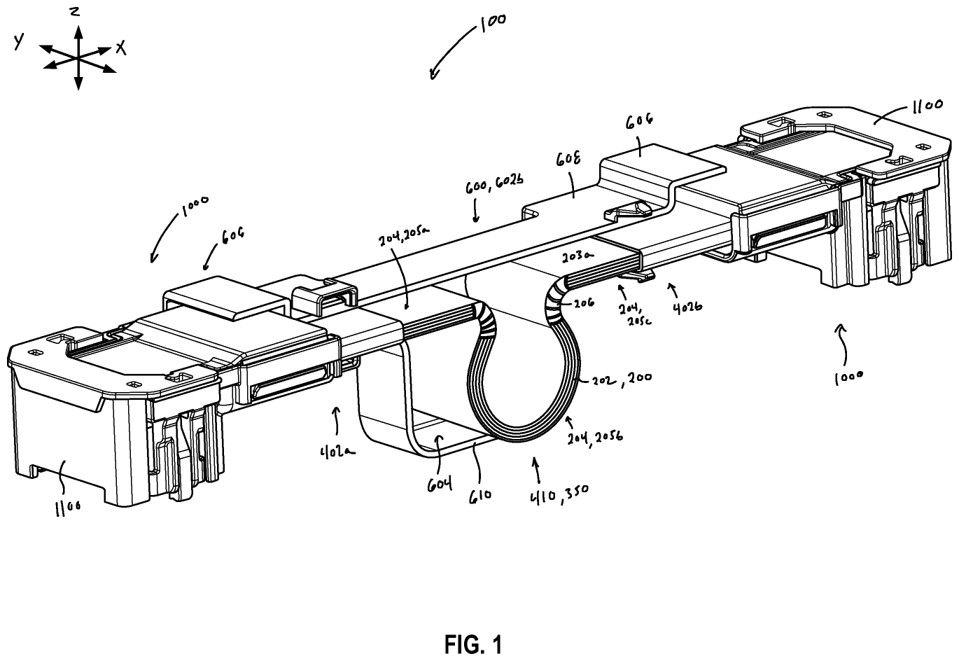

FIGS. 1-73 show a first embodiment of a elastically deformable battery module connector system 100, which includes: (i) the busbar 200, (ii) the busbar housing 600, and (iii) at least one male connector assembly 1000. The busbar 200 disclosed herein is formed from a plurality of conductors 202, wherein select extents of the busbar 200 are subject to a fusion process 180 that solidifies an extent of the conductors 202 within that extent of the busbar 200. As a result of this fusion process 180, the busbar 200 includes: (i) at least one unfused segment 204, and (ii) at least one fused segment 206. Integrally forming fused and unfused segments 204, 206 in a single busbar 200 is beneficial because it allows the busbar 200 to combine the best features of conventional rigid busbars and conventional flexible busbars into a single busbar, while limiting the negative features associated with these conventional busbars. For example, the unfused segments 204 are flexible, which allows the busbar 200 to: (i) adjust for manufacturing tolerances, (ii) expand and contract during thermal expansion and contraction events, such as battery charging and battery discharging cycles, and (iii) help absorb vibrations caused by the operating environment (e.g., within a vehicle) that the busbar 200 is installed in, instead of transferring these vibrations into other components operatively associated with the busbar 200. Additionally, the fused segments 206 of the busbar 200 are stiffer (e.g., increased Young's modulus in N/m²) which allows the busbar 200 to be accurately bent out-of-plane and purposely maintain these bends over time without causing the conductors 202 to delaminate and thus reduce current flow through the busbar 200.

### A. Busbar

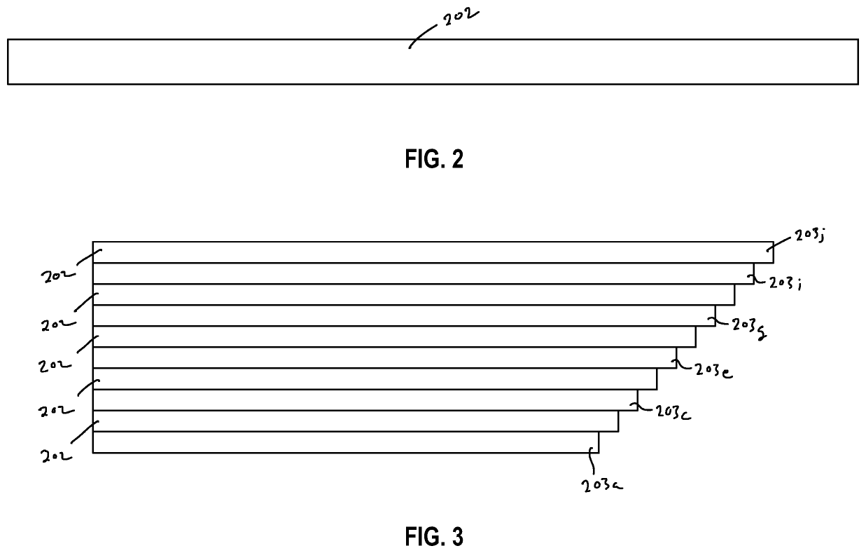

FIGS. 2-3 show the first step in forming the busbar 200. Specifically, a plurality of individual conductors 202 are obtained, cut to specified lengths, and arranged in a vertical stack. In the embodiment shown in the Figures, each conductor 202 has an elongated rectangular prism configuration. Said rectangular prism configuration is beneficial over other configurations (e.g., round or square) due to its ability to dissipate heat quickly. While the width (between 10 mm and 30 mm, preferably 20 mm) and thickness (between 0.1 mm and 0.5 mm, preferably 0.25 mm) of each conductor 202 remain substantially constant across the length of the busbar 200, the length of the conductors 202 contained in the busbar 200 very based on their positional relationship within the stack. In particular, the conductors 202 are staggered and increase in length when moving from the bottom conductor 203a (or shortest conductor) to the top conductor 203j (or longest conductor). This staggered length arrangement is desired because the top conductor 203j must travel further in comparison to the bottom conductor 203a due to the curvature of the elastically deformable intermediate portion 410 (see FIGS. 18-24).

In this first embodiment, each conductor 202 is made from C10200 copper alloy, which has: (i) electrical conductivity of more than 80% of IACS (International Annealed Copper Standard, i.e., the empirically derived standard value for the electrical conductivity of commercially available copper), per ASTM B747 standard, and (ii) a coefficient of thermal expansion (CTE) of 17.6 ppm/degree Celsius (from 20-300 degrees Celsius) and 17.0 ppm/degree Celsius (from 20-200 degrees Celsius). In other embodiments, the chosen copper material may be replaced with stainless steel, nickel, aluminum, silver, gold, copper, steel, zinc, brass, bronze, iron, platinum, lead, molybdenum, calcium, tungsten, lithium, tin, a combination of the listed materials, or other similar metals.

Once the desired configuration of the individual conductors 202 are formed, the conductors 202 are arranged in a layered stack with the first end 208a of all conductors aligned with one another. In other words, the end surface of the stack of conductors 202 is substantially flat and substantially perpendicular to the top and bottom surfaces 215a, 215b of the top and bottom conductors 203j, 203a. In this configuration, the plurality of conductors 202 provide an unfused reference rigidity. This unfused reference rigidity is between 1 KPa and 200 GPa, preferably between 50 KPa and 2,500 KPa, more preferably between 100 KPa and 1,000 KPa, and most preferably 320 KPa. While some figures in this application only depict the busbar 200 with five conductors 202 due to space constraints, it should be understood that the preferred embodiment is a layered stack of ten conductors 202. It should be understood that while the preferred embodiment is a layered stack of ten conductors 202, this disclosure contemplates busbars 200 that include any number of conductors 202 (e.g., one conductor 202 to a hundred conductors 202).

### i. Selectively Fusing a First Extent of the Busbar

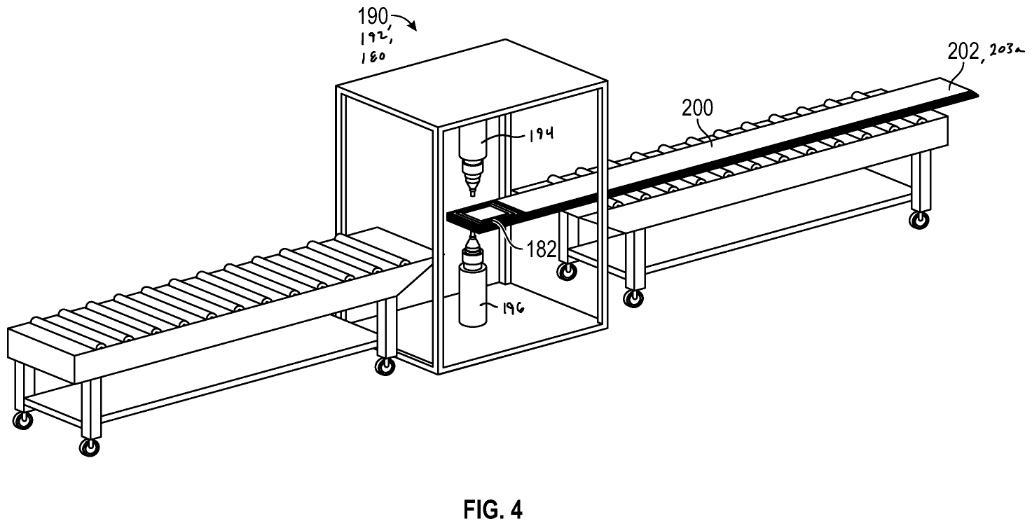

Once the layered stack of ten conductors 202 is created, the process of fabricating the busbar 200 continues by: (i) fusing the first end sector 208a of the busbar 200, and (ii) fusing the identified segments of the central sector 210 of the busbar 200, which are contained in the first extent 212a of the busbar 200. Before being able to selectively fuse an extent of the busbar 200, the user or manufacturer must acquire or obtain access to a machine 190 capable of performing the fusion method selected to selectively fuse said busbar 200. For example, if the designer decides to use a laser welding fusion method, then the designer acquires or obtains access to the laser welding machine 192, shown in at least FIGS. 4, 5, and 19. As shown therein, the laser welding machine 192 may include two separate lasers 194, 196 that can simultaneously weld the busbar 200 from two opposite directions. The two separate lasers 194, 196 are preferably aligned in a vertical plane. However, it should be understood that the laser welding machine 192 may have other configurations, which include: (i) only one laser 194 that can interact with only one side of the busbar 200 at a time, (ii) only one laser 194, but the light output from the laser is modified, using optics and mirrors, such that the laser can interact with both sides of the busbar 200 at the same time, or (iii) two lasers 194, 196 that are not aligned.

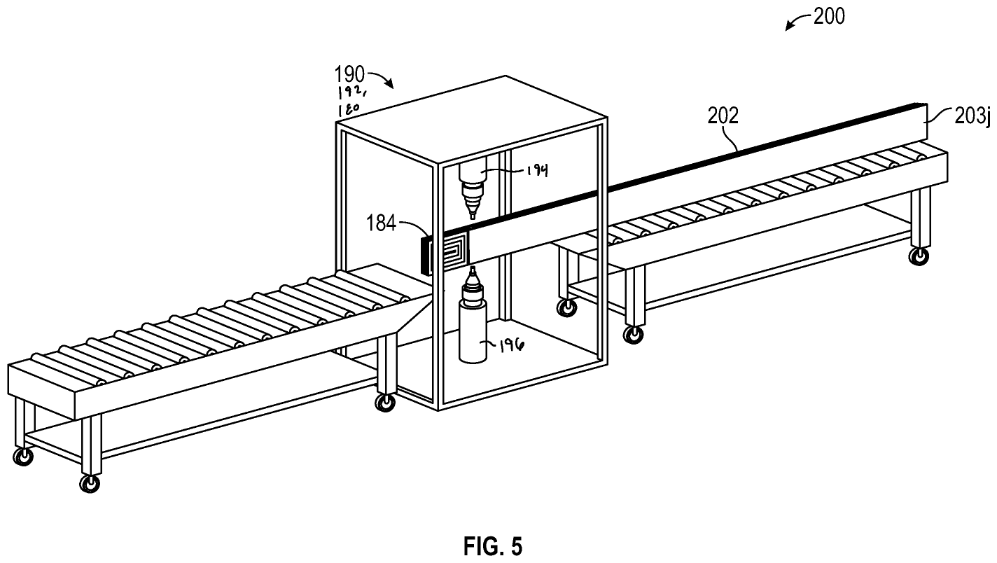

Next, the designer will: (i) insert the conductors 202 that have been arranged in the above disclosed layered stack design into machine 192 and (ii) provide fusing instructions to machine 192 (e.g., load an engineering model) that are associated with the first end sector 208a and the first extent 212a of the busbar 200. The laser welding machine 192 will then perform the fusion process 180 described in its instructions. For example, FIG. 4 shows the busbar 200 in a horizontal orientation where its width resides in a plane that is oriented substantially perpendicular to the lasers 194, 196. In this horizontal orientation, the machine 192 performs a surface-based fusion process (i.e., vertical partial penetration weldment process 182) on the end sector 207 of the busbar 200 according to the instructions associated with said first end sector 208a of the busbar 200. Next, as shown in FIG. 5, the busbar 200 is rotated to a vertical orientation where its thickness resides in a plane that is oriented substantially perpendicular to the lasers 194, 196. In this vertical orientation, the machine 192 performs an edge-based fusion process (i.e., a lateral partial penetration weldment process 184) on the first extent 212a of the busbar 200 according to the instructions associated with said first extent 212a.

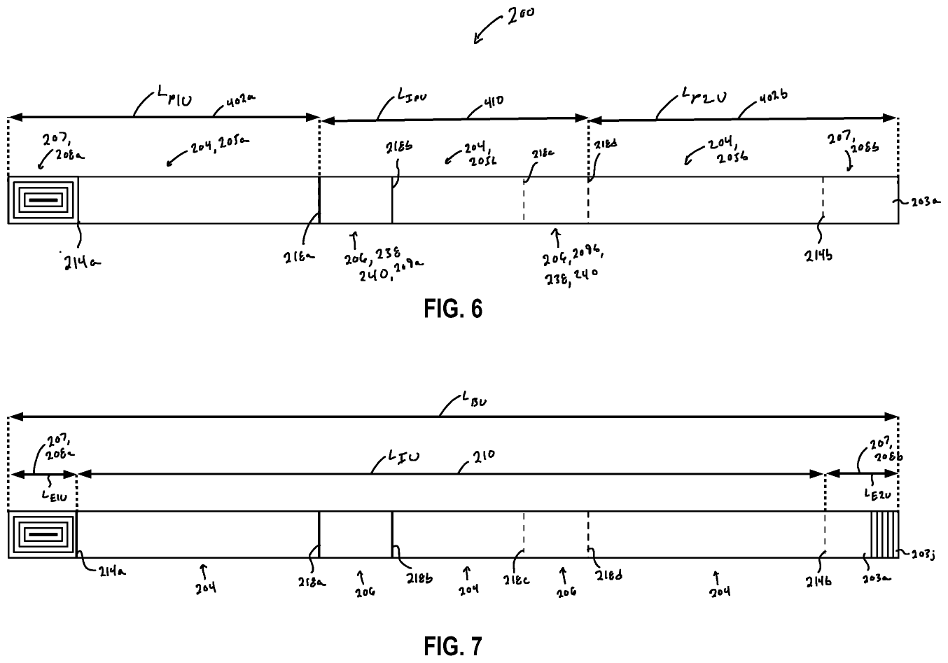

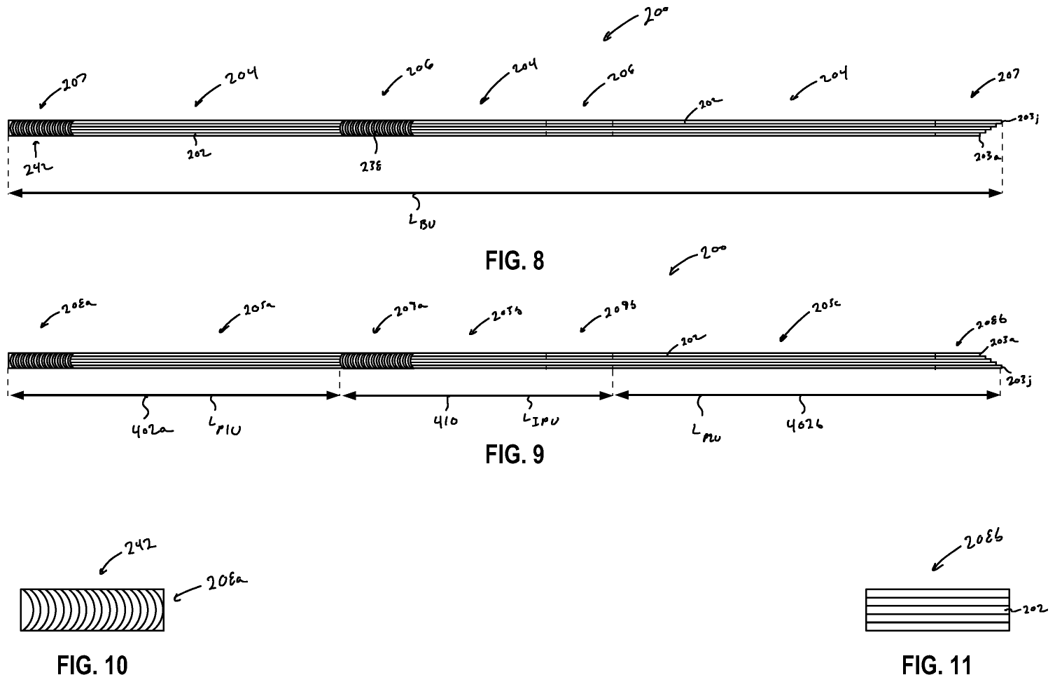

After the selective welding of the first end sector 208a and the first extent 212a of the central sector 210, the busbar shown in FIGS. 6-17 is formed. It should be understood that at this stage of the fabrication of the busbar 200, only the first end sector 208a and the first extent 212a of the central sector 210 are formed. The formation of these portions, extents, sectors, segments, zones, and regions are denoted by the sold lines shown in FIGS. 6 and 7. In order to simplify the discussion, other portions, extents, sectors, segments, zones, and regions that are not presently formed at this stage of fabrication, but are identified and will be formed at a later stage of fabrication are denoted by dotted lines in FIGS. 6 and 7. In fact, these identified and later formed extents, sectors, segments, zones, and regions are preferably not formed at this stage of fabrication because their inclusion will likely introduce additional stresses on the conductors 202 during the bending of said busbar 200. To avoid introducing these stresses, the formation of these extents, sectors, segments, zones, and regions will be done after the busbar 200 is bent into the desired shape. Additionally, the configuration of the disclosed busbar 200 should be understood as exemplary and that other configurations of the extents, sectors, segments, zones, and regions is contemplated by this disclosure. For example, all portions, sectors, segments, zones, and regions that are disclosed or contemplated in U.S. patent application Ser. Nos. 17/970,116 and 17/699,033, and PCT Application No. PCT/IB2022/057772 may be included or utilized in busbar 200.

FIGS. 6-11 show that the busbar 200 includes: (i) a central sector 210 and (ii) two end sectors 207. The central sector 210 extends between end boundary lines 214a, 214b, while the end sectors 207 extends outward from end boundary lines 214a, 214b. The end boundary lines 214a, 214b separate the fused segments 206 that contain fully solidified regions 242 that are arranged to form a densification weld from the segments 204, 206 that do not contain fully solidified regions. It should be understood that end boundary lines 214a, 214b are positioned inward from the end edges 216c, 216d a sufficient distance to allow enough material to be present in the end sectors 207 of the busbar 200 to allow said end sectors 207 to be coupled to a connector, terminal, receptacle, or any other structure that couples the busbar 200 to an external structure or component. For example, the end boundary lines 214a, 214b may be formed between 1 mm and 40 mm, and preferably between 14 mm and 22 mm from the end edges 216c, 216d.

As shown in at least FIG. 6, the central sector 210 includes: (i) three unfused segments 204 (205a, 205b, 205c), and (ii) two fused segments 206 (209a, 209b). In particular, the unfused segments 204 are arranged such that: (i) the first unfused segment 205a extends between the first end boundary line 214a and a first intermediate boundary line 218a, (ii) the second unfused segment 205b extends between a second intermediate boundary line 218b and a third intermediate boundary line 218c, and (iii) the third unfused segment 205c extends between a fourth intermediate boundary line 218d and the second end boundary line 214b. Meanwhile, the fused segments 206 are arranged such that: (i) the first unfused segment 205a extends between the first intermediate boundary line 218a and the second intermediate boundary line 218b, and (ii) the second fused unfused segment 209b extends between the third intermediate boundary line 218c and the fourth intermediate boundary line 218d. In other words, the first intermediate boundary line 218a separates a linear extent (i.e., first peripheral portion 402a) of the busbar 200 from the non-linear extent (i.e., elastically deformable intermediate portion 410). Additionally, the fourth intermediate boundary line 218d separates a linear extent (i.e., second peripheral portion 402b) of the busbar 200 from the non-linear extent (i.e., elastically deformable intermediate portion 410). Finally, the second and third intermediate boundary lines 218c, 218d separate an unfused segment 204 from the fused segments 206.

FIGS. 12-17 show cross-sectional views to illustrate how the selective fusion process alters the configuration of the individual conductors 202 contained within the end sectors 207 and the first extent 212a of the central sector 210 of the busbar 200. Specifically, cross-sectioning this busbar 200 along lines 13-13, 15-15, 17-17 shows that: (i) areas did not undergo a fusion process (e.g., weldment) remain unsolidified 230, (ii) areas that underwent a fusion process (e.g., weldment): (a) namely, edge welds and specifically right edge welds and left edge welds-create laterally solidified regions 238 in the fused segments 206 of the central sector 210 of the busbar 200, or (b) namely, surface welds and specifically upper surface welds and lower surface welds—create fully solidified regions 242 in the end sector 207 of the busbar 200.

### 1. Unfused Segment

FIG. 13 show a cross-sectional view of the busbar 200 taken along the section plane defined by line 13-13 of FIG. 12. Said cross-section is taken between the first end boundary line 214a and the first intermediate boundary line 218a. Said boundary lines define the edges of the unfused segment 204 (namely, the first unfused segment 205a). The cross-section of FIG. 13 reveals a plurality of conductors 202 that do not include a solidified region 238, 242. In other words, the plurality of conductors 202 shown in this cross-section have not undergone a fusion process to combine or fuse an extent of conductors into a single consolidated conductor. Stated another way, each conductor 202 in this unfused segment 204 remains an individual and distinct conductor 202. This configuration of individual and distinct conductors 202 forms a flexible section 224, which is not designed to be bent or withstand harsh handling forces. In this embodiment, said flexible section 224 has a rigidity that is less than 550 KPa or 0.55 Nm² (2,200 KPa for a rigid reference busbar with 1 conductor*0.25)=550 KPa) In particular, said flexible section 224 has a rigidity that is approximately 320 KPa.

### 2. Fused Segment

The laterally solidified regions 238 extend from lateral edges 216a, 216b of the busbar 200 to an edge-based fusion peak 219 of the fusion process 180. Wherein the edge-based fusion peak 219 is positioned at a point that is located: (i) laterally between a midpoint 217, and the lateral edges 216a, 216b of the fused segment 206, and (ii) vertically between (a) first surface 215a and (b) a second surface 215b of the busbar 200. As such, the laterally solidified region 238 has an area defined by a height H_{LSR} and a width W_{LSR}. In an exemplary embodiment, the edge fusion width or width of the laterally solidified region W_{LSR} is less than 0.4 mm, and most preferably between 0.01 mm and 0.35 mm. Attempting to increase the edge fusion width or width of the laterally solidified region W_{LSR} beyond 0.4 mm for the disclosed embodiment may cause undesirable puddling near the lateral edges 216a, 216b, as the busbar 200 includes copper and ten conductors 202 that have thicknesses of 0.25 mm. However, it should be understood that busbars 200 that have other configurations or are made from other materials, said puddling may not occur until deeper weldments or may occur at a shallower weldments. As such, edge fusion width or width of the laterally solidified region W_{LSR} for other embodiment may be between 0.05 mm to 5 mm, preferably between 0.1 mm to 2.5 mm, and most preferably between 0.1 mm and 0.75 mm.

The limited solidification zone 240 is an extent of the busbar 200 that: (i) extends from a midpoint 217 of the fused segment 206 to one of the lateral edges 216a, 216b, and (ii) has undergone an edge-based fusion process (e.g., the lateral partial penetration weldment process 184 or a cold forming process). The limited solidification zone 240 has: (i) a height H_{LSZ} that extends between the first and second surfaces 215a, 215b, and (ii) width W_{LSZ} that extends between the midpoint 217 and the lateral edges 216a, 216b of the conductors 202. Stated another way, the limited solidification zone 240 has: (i) a height H_{LSZ} that is: (a) typically equal to the height H_{F} of the fused segment 206, and (b) equal to or greater than a fusion height or laterally solidified height H_{LSR}, and (ii) a width W_{LSZ} that is: (a) equal to half (e.g., 10 mm) the width (e.g., 20 mm) of the busbar 200, and (b) is greater that the lateral cross-sectional width W_{LSR} of the laterally solidified region 238.

The edge fusion width or width of the laterally solidified region W_{LSR} is: (i) consistent in a fused segment 206, and (ii) may vary when multiple fused segments 206 are compared against one another. However, in other embodiments, the edge fusion width or width of the laterally solidified region W_{LSR} may: (i) remain constant across the entire fused segment 206, or (ii) may vary in a fused segment 206, (iii) remain constant across a plurality of fused segments 206, and/or (iv) may vary across a plurality of fused segments 206. As discussed above, the edge fusion width or width of the laterally solidified region W_{LSR} is between 0.05 mm and 0.4 mm and preferably 0.2 mm. Accordingly, the total fusion depth W_{T} which is calculated by summing up the width of the laterally solidified region W_{LSR} associated with the right and left edges, varies between each of the plurality of fused segments 206. As such, the first total fusion depth associated with fused segment 206 that extend between 218a and 218b is between 0.1 mm (i.e., 0.05 mm+0.05 mm) and 0.8 mm (i.e., 0.4 mm+0.4 mm) and preferable 0.4 mm. As such, the total fusion depth W_{T} is between 0.5% and 4% of the busbar width (i.e., 20 mm).

Based on the above described heights and widths, the busbar 200 includes the following relationships: (i) height H_{LSR} of the laterally solidified region 238 is typically substantially equal to the height H_{LSZ} of the limited solidification zone 240, and (ii) the width W_{LSR} of the laterally solidified region 238 is less than to the width W_{LSZ} of the limited solidification zone 240, wherein the width W_{LSR} is at typically 50% less than the width W_{LSZ} and is most preferably between 0.5% (i.e., (1−(9.95 mm/10 mm))*100) and 4% (i.e., (1−(9.6 mm/10 mm))*100) of the width W_{LSZ} of the limited solidification zone 240. Additionally, the height of the edge weld 184 is substantially equal to the height H_{LSR} of the limited solidification region 238, and the width of the edge weld 184 is substantially equal to width W_{LSR} of the laterally solidified region 238. As such, the height of the edge weld 184 is substantially equal to the height H_{LSZ} of the limited solidification zone 240, and the width of the edge weld 184 is less than the width W_{LSZ} of the limited solidification zone 240.

The laterally solidified region width W_{LSR} is less than both the limited solidification zone 240 width W_{LSZ} and half the width of the busbar 200. Because laterally solidified region width W_{LSR} is less than half the width of the busbar 200, an unsolidified region 230 is formed between the edge-based fusion peak 219 and the midpoint 217 of the busbar 200. This unsolidified region 230 has an unsolidified width Wu, which extends between the midpoint 217 of the busbar 200 and the edge-based fusion peak 219. The unsolidified width Wu is typically at least 10% of limited solidification zone 240 width W_{LSZ} and is preferably between 50% and 99.9% of limited solidification zone 240 width W_{LSZ}. On the other hand, laterally solidified region width W_{LSR} is equal to at least 0.1% of the limited solidification zone 240 width W_{LSZ}, is preferably between 1% and 10% of the limited solidification zone 240 width W_{LSZ}, and is most preferably between 3% and 8% of the limited solidification zone 240 width W_{LSZ}.

In this exemplary embodiment, a laterally solidified regions 238 may be created by solidifying a lateral extent of ten conductors 202 into a single conductor. Stated another way, the central sector 210 of the busbar 200 includes a plurality of conductors 202 that traverse or spans the central sector 210 of the busbar 200. The fused segment 206 of the central sector 210 contains a limited solidification zone 240 that extends between a midpoint 217 and the lateral edges 216a, 216b of the conductors 202. A minority of the conductors 202 contained within this limited solidification zone 240 have been solidified into a single consolidated conductor to form a laterally solidified region 238. Likewise, a majority of the conductors 202 contained in this limited solidification zone 240 are unsolidified and form an unsolidified region 230.

As best shown in FIG. 15, the laterally solidified regions 238 may contain varying fusing density, when a lateral partial weldment process 184 is used to form said regions 238. Said lateral partial weldment process 184 may form a first or exterior zone with a first fusing density and the second or interior zone with a fusing second density less than the first fusing density. The differences in density result from the configuration and operating conductions of the laser welding machine 192, where the laser beam loses strength as it penetrates into the busbar 200. The less dense zone is created at a certain distance inward from edge of the weld or inward of the more dense zone. It should be understood that this second zone may have a fusing density gradient, where it has a higher fusing density closest to the first zone and the lowest fusing density at a furthest point away from the first zone. It also should be understood that the fusing density may be consistent or substantially consistent within this first zone. In addition to solidifying the lateral edges 216a, 216b of the busbar 200, the lateral partial weldment process 184 rounds off the corners of the busbar 200. These rounded corners help reduce the probability that the conductors 202 wear into or tear the insulation or housing 600. Additional aspects of the laterally solidified regions 238 and unsolidified region 230 are presented in the definitions section at the outset of the detailed description.

As discussed above, the fused segment 206 within the central sector 210 of the busbar 200 contains both laterally solidified regions 238 and unsolidified region 230. As such, it should be understood that increasing the area of the laterally solidified regions 238 within the fused segment 206: (i) will increase at least the localized stiffness in the fused segment 206, (ii) tends to increase the stiffness of the central sector 210 of the busbar 200, and (iii) tends to increase the overall stiffness of the busbar 200. For example, creating these laterally solidified regions 238 will increase the Young's modulus of the busbar (e.g., above 320 KPa or 0.32 Nm² at room temperature). Further, it should be understood that increasing the area of unsolidified region 230 within the fused segment 206: (i) will increase at least the localized flexibility in the fused segment 206, (ii) tends to increase the flexibility of the central sector 210 of the busbar 200, and (iii) tends to increase the overall flexibility of the busbar 200.

FIG. 15 show a cross-sectional view of the busbar 200 taken along section plane defined by line 15-15 of FIG. 14. Said cross-section is taken between the first intermediate boundary line 218a and the intermediate boundary line 218b. These boundary lines 218a, 218b define the edges of the fused segment 206 or fused segment 206 (namely, the first fused segment 209a). The cross-section of FIG. 15 reveals: (i) two laterally solidified regions 238 that are formed using right and left lateral partial penetration weldments that extend inward from the lateral edges 216a, 216b of the busbar 200, and (ii) an unsolidified region 230 that extends between the two laterally solidified regions 238. As such, the right and left lateral partial penetration weldments combine all of the conductors 202 contained within the laterally solidified regions 238 into a single consolidated conductor. This first fused segment 206, 209a lacks an extent that has been subject to a surface-based fusion process in order to form partially solidified region, where all conductors in said partially solidified region are fused together to form a single consolidated conductor. Because this first fused segment 206, 209a lacks a partially solidified region, it also lacks a partial solidification zone. As such, this bend region 226 has a rigidity that is greater than 770 KPa ((2,200 KPa for a rigid reference busbar with 1 conductor*0.4)=770 KPa).

### 3. Fused End Sector

Unlike the central sector 210, the end sectors 207 are intended to receive a connector; thus, it is desirable for these areas to be fully solidified as a single consolidated conductor. All extents of the conductors 202 contained in the fully solidified regions 242 are solidified into a single conductor because a significant extent of the conductors 202 are: (i) solidified downward from the top surface 215a, (ii) solidified upward from the bottom surface 215b, and (iii) solidified inward from the lateral edges 216a, 216b. Accordingly, these significant extents of the conductors 202 meet between the top and bottom surfaces 215a, 215b, typically in the midpoint region between the two surfaces 215a, 215b, and form a fully solidified region 242. The weld depth or fully solidification region 242 height H_{FSR} is at least substantially equal to the fused height H_{F} of the busbar 200. In certain exemplary embodiments, the fully solidified height H_{FSR} may be greater than the fused height H_{F} when weldment material is deposited onto one of the two surfaces 215a, 215b creating a “dome-effect”. Because fully solidification region 242 height H_{FSR} is equal or greater than the fused height H_{F}, an unsolidified region 230 is not formed between weldment and the second surface 215a, 215b of the busbar 200. In other words, all conductors 202 positioned within the full solidification zone are solidified into a single consolidated conductor. Additional aspects of the fully solidified region 242 are disclosed in PCT/US20/50016, which is hereby incorporated by reference.

Like the partially solidified zone 1300, the fully solidified zone is an area of the busbar 200, where the zone extends between the top surface 215a and the bottom surface 215b that has undergone a full weldment process 182. The full solidification zone has a height that extends between the first and second surfaces 215a, 215b. Stated another way, the full solidification zone has a height that is equal to fused height H_{F} and may be equal to the fully solidified height H_{FSR}. Based on the disclosed weldments, the end sectors 207 are welded in manner that causes these sectors 207 to be densified (enough solidified surface area to equal 120% of the busbar's 200 cross sectional area) such that they can be coupled to a connector.

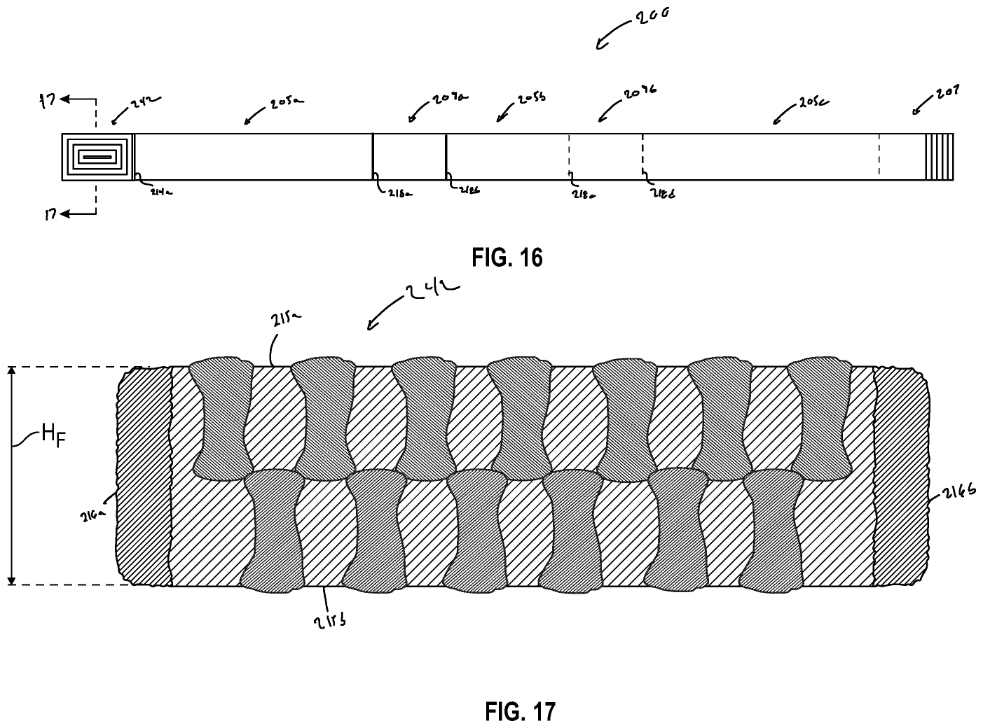

FIG. 17 show a cross-sectional view of the busbar 200 taken along section plane defined by line 17-17 of FIG. 16. Said cross-section is taken between the end edge 216c and the first intermediate boundary line 218a, which defines the end sector 207, 208a and the fully solidified regions 242. The cross-section of FIG. 17 reveals: (i) two laterally solidified regions 238 that are formed using right and left lateral partial penetration weldments that extend inward from the lateral edges 216a, 216b of the busbar 200, and (ii) thirteen partially solidified regions that are formed using top and bottom vertical partial penetration weldment process 182 that extend upward and downward from the top and bottom surfaces 215a, 215b of the busbar 200. As such, this bend region 226 has a rigidity that is greater than 770 KPa ((2,200 KPa for a rigid reference busbar with 1 conductor*0.35)=770 KPa).

### ii. Alternative Embodiments

As discussed above, the central sector 210 may contain: (i) any number (e.g., 0-1000) of unfused segments 204, and (ii) any number (e.g., 0-1000) of fused segments 206. The fused segments 206 may contain any number (e.g., 0-1000) of laterally solidified regions 238, any number (e.g., 0-1000) of partially solidified regions, and any number (e.g., 0-1000) of unsolidified regions 230. Also, the fused segment(s) 206 may contain any number of waveforms (e.g., 0-100), preferably between 1-6 waveforms, and most preferably two waveforms. Likewise, the central sector 210 of the busbar 200 may contain: (i) any number of waveforms (e.g., 0-100), (ii) any number (e.g., 0-1000) of laterally solidified regions 238, (iii) any number (e.g., 0-1000) of partially solidified regions, (iv) any number of fully solidified regions 242, and/or (v) any number (e.g., 0-1000) of unsolidified regions 230. Finally, the busbar 200 may contain: (i) any number of waveforms (e.g., 0-100), (ii) any number (e.g., 0-1000) of laterally solidified regions 238, (iii) any number (e.g., 0-1000) of partially solidified regions, (iv) any number of fully solidified regions 242, and/or (v) any number (e.g., 0-1000) of unsolidified regions 230. This configuration allows the busbar designer to selectively form segments, zones, regions, and/or volumes into a single busbar, which provides said busbar 200 with the benefits associated with conventional rigid and conventional flexible busbars.

In alternative embodiments, the disclosed laser fusion processes may be replaced or used in addition to resistance welding, arc welding, electron beam welding, orbital welding, ultrasonic welding, friction welding, any combination of the above methods, or other known methods for fusing metal. Additionally, the lateral partial penetration weldment process 184 or a cold forming process that form the laterally solidified region within the limited solidification zone of the central sector 210 may be omitted or their width may be expanded. Further, the lateral partial penetration weldment process 184 or a cold forming process that is used in connection with the end sectors 207 may be omitted.

### iii. Forming the Intermediate Portion

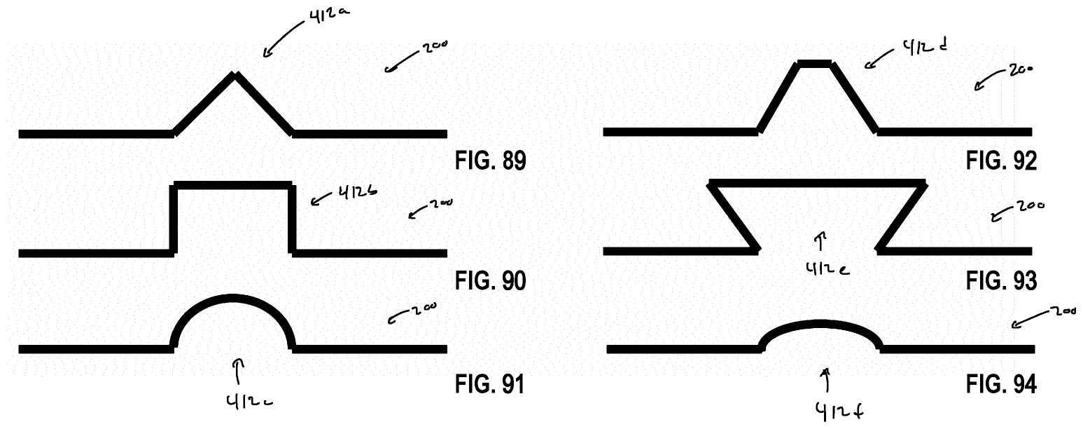

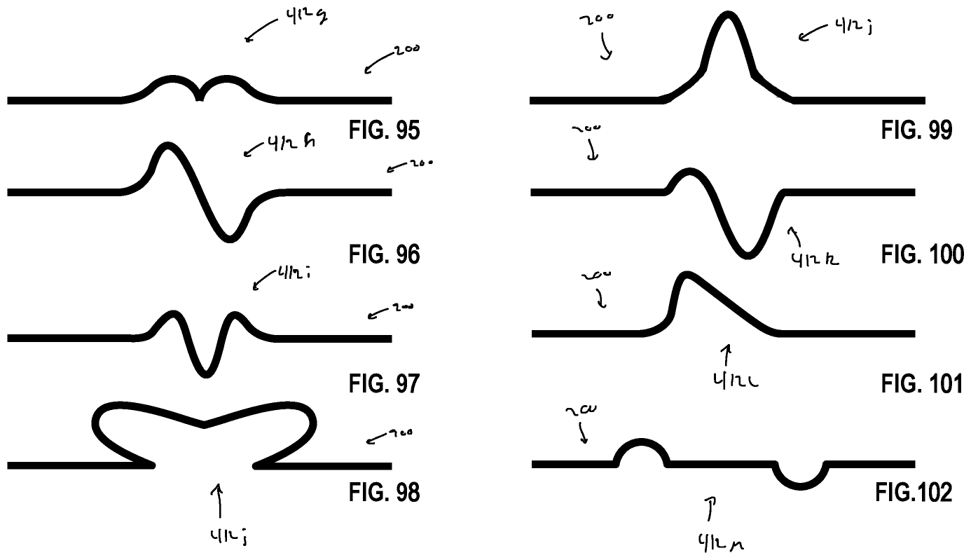

After the first end sector 208a and the first extent 212a of the busbar 200 are selectively fused, the process of fabricating the busbar 200 continues by forming the elastically deformable intermediate portion 410 of the busbar 200 into the desired shape. Said elastically deformable intermediate portion 410 of the busbar 200 is located between a first peripheral portion 402a and a second peripheral portion 402b. Specifically, the first peripheral portion 402a includes: (i) the first end sector 207, 208a, and (ii) a first extent of the central sector 210—namely, the first unfused segment 204, 205a. Similarly, the second peripheral portion 402b includes: (i) the second end sector 207, 208b, and (ii) a second extent of the central sector 210—namely, the third unfused segment 204, 205c. Based on this disclosed configuration, the first and second peripheral portions 402a include: (i) a fully solidified region 242, and (ii) an unsolidified region 230. Meanwhile, the intermediate portion 410 is formed in the central sector 210 and between the first and second extents of the central sector 210. As such, the intermediate portion 410 includes: (i) the first fused segment 206, 209a, (ii) the second unfused segment 204, 205b, and (iii) the second fused segment 206, 209b. Thus, the intermediate portion 410 includes: (i) two laterally solidified regions 238, and (ii) an unsolidified region 230 extending between the two laterally solidified regions 238. It should be understood that other configurations are contemplated by this disclosure (see FIGS. 89-102). For example, in an alternative embodiment the intermediate portion 410 may include partially solidified regions.

In other words, the first peripheral portion 402a is defined between the left end edge 216c and the first intermediate boundary line 218a and the second peripheral portion 402b is defined between the right end edge 216d and the fourth intermediate boundary line 218d. Stated another way, said first and second peripheral portions 402a, 402b extend outward from the first and fourth intermediate boundary lines 218a, 218d. It should be understood that first and fourth intermediate boundary lines 218a, 218d are positioned inward from the end edges 216c, 216d a sufficient distance to: (i) allow a connector, terminal, receptacle, or any other structure to be properly coupled to the busbar 200, and (ii) properly position the elastically deformable intermediate portion 410 in a desired location (e.g., a location that does not interfere with the location of the battery modules 60). For example, the end boundary lines 214a, 214b may be formed between 15 mm and 85 mm, and preferably between 35 mm and 55 mm from the end edges 216c, 216d.

The first and second peripheral portions 402a, 402b are not designed to be bent or altered in this stage of the fabrication process. Thus, in the uninstalled state S_{U}, these peripheral portions 402a, 402b remain substantially parallel, substantially aligned, their top and bottom surfaces 215a, 215b are substantially coplanar, and their lateral edges 216a, 216b are substantially co-linear. As such, these peripheral portions 402a, 402b are not designed to include curvilinear or angular extents. Additionally, in an installed state S_{I}, these peripheral portions 402a, 402b typically and/or preferably remain substantially parallel, substantially aligned, their top and bottom surfaces 215a, 215b are substantially coplanar, and their lateral edges 216a, 216b are substantially co-linear. The configuration of the first and second peripheral portions 402a, 402b is beneficial because it helps ensure that undesired forces are at least minimized, and preferably not applied on the connections between the busbar 200 and the male connector assemblies 1000, or the male connector assemblies 1000 and the battery module 60. Examples of undesired forces may be introduced if the peripheral portion 402a, 402b of the busbar 200 have a curvilinear configuration. And said undesired forces can lead to failures within the battery pack 90, which are extremely costly to diagnose, repair or mitigate. Therefore, minimizing or eliminating these undesired forces is beneficial.

Unlike the first and second peripheral portions 402a, 402b, the elastically deformable intermediate portion 410 is designed to elastically deform when a load is placed on the busbar 200, (e.g., from dynamic movement of the battery module(s) 60). In order to elastically deform when said load is placed on the busbar 200, the elastically deformable intermediate portion 410 has a configuration, in an uninstalled state S_{U}, that preferably positions at least an extent of, preferably a majority of, and most preferably a substantial majority of the intermediate portion 410 in a position that is: (i) not substantially parallel with, (ii) not substantially aligned with, (iii) not substantially coplanar with, or (iv) not substantially co-linear with the entirety of the first and second peripheral portions 402a, 402b. In other words, the intermediate portion 410 resides out of plane with the first and second peripheral portions 402a, 402b, which arises from the fact that the intermediate portion 410 includes a substantial curvilinear(s) extent or an angular(s) extent. Stated another way, the first and second peripheral portions 402a, 402b substantially reside in a first plane, and the majority of the elastically deformable intermediate portion 410 resides outside of said first plane. The formation of this (or these) curvilinear or angular extents in the intermediate portion 410 is facilitated by the inclusion of the fused segment 206 within the busbar 200 due to the fact that said fused segment 206 helps keep the busbar 200 from delaminating when said elastically deformable intermediate portion 410 is bent into its desired shape.

In the preferred embodiment shown in FIGS. 1-73, at least the intermediate portion 410 of the busbar 200, especially when viewed in a side view, has a configuration that substantially matches the configuration of the capital letter, Omega (“Ω”), in the Greek alphabet or the Ohm symbol, (“Ω”), which is a unit of energy management. Specifically, the first peripheral portion 402a's configuration is similar to an extent of the left foot or left base section of the Omega-shape, the elastically deformable intermediate portion 410's configuration is similar to the curvilinear shape of the Omega-shape, and the second peripheral portion 402b's configuration is similar to an extent of the right foot or right base section of the Omega-shape. Stated another way, the busbar 200 includes: (i) a first linear extent 260a, (ii) a first foot or base of the Omega-shape, which is formed by a first curvilinear extent 262a that creates an first external recess 264a, (iii) a semi-circular extent 266, (iv) a second foot or base of the Omega-shape, which is formed by a second curvilinear extent 262b that creates an second external recess 264b, and (v) a second linear extent 260b. Additionally the configuration of the busbar 200 positions the fused segments 206, 209a, 209b near the feet or base of the Omega-shape, while the unfused segments 204, 205a, 205b, 205c are: (i) located between the end sectors 207 and fused segments 206, 209a, 209b, and (ii) along a curvilinear path between the fused segments 206, 209a, 209b. It should be understood that in other embodiments, the first and second extent of the central sector 210 may include fused segments 206, and the curvilinear path between the fused segments 209a, 209b may be completely fused or partially fused. It should also be understood in other embodiments, that the elastically deformable intermediate portion 410 may have an alternate configuration (e.g., square, triangle, sinusoidal wave, etc.) including, but not limited to, the shapes disclosed in FIGS. 89-102. Finally, it is believed that optimal elastic deformation performance of the busbar 200 occurs when the elastically deformable intermediate portion 410 has a curvilinear configuration that lacks right angles or “severe angles” like those shown in FIGS. 89, 90, 92, 93, 95 and 98.

As shown in FIG. 6, when the busbar 200 is in an original or unbent state S_{UB} of the busbar 200, the length of each portion is as follows: (i) the first peripheral portion 402a has a length L_{P1U} that extends from the end edge 216c of the busbar 200 to first intermediate boundary line 218a, (i) the second peripheral portion 402b has a length L_{P2U} that extends from the end edge 216d of the busbar 200 to fourth intermediate boundary line 218d, and (iii) the intermediate portion 410 has a length L_{IPU} that extends from the first intermediate boundary line 218a to fourth intermediate boundary line 218d. The peripheral portion lengths L_{IPU}, L_{P2U} must be sufficiently long to facilitate the coupling of the busbar 200 to an external device or component. In the disclosed embodiment, these peripheral portion lengths L_{IPU}, L_{P2U} may be larger than 5 mm, preferably larger than 10 mm, more preferably greater than 14 mm, and most preferably between 30 mm and 60 mm. While peripheral portion lengths L_{IPU}, L_{P2U} contribute to the overall length L_{UB} of the busbar 200, the intermediate portion length L_{IPU} substantially drives the calculations shown in the below table.

Also, as shown in FIG. 7, when the busbar 200 is in an original or unbent state S_{UB} of the busbar 200, the length of each portion is as follows: (i) the first end sector 208a has a length L_{E1U} that extends from the end edge 216c of the busbar 200 to the first end boundary line 214a, (ii) the second end sector 208b has a length L_{E2U} that extends from the end edge 216d of the busbar 200 to the second end boundary line 214b, and (iii) the central sector 210 has a length L_{CU} that extends from first end boundary line 214a to the second end boundary line 214b. The end sector lengths L_{E1U}, L_{E2U} must be sufficiently long to facilitate the coupling of the busbar 200 to an external device or component. In the disclosed embodiment, these end sector lengths L_{E1U}, L_{E2U} may be larger than 2 mm, preferably larger than 7 mm, and most preferably between 10 mm and 20 mm. To note, the below table is for a busbar 200 having ten copper conductors stacked to form a busbar 200 that has a thickness T_{B} of 2.5 mm and a width of 20 mm.

TABLE 1
Busbar Forces and Dimensions

| | Intermediate Portion | | | | | |
|---|---|---|---|---|---|---|
| Activation | Interior Diameter | L_{IPU} | L_{P1U}, L_{P2U} | L_{BU} | L_{BN} | Package Volume |
| Force (N) | (mm) | (mm) | (mm) | (mm) | (mm) | (mm³) |
| 312 | 10 | 32 | 22 | 76 | 58 | 1,570 |
| 211 | 12 | 38 | 26 | 90 | 72 | 2,261 |
| 155 | 14 | 44 | 30 | 104 | 84 | 3,077 |
| 98 | 16 | 51 | 34 | 119 | 96 | 4,019 |
| 67 | 18 | 57 | 38 | 133 | 108 | 5,087 |
| 42 | 20 | 63 | 44 | 151 | 116 | 6,280 |
| 35 | 22 | 69 | 48 | 165 | 130 | 7,599 |
| 32 | 24 | 75 | 52 | 179 | 140 | 9,043 |
| 31 | 26 | 82 | 56 | 194 | 152 | 10,613 |
| 30 | 28 | 88 | 60 | 208 | 164 | 12,308 |
| 29 | 30 | 95 | 64 | 223 | 175 | 14,130 |
| 28 | 32 | 101 | 68 | 237 | 187 | 16,076 |
| 26 | 34 | 107 | 72 | 251 | 198 | 18,149 |
| 24 | 36 | 113 | 76 | 265 | 209 | 20,347 |

The total length L_{BU} of the unbent busbar and the formed length L_{BN} of the busbar extend between the end edges 216c, 216d of the busbar 200 in an uninstalled state S_{U}. As shown in the above Table 1, the ration of the formed length L_{BN} and the total length L_{BU} is between 70% and 90%. In other words, the formed length L_{BN} is more than 10% less than total length L_{BU} and preferably more than 20% less than the total length L_{BU}. The above table also shows the unbent intermediate portion length L_{IPU} is between 35% and 49% of the total length L_{BU} of the unbent busbar 200 and each of the peripheral portion lengths L_{P1U}, L_{P2U} is between 25% and 32% of the total length L_{BU} of the unbent busbar 200. As such, the unbent intermediate portion length L_{IPU} is less than a majority of the total busbar length L_{BU} of the busbar 200. However, as discussed above, other length ratios are contemplated by this disclosure.

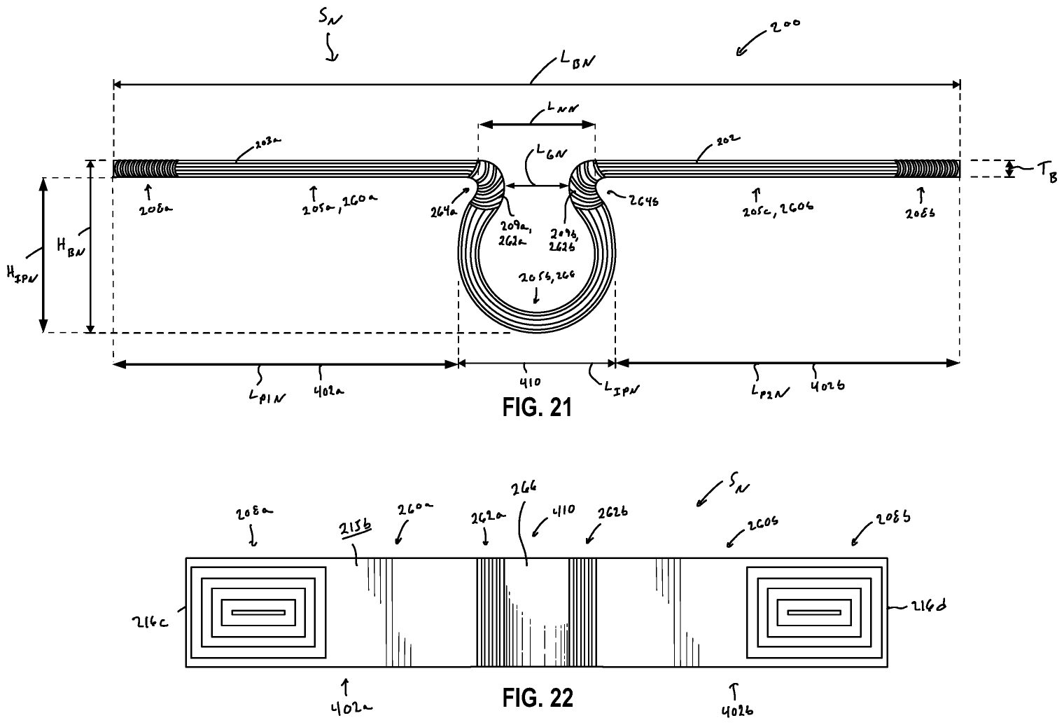

The unbent intermediate portion length L_{IPU} is approximately equal to the circumference of a circle with the associated interior diameter. For example, a circle having a diameter of 20 mm will have a circumference of approximately 62.8 mm, and, as such, the unbent length of the intermediate portion length is approximately 63 mm. As shown in at least FIGS. 21 and 69, due to the unique geometry of the intermediate portion 410, there is a bend height H_{IPN} which is defined between the outer surface of the uppermost conductor 203j (e.g., at the mid-height of the intermediate portion 410) and the outer surface of the lowermost conductor 203a in either the first peripheral portion 402a or the second peripheral portion 402b. In the neutral state S_{N}, the intermediate portion 410 has a bend height H_{IPN} that is between 20 mm and 28 mm, preferably 23 mm. Also, as shown in at least FIGS. 21 and 69, there is a bend length L_{IPN} of the intermediate portion 410 defined between the opposed outer surfaces of the uppermost conductor 203j (e.g., at the mid-length of the intermediate portion 410). In the neutral state S_{N}, the intermediate portion 410 has a bend length L_{IPN} that is between 23 mm and 31 mm, and preferably 27 mm. In other words, the design of this busbar 200 includes an extent—namely, the intermediate portion 410—that purposely increases the height and space required to mount this busbar 200 within the power distribution assembly 50. This increased space requirement is contrary to the goal of minimizing the space required by electrical connectors. As such, this is an unconventional solution to solve issues associated with material conditions associated with the battery modules 60 and dynamic movement of the battery modules 60. It should be understood that this disclosure contemplates other ratios or calculations based on the above table.

Table 1 (above) shows an activation force F_{A} supplied by the battery modules 62a, 62b and that moves the busbar 200 between the neutral state S_{N} and the compressed state S_{C} or between the neutral state S_{N} ad the extended state S_{E}. Because the busbar 200 responds linearly, the activation force F_{A} is of equal magnitude but opposite direction when moving between the neutral state S_{N} and the compressed state S_{C} versus between the neutral state S_{N} ad the extended state S_{E}. Thus, the activation force F_{A} can be a compressive activation force F_{A} or an expansion activation force F_{A} depending Also, as shown in the above Table 1, increasing the interior diameter of the intermediate portion 410 beyond 22 mm does not significantly reduce the activation force F_{A} (first column) needed to move the busbar 200 between the neutral state S_{N} to either the compressed state S_{C} or extended state S_{E}, but the increase in the interior diameter significantly increases the overall package volume of the busbar 200, which represents the amount of space in the battery pack that needs to be reserved for installation and operation of the elastically deformable connector system 100. For example, doubling the size of the interior diameter of the intermediate portion 410 from 10 mm to 20 mm, reduces the activation force F_{A} by over seven times from 312 N to 42 N. However, increasing the size of the interior diameter of the intermediate portion 410 from 20 mm to 30 mm, only reduces the activation force F_{A} by over 1.5 times from 42 N to 30 N. Thus, the configuration with the smallest package size that requires less than 50 Newtons of activation force F_{A} to move between states is a busbar 200 with an interior diameter of 20 mm. This relationship is believed to be an optimal balance between the decrease in activation force F_{A} and the increase in package size. It should be understood that other busbar 200 configurations (e.g., material, thickness, width, configuration of the intermediate portion, weldments, and etc.) may alter the above calculations and/or change the ratios between the above properties. For example, increasing the thickness of each conductor 202 or the number of conductors 202 without altering other measurements will likely increase the force needed to move the busbar 200 from the neutral state S_{N} to either the compressed state S_{C} or extended state S_{E}. Similarly, decreasing the thickness of each conductor 202 or the number of conductors 202 without altering all other measurements will likely decrease the force needed to move the busbar 200 from the neutral state S_{N} to either the compressed state S_{C} or extended state S_{E}.

Additionally, the volume of the intermediate portion 410 is greater than: (i) the volume of the peripheral portions 402a, 402b, and (ii) the volume of a connector that replaces the intermediate portion 410, which is linear and extends between the peripheral portions 402a, 402b. Further, the upper surface area (e.g., 1,233 mm²) of the intermediate portion 410 is greater than: (i) the surface area (e.g., 866 mm²) of the peripheral portions 402a, 402b, and (ii) the surface area of a connector that replaces the intermediate portion 410, which is linear and extends between the peripheral portions 402a, 402b. As such, the peripheral portions 402a, 402b contain less material then: (i) intermediate portion 410, and (ii) a connector that replaces the intermediate portion 410, which is linear and extends between the peripheral portions 402a, 402b.

### iv. Selective Welding a Second Extent of the Busbar

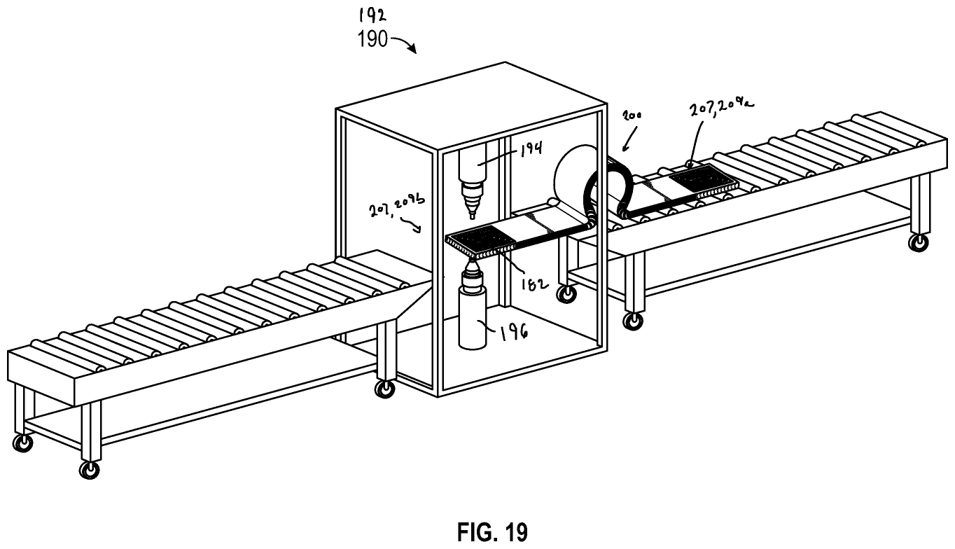

Next, the designer will: (i) insert the bent busbar 202 into the machine 192 and (ii) provide fusing instructions to machines 192 (e.g., load an engineering model) that are associated with the second end sector 207, 208b and the second extent 212b of the busbar 200. The laser welding machine 192 will then perform the fusion process 180 that is described in its instructions. For example, FIG. 19 shows the busbar 200 in a horizontal orientation where its width resides in a plane that is oriented substantially perpendicular to the lasers 194, 196. In this horizontal orientation, the machine 192 performs a surface-based fusion process (i.e., vertical partial penetration weldment process 182) on the end sector 207 of the busbar 200 according to the instructions associated with said second end sector 208b of the busbar 200. Next, the busbar 200 is rotated to vertical orientation where its thickness resides in a plane that is oriented substantially perpendicular to the lasers 194, 196. In this vertical orientation, the machine 192 performs an edge-based fusion process (i.e., a lateral partial penetration weldment process 184) on the second extent 212b of the busbar 200 according to the instructions associated with said second extent 212b. After the selective welding of the second end sector 208b and the second extent 212b of the central sector 210, the busbar shown in FIGS. 20-24 is formed.

### v. Optional Fabrication Steps

After the above described welding processes have been completed, the optional fabrication steps may be completed. For example, completing the optional fabrication steps may include: (a) assembling and coupling connectors 1000 to the busbar 200, (c) insulating the busbar 200, (d) plating an extent of the busbar 200 and/or placing the busbar 200 in the housing 600.

### B. Male Connector Assembly

Referring to FIG. 15, the male connector assembly 1000 is comprised of: (i) a housing assembly 1100, and (ii) a male terminal assembly 1430 having a spring member 1440c and a male terminal 1470. Said male terminal assembly 1430 is coupled to the first and second peripheral portions 402a, 402b of the busbar 200 using any known coupling process, including laser welding and/or ultrasonic welding. It should be understood that connector assembly 1000 is an example of a potential connector that may be coupled to the busbar 200. This disclosure contemplates utilizing other connectors, including conventional bolted connectors.

i. Male Housing Assembly

The male housing assembly 1100 encases or surrounds a substantial extent of the other components contained within the male terminal assembly 1430. The exterior housing assembly 1100 generally includes: (i) an exterior housing 1104 and (ii) a deformable connector position assurance (“CPA”) 1170. The exterior housing 1104 includes two arrangements of walls, wherein: (i) the first side wall arrangement 1106 has a rectangular shape and is designed to receive an extent of the busbar 200 and (ii) the second side wall arrangement 1108 has a cubic shape and is designed to receive a substantial extent of the male terminal assembly 1430. The second arrangement of walls 1108 includes a non-deformable CPA receiver 1160 that extends from at least one of the walls 1108b and preferably two walls 1108d and is designed to receive an extent of the deformable CPA 1170. The two arrangements of walls are typically formed from an insulating material that is designed to isolate the electrical current that flows through the male connector assembly 1000 from other components. Additional details about the exterior housing assembly 1100 are described within PCT/US2019/36070. It should be understood that the male housing assembly 1100 does not include a lever to assist in the coupling of the male connection assembly 1000 to the female connection assembly 2000.

ii. Male Terminal Assembly

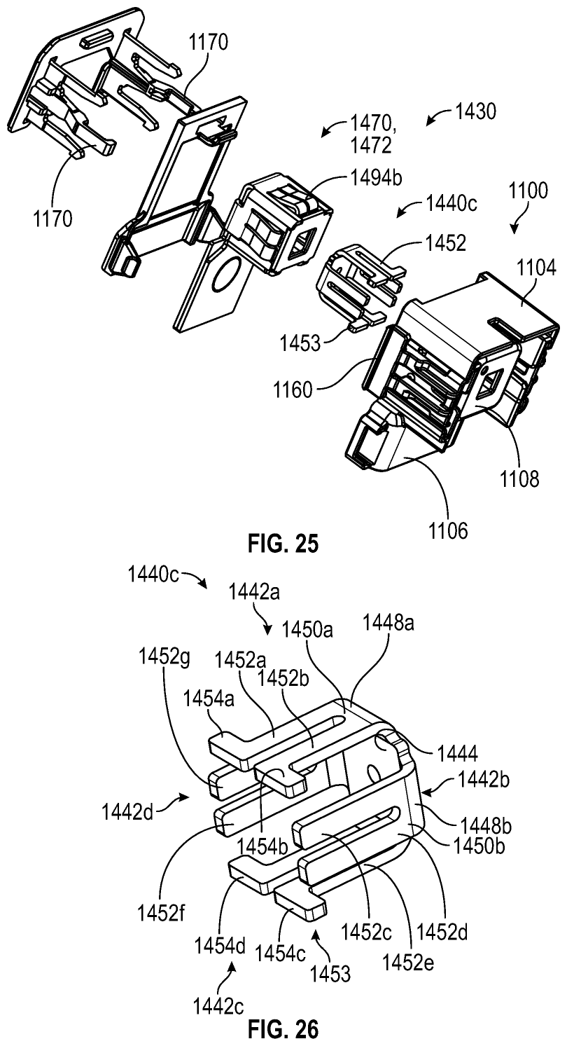

FIGS. 25-30 provide various views of the male terminal assembly 1430, wherein said assembly 1430 includes a spring member 1440c and a male terminal 1470. The male terminal 1470 includes a male terminal body 1472 and a male terminal connection member or plate 1474. Said male terminal body 1472 includes: (i) a first or front male terminal wall 1480 with a touch proof post opening 1510 formed therein, (ii) an arrangement of male terminal side walls 1482a-1482d, and (iii) a second or rear male terminal wall 1484. The combination of these walls 1480, 1482a-1482d forms a spring receiver 1486 that is designed to receive the internal spring member, male spring member, or second spring member 1440c.

Referring to FIG. 26, the internal spring member 1440c includes an arrangement of spring member side walls 1442a-1442d and a rear spring wall 1444. The arrangement of spring member side walls 1442a-1442d each is comprised of: (i) a first or arched spring section 1448a-1448d, (ii) a second spring section, a base spring section, or a middle spring section 1450a-1450d, (iii) a third section or spring arm 1452a-1452h, and (iv) a forth section or centering means 1453. The arched spring sections 1448a-1448d extend between the rear spring wall 1444 and the base spring sections 1450a-1450d and position the base spring sections 1450a-1450d substantially perpendicular to the rear spring wall 1444. In other words, the outer surface of the base spring sections 1450a-1450d is substantially perpendicular to the outer surface of the rear spring wall 1444.

The base spring sections 1450a-1450d are positioned between the arched sections 1448a-1448d and the spring arms 1452a-1452h. As shown in FIG. 26, the base spring sections 1450a-1450d are not connected to one another and thus gaps are formed between the base spring sections 1450a-1450d of the spring member 1440c. The gaps aid in omnidirectional expansion of the spring arms 1452a-1452h, which facilitates the mechanical coupling between the male terminal 1470 and the female terminal assembly 2430. The spring arms 1452a-1452h extend from the base spring sections 1450a-1450d of the spring member 1440c, away from the rear spring wall 1444, and terminate at a free end 1446. The spring arms 1452a-1452h are generally planar and are positioned as such the outer surface of the spring arms 1452a-1452h are coplanar with the outer surface of the base spring sections 1450a-1450d. Unlike the spring arm 31 that is disclosed within FIGS. 4-8 of PCT/US2018/019787, the free end 1446 of the spring arms 1452a-1452h do not have a curvilinear component. Instead, the spring arms 1452a-1452h have a substantially planar outer surface. This configuration is beneficial because it ensures that the forces associated with the spring member 1440c are applied substantially perpendicular to the free end 1488 of the male terminal body 1472. In contrast, the curvilinear components of the spring arm 31 are disclosed within FIGS. 4-8 of PCT/US2018/019787 do not apply a force in this manner.

Like the base spring sections 1450a-1450d, the spring arms 1452a-1452h are not connected to one another. In other words, there are spring arm openings that extend between the spring arms 1452a-1452h. This configuration allows for the omnidirectional movement of the spring arms 1452a-1452h, which facilitates the mechanical coupling between the male terminal 1470 and the female terminal assembly 2430. In other embodiments, the spring arms 1452a-1452h may be coupled to other structures to restrict their omnidirectional expansion. The number and width of individual spring arms 1452a-1452h and openings may vary. In addition, the width of the individual spring arms 1452a-1452h is typically equal to one another; however, in other embodiments one of the spring arms 1452a-1452h may be wider than other spring arms.

A previous design of the spring member 1440pd is disclosed in connection with FIGS. 5-6 of PCT/US2019/36127 and FIG. 13 of PCT/US2021/043686 shows how the spring member 1440pd may be perfectly aligned within the male terminal body 1472pd of the male terminal assembly 1430pd. However, due to manufacturing tolerances and imperfect assembly methods, the spring member 1440pd may become misaligned or cocked within the male terminal body 1472pd during assembly of the male terminal assembly 1430pd. An example of this misalignment is shown in FIG. 14 of PCT/US2021/043686, wherein angle theta θ shows this misalignment as it extends between the inner surface of the spring receive and the outer surface of the spring member 1440pd. In certain embodiments, angle theta θ may be between 1 degree and 5 degrees. In order to help avoid this misalignment, the spring member 1440c disclosed herein includes centering means 1453, which is shown as anti-rotation projections 1454a-1454d. The anti-rotation projections 1454a-1454d help center the spring member 1440c by limiting the amount the spring member 1440c can rotate within the male terminal body 1472 due to the interaction between the outer surface of the projections 1454a-1454d and an inner surface of the side wall portions 1492a-1492d of the male terminal body 1472. Properly centering the spring member 1440c within the male terminal body 1472, provides many advantages over terminals that are not properly centered or aligned within the male terminal assembly 1430, wherein these advantages includes: (i) ensuring that the spring member 1440c applies a proper force on the male terminal body 1472 to provide a proper connection between the male terminal assembly 1430 and the female terminal assembly 2430, (ii) helps improve the durability and useable life of the terminal assemblies 1430, 2430, and (iv) other beneficial features that are disclosed herein or can be inferred by one of ordinary skill in the art from this disclosure.

It should be understood that is other embodiments the centering or alignment means 1453 may take other forms, such as: (i) projections that extend outward from the first and second spring arms 1452a, 1452b that are positioned within a single side wall, (ii) projections that extend outward from the first and fifth spring arms 1452a, 1452e, wherein the projections are situated diagonally opposite from one another, (iii) projections that extend outward from all spring arms 1452a-1452h, wherein the projections associated with 1452c, 1452d, 1452g, 1452h are offset positional relationship in comparison to the projections associated with 1452a, 1452b, 1452e, 1452f, (iv) projections that extend inward from the inside walls of the male terminal body 1472, (v) projections that extend inward towards the center of the connector from the contact arms 1494a-1494h, (vi) cooperative dimensioned spring retainer, (vii) projections, tabs, grooves, recesses, or extents of other structures that are designed to help ensure that the spring member 1440c is centered within the male terminal body 1472 and cannot rotate within the spring receiver 1486. For example, a projection may extent from the front or rear walls of the male terminal body 1472 and they may be received by an opening formed within the spring member 1440c.

It should further be understood that instead of utilizing a mechanical based centering or alignment means 1453, the centering means 1453 may be force based, wherein such forces that may be utilized are magnetic forces or chemical forces. In this example, the rear wall of the spring member 1440c may be welded to the rear wall of the male terminal body 1472. In contrast to a mechanical or force based centering means 1453, the centering means 1453 may be a method or process of forming the male terminal assembly 1430. For example, the centering means 1453 may not be a structure, but instead may simultaneous printing of the spring member 1440c within the male terminal body 1472 in a way that does not require assembly. In other words, the centering means 1453 may take many forms (e.g., mechanical based, force based, or process based) to achieve the purpose of centering the spring member 1440c within the male terminal body 1472.

The internal spring member 1440c is typically formed from a single piece of material (e.g., metal); thus, the spring member 1440c is a one-piece spring member 1440c or has integrally formed features. In particular, the following features are integrally formed: (i) the arched spring section 1448a-1448d, (ii) the base spring section 1450a-1450d, (iii) the spring arm 1452a-1452h, and (iv) the centering means 1453. To integrally form these features, the spring member 1440c is typically formed using a die forming process. The die forming process mechanically forces the spring member 1440c into shape. As discussed in greater detail below and in PCT/US2019/036010, when the spring member 1440c is formed from a flat sheet of metal, installed within the male terminal 1472 and connected to the female receptacle 2472, and is subjected to elevated temperatures, the spring member 1440c applies an outwardly directed spring thermal force S_{TF} on the contact arms 1494a-1494h due in part to the fact that the spring member 1440c attempts to return to a flat sheet. However, it should be understood that other types of forming the spring member 1440c may be utilized, such as casting or using an additive manufacturing process (e.g., 3D printing). In other embodiments, the features of the spring member 1440c may not be formed from a one-piece or be integrally formed, but instead formed from separate pieces that are welded together.

In an alternative embodiment that is not shown, the spring member 1440c may include recesses and associated strengthening ribs. As discussed in PCT/US2019/036010, these changes to the configuration of the spring member 1440c alter the forces that are associated with the spring member 1440c. In particular, the spring biasing force S_{BF} is the amount of force that is applied by the spring member 1440c to resist the inward deflection of the free end 1446 of the spring member 1440c when the male terminal assembly 1430 is inserted within the female terminal assembly 2430. Specifically, this inward deflection occurs during the insertion of the male terminal assembly 1430 due to the fact that an extent of an outer surface of the male terminal body 1472 is slightly larger than the interior of the female receptacle 2472. Thus, when the male terminal assembly 1430 is inserted into the female terminal assembly 2430, the extent of the outer surface is forced towards the center 1490 of the male terminal 1470. This inward force on the outer surface displaces the free end 1446 of the spring member 1440c inward (i.e., towards the center 1490). The spring member 1440c resists this inward displacement by providing a spring biasing force SF.

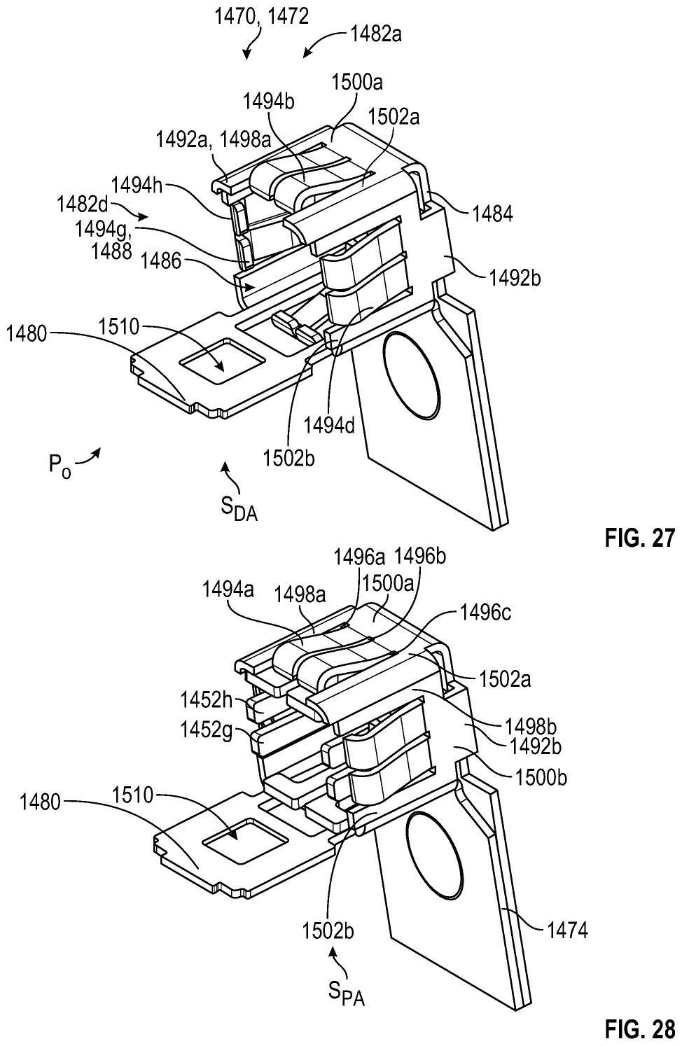

FIGS. 27-30 show a male terminal 1470 that includes the male terminal body 1472 and a male terminal connection plate 1474. Specifically, the male terminal connection plate 1474 is coupled to the male terminal body 1472 and is configured to receive an extent of a structure (e.g., busbar) that connects the male terminal assembly 1430 to a device (e.g., second battery module 60) outside of the connector system 100. The conductor 202 is typically welded to the connection plate 1474; however, other methods (e.g., forming the conductor 202 as a part of the connection plate 1474) of connecting the conductor 202 to the connection plate 1474 are contemplated by this disclosure.

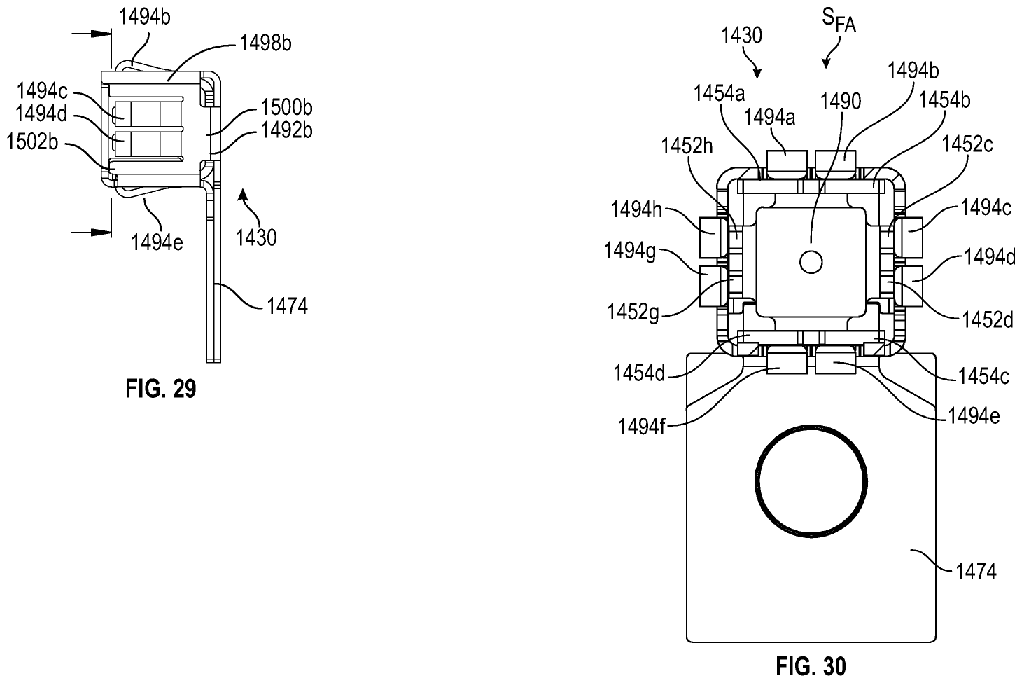

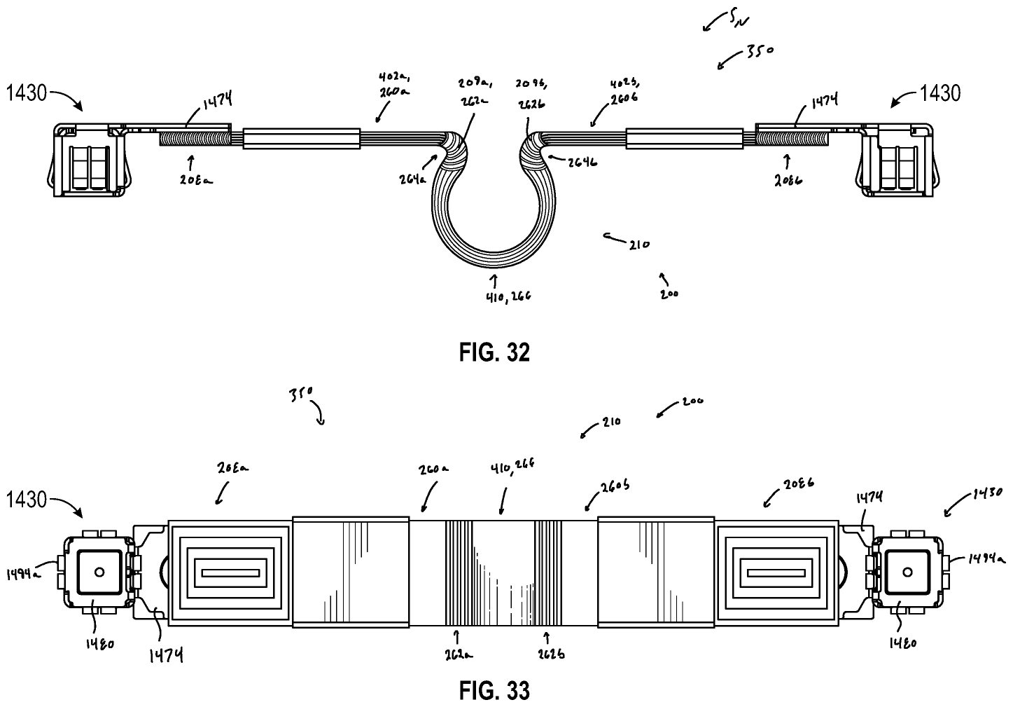

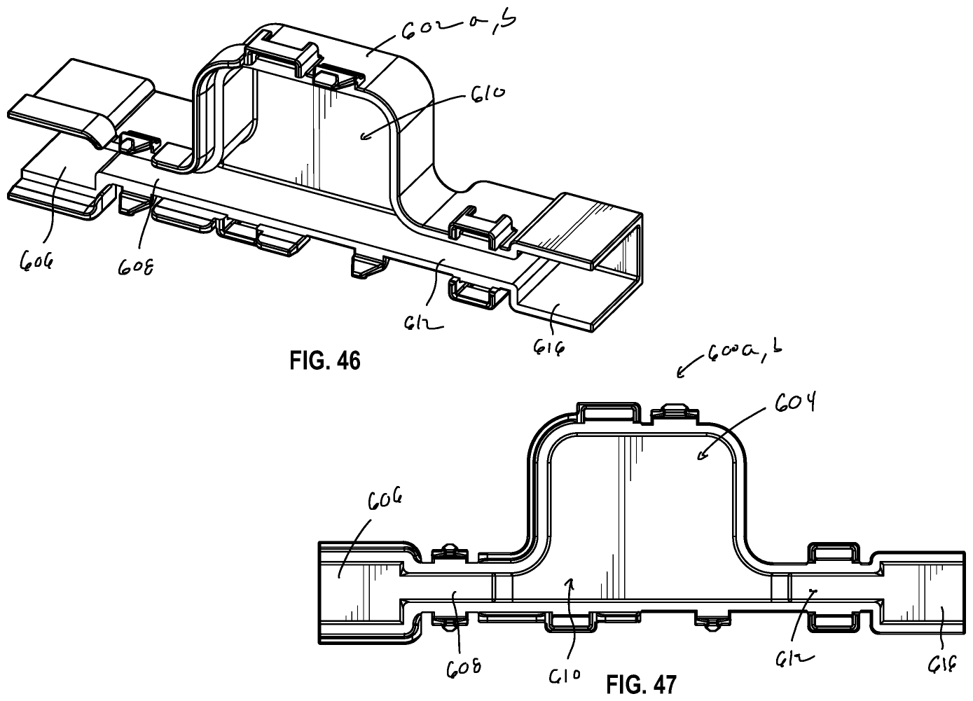

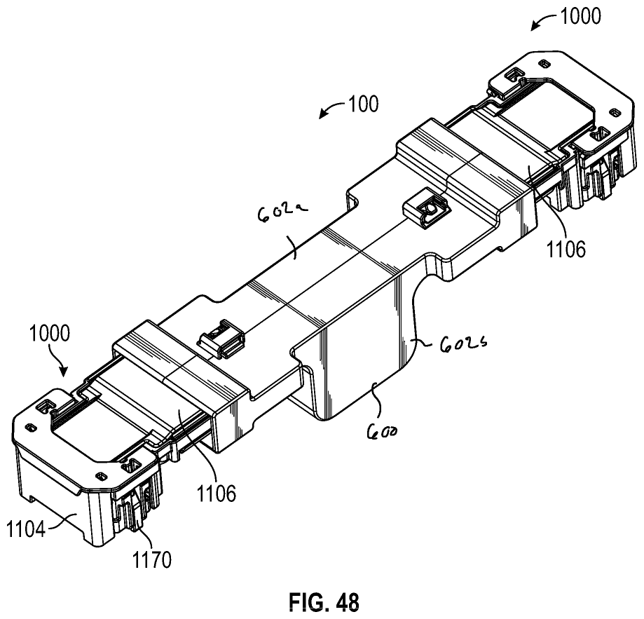

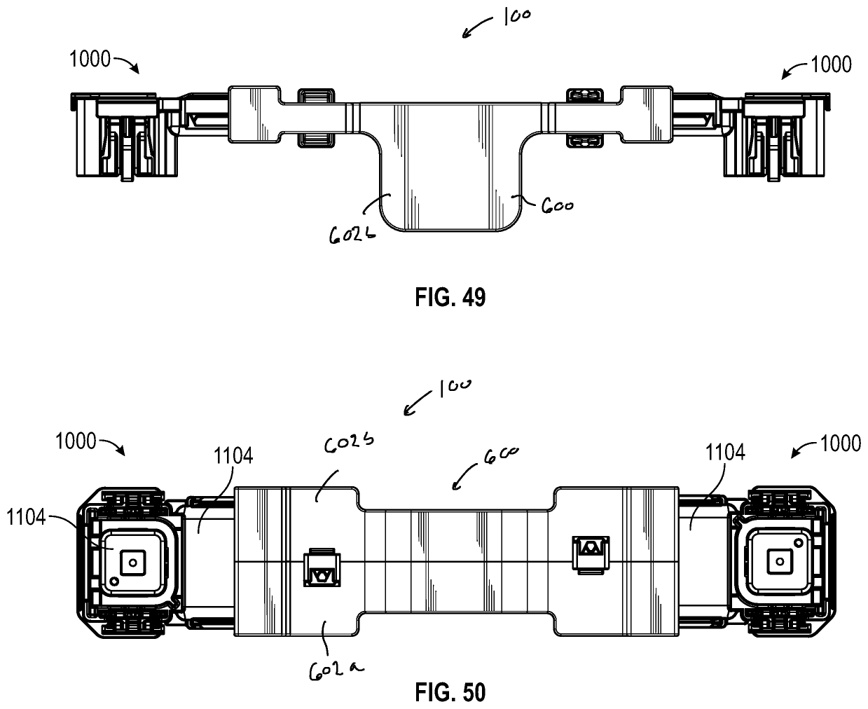

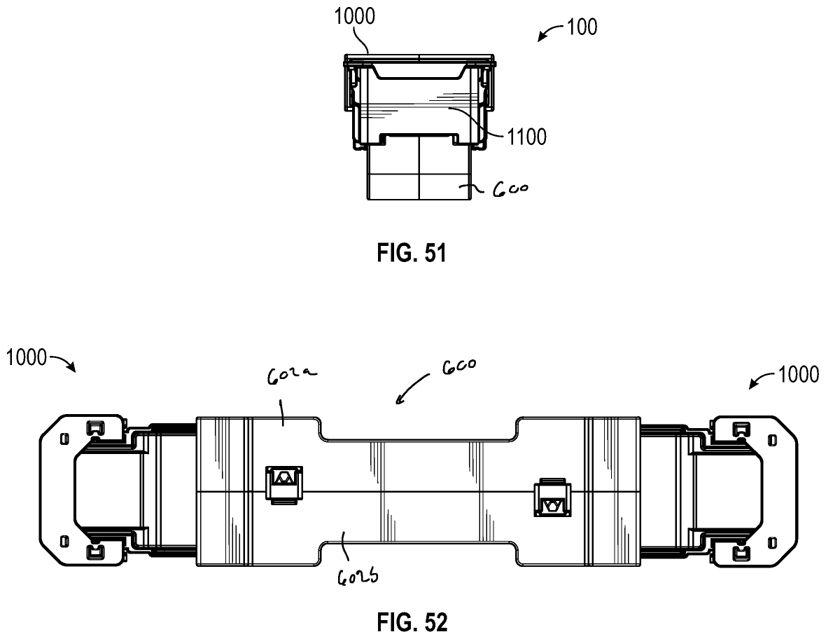

As shown in FIGS. 27-30 the arrangement of male terminal side walls 1482a-1482d are coupled to one another and generally form a rectangular prism. The arrangement of male terminal side walls 1482a-1482d includes: (i) a side wall portion 1492a-1492d, which generally has a “U-shaped” configuration, (ii) contact arms 1494a-1494h, and (iii) a plurality of contact arm openings 1496a-14961. As best shown in FIGS. 28-29, the side wall portions 1492a-1492d are substantially planar and have a U-shaped configuration. The U-shaped configuration is formed from three substantially linear segments, wherein a second or intermediate segment 1500a-1500d is coupled on one end to a first or end segment 1498a-1498d and on the other end to a third or opposing end segment 1502a-1502d. The contact arms 1494a-1494h extend: (i) from an extent of the intermediate segment 1500a-1500d of the side wall portion 1492a-1492d, (ii) away from the rear male terminal wall 1484, (iii) across an extent of the contact arm openings 1496a-14961, and (iv) terminate just short of the front male terminal wall 1480. This configuration is beneficial over the configuration of the terminals shown in FIGS. 9-15, 18, 21-31, 32, 41-42, 45-46, 48 and 50 in PCT/US2018/019787 because it allows for: (i) can be shorter in overall length, which means less metal material is needed for the formation and the male terminal 1470 can be installed in narrower, restrictive spaces, (ii) has a higher current carrying capacity, (iii) is easier to assemble, (iv) improved structural rigidity because the contact arms 1494a-1494h are positioned inside of the first male terminal side wall portion 1492a-1492d, (iv) benefits that are disclosed in connection with PCT/US2019/036010, and (v) other beneficial features that are disclosed herein or can be inferred by one of ordinary skill in the art from this disclosure.

The contact arm openings 1496a-14961 are integrally formed with the central sector 1500a-1500d of the male terminal side walls 1482a-1482d. The contact arm openings 1496a-14961 extend along the lateral length of the contact arms 1494a-1494h in order to create a configuration that permits the contact arms 1494a-1494h not to be laterally connected to: (i) another contact arm 1494a-1494h or (ii) a structure other than the extent of the male terminal side wall portion 1492a-1492d to which the contact arms 1494a-1494h are coupled thereto. Additionally, the contact arm openings 1496a-14961 are aligned with the spring arm openings. This configuration of openings forms the same number of spring arms 1452a-1452h as the number of contact arms 1494a-1494h. In other words, FIG. 28 show eight spring arms 1452a-1452h and eight contact arms 1494a-1494h. It should be understood that in other embodiments, the number of spring arms 1452a-1452h may not match the number of contact arms 1494a-1494h. For example, there may be fewer than one spring arms 1452a-1452h.

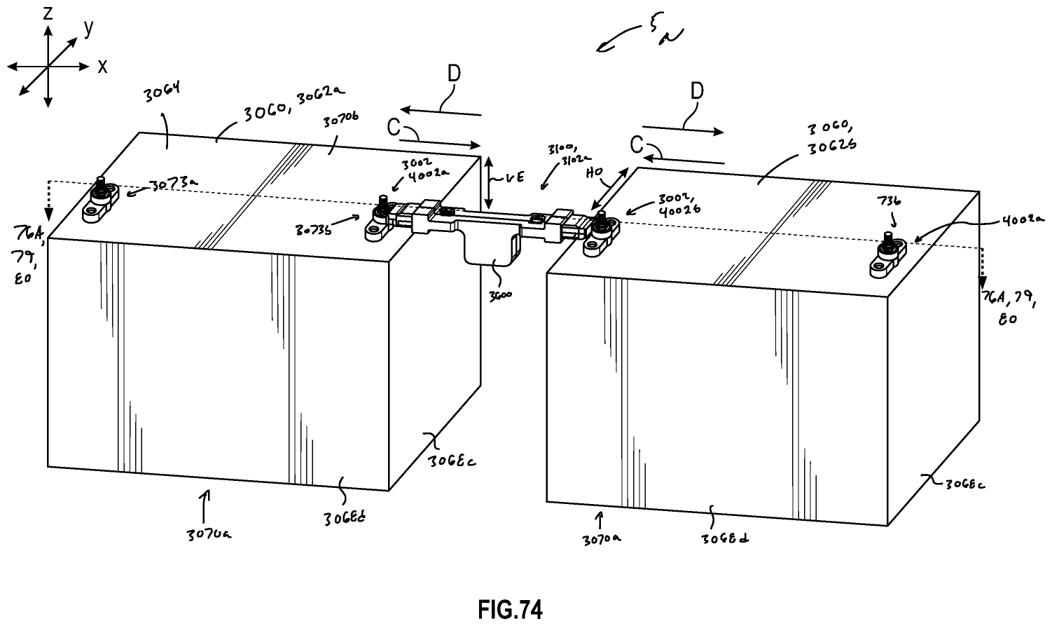

The contact arms 1494a-1494h extend away from the rear male terminal wall 1484 at an outward angle. In particular, the outward angle may be between 0.1 degree and 16 degrees between the outer surface of the extent of the male terminal side wall 1492a-1492d and the outer surface of the first extent of the contact arms 1494a-1494h, preferably between 5 degrees and 12 degrees and most preferably between 7 degrees and 8 degrees. This outward angle is shown in multiple figures, but may be best visualized in connection with FIGS. 28-29. This configuration allows the contact arms 1494a-1494h to be deflected or displaced inward and towards the center 1490 of the male terminal 1470 by the female receptacle 2472, when the male terminal assembly 1430 is inserted into the female terminal assembly 2430. In particular, the male terminal body 1472 has an outer perimeter that extends around the outermost extent of the contact arms 1494a-1494h. In a disconnected state S_{D} (i.e., when the male terminal body 1472 is not inserted within the female terminal assembly 2430), the outer perimeter of the male terminal body has an uncompressed dimension. In a fully connected state S_{FC} (i.e., when the male terminal body 1472 is inserted within the female terminal assembly 2430 (see FIG. 73)), the outer perimeter of the male terminal body has a compressed dimension. And wherein the compressed dimension is less than the uncompressed dimension. In this disclosed embodiment, the uncompressed dimension is between 1% and 15% larger than the compressed dimension due to the configuration and design of the male terminal body 1472 and the female terminal body 2430. This inward deflection is best shown in FIGS. 74, which is evidenced by the gap 1550. This inward deflection helps ensure that a proper mechanical and electrical connection is created by ensuring that the contact arms 1494a-1494h are placed in contact with the female receptacle 2472.

As shown in FIG. 27-29, the terminal ends of the contact arms 1494a-1494h are positioned: (i) within an aperture formed by the U-shaped side wall portions 1492a-1492d, (ii) substantially parallel to the male terminal side wall 1492a-1492d, and (iii) in contact the planar outer surface of the spring arms 1452a-1452h, when the spring member 1440c is inserted into the spring receiver 1486. This configuration is beneficial over the configuration shown in FIGS. 3-8 in PCT/US2018/019787 because the assembler of the male terminal assembly 1430 does not have to apply a significant force in order to deform a majority of the contact arms 1494a-1494h outward to accept the spring member 1440c. This required deformation can best be shown in FIG. 6 of PCT/US2018/019787 due to the slope of the contact arm 11 and the fact the outer surface of the spring arm 31 and the inner surface of the contact arm 11 are adjacent to one another without a gap formed therebetween. In contrast to FIGS. 3-8 in PCT/US2018/019787, FIG. 30 of the present application show a very small gap that is formed between the outer surfaces of the spring member 1440c and the inner surface of the contact arms 1494a-1494h. Accordingly, very little force is required to insert the spring member 1440c into the spring receiver 1486 due to the fact the assembler does not have to force the contact arms 1494a-1494h to significantly deform during the insertion of the spring member 1440c.

The male terminal 1470 is typically formed from a single piece of material (e.g., metal); thus, the male terminal 1470 is a one-piece male terminal 1470 and has integrally formed features. To integrally form these features, the male terminal 1470 is typically formed using a die-cutting process. However, it should be understood that other types of forming the male terminal 1470 may be utilized, such as casting or using an additive manufacturing process (e.g., 3D printing). In other embodiments, the features of the male terminal 1470 may not be formed from a one-piece or be integrally formed, but instead formed from separate pieces that are welded together. In forming the male terminal 1470, it should be understood that any number (e.g., between 1 and 100) of contact arms 1494a-1494h may be formed within the male terminal 1470.

Positioning the internal spring member 1440c within the male terminal assembly 1430 occurs across multiple steps or stages. FIG. 27 provides the first embodiment of the male terminal assembly 1430 in a disassembled state SDA, FIG. 28 provides the first embodiment of the male terminal assembly 1430 in a partially assembled state S_{PA}, and FIG. 29 provides the first embodiment of the male terminal assembly 1430 in a fully assembled state S_{FA}. The first stage of assembling the male terminal assembly 1430 is where the front male terminal wall 1480 is in an open or flat position P_{O} and the spring member 1440c is separated from the male terminal 1470. In this open position P_{O}, the front male terminal wall 1480 is substantially coplanar with one of the male terminal side wall 1482c. This configuration of the male terminal 1470 exposes the spring receiver 1486 and places the male terminal 1470 in a state that is ready for receiving the spring member 1440c. The second stage of assembling the male terminal assembly 1430 is shown in FIG. 28, where the front male terminal wall 1480 remains in the open or horizontal position P_{O} and the spring member 1440c is positioned within or inserted into the spring receiver 1486. To reach the partially assembled state S_{PA}, an insertion force, F_{I}, has been applied to the spring member 1440c to insert the spring member 1440c into the spring receiver 1486. The insertion force, F_{I}, is applied on the spring member 1440c until the second or rear male terminal wall 1484 is positioned adjacent to the rear spring wall 1444, a free end 1488 of the male terminal 1470 is substantially aligned with a free end 1446 of the spring member 1440c, and a portion of the male terminal side walls 1482a-1482d are positioned adjacent a portion of the spring member side walls 1442a-1442d.

The third stage of assembling the male terminal assembly 1430 is shown in FIG. 29, where: (i) the front male terminal wall 1480 is closed or vertical P_{CL} and (ii) the spring member 1440c is positioned within the spring receiver 1486. To close the front male terminal wall 1480, an upward directed force, F_{U}, is applied to the male terminal wall 1480 to bend it about its seam to place it adjacent to the side walls 1482a-1482d. After the front male terminal wall 1480 is in the proper position, the top edge is coupled (e.g., welded) to the side wall 1480 of the male terminal body 1472. Here, the closed or vertical P_{CL} of the front male terminal wall 1480 ensures that the spring member 1440c is retained within the male terminal 1470. It should be understood that in other embodiments, the front male terminal wall 1480 may be omitted, may not have a touch proof post opening therethrough, may not extend the entire way from side wall 1482a-1482d (e.g., partially extending from any side wall 1482a-1482d), or may be a separate piece that is coupled to both side walls 1482a-1482d.

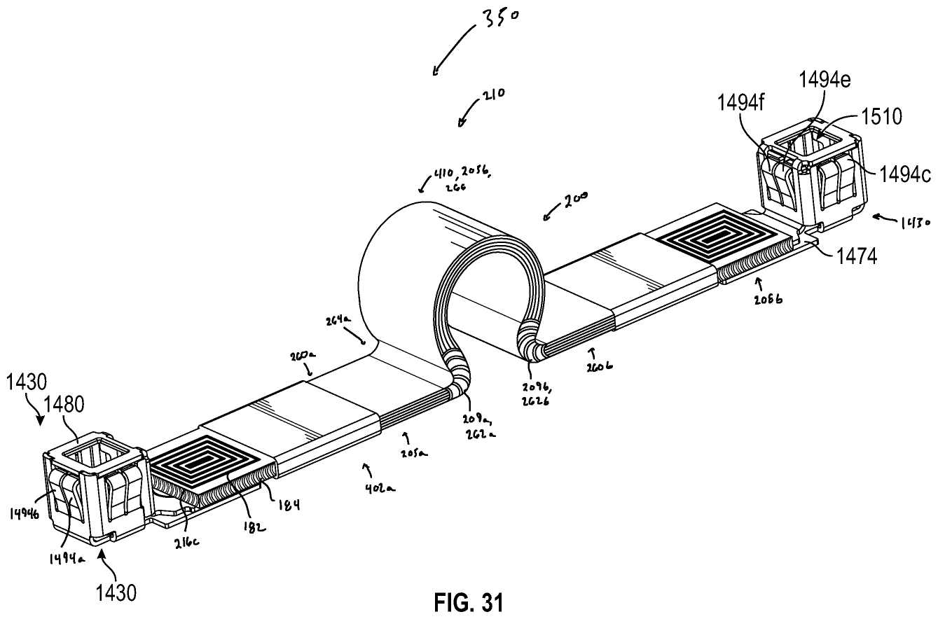

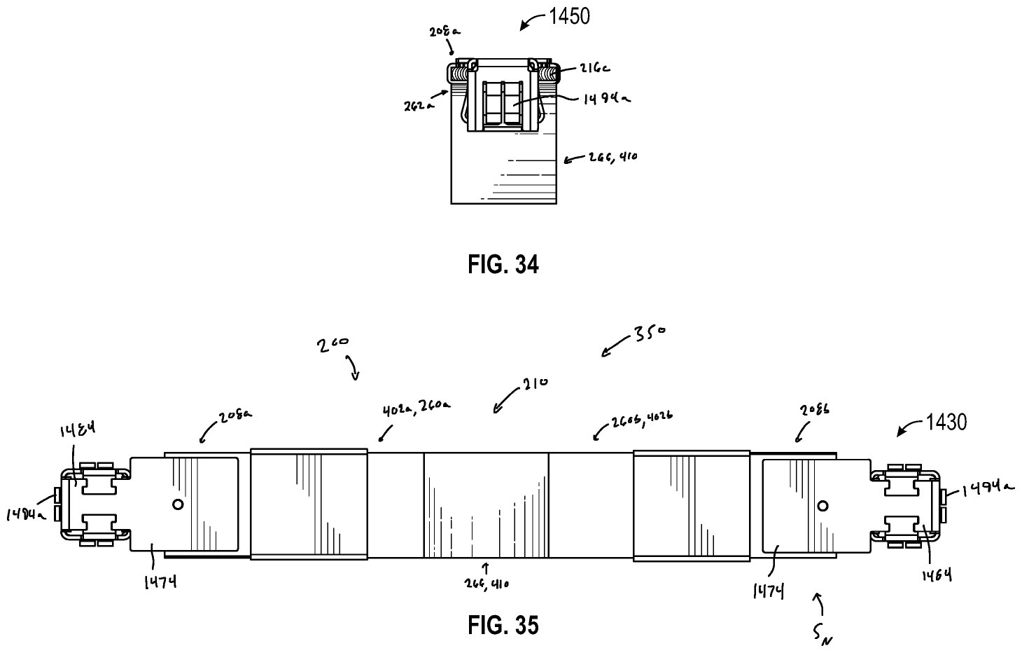

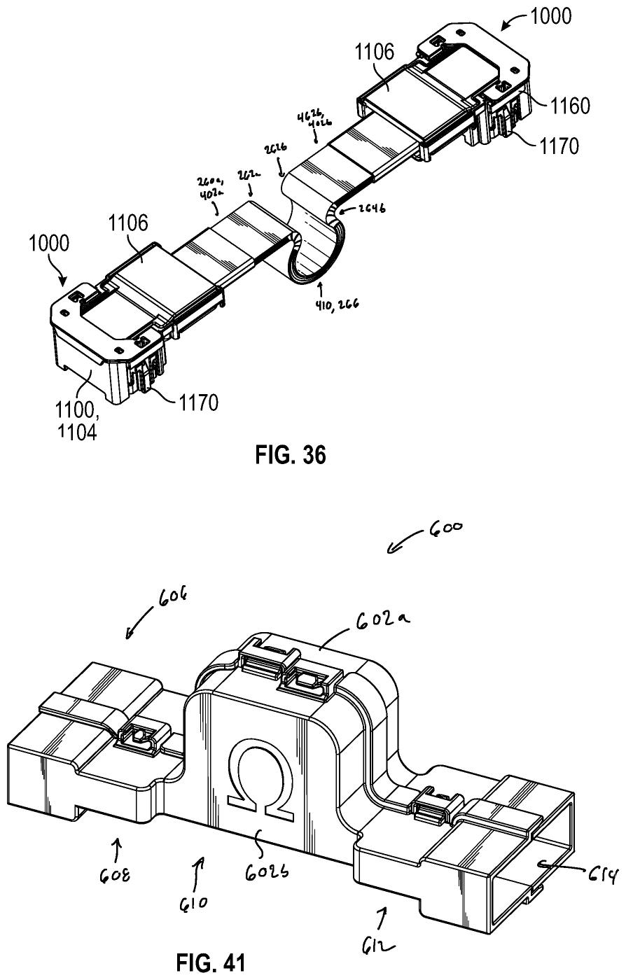

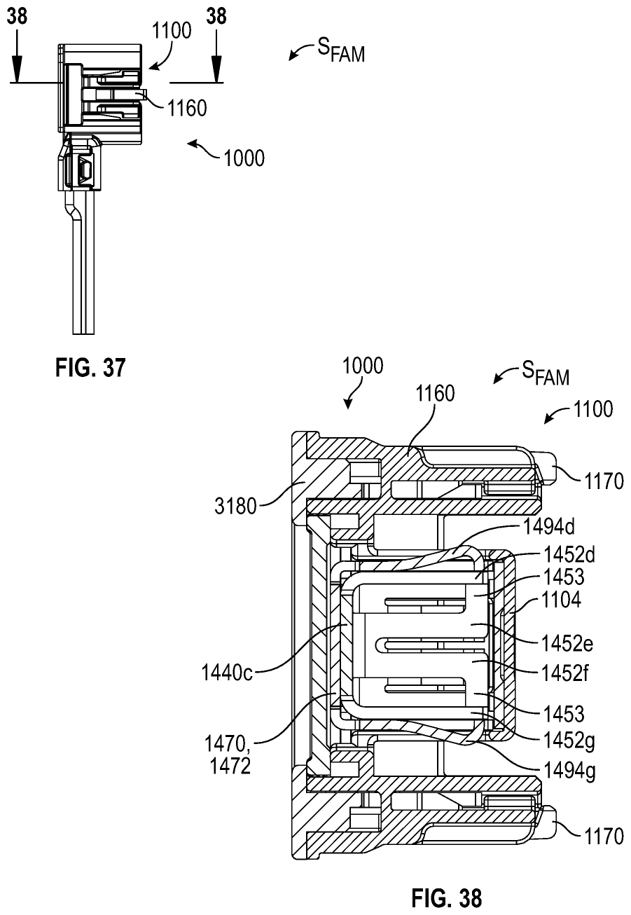

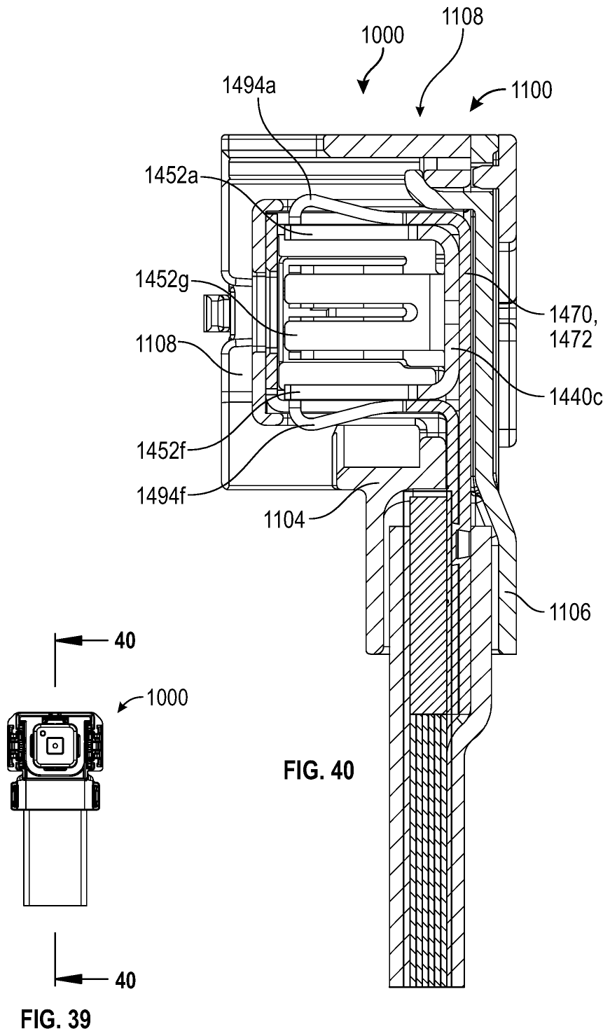

After the male terminal assembly 1430 has been assembled, the manufacture will perform the next step of coupling said male terminal assemblies 1430 to the end sectors 207 of the busbar 200. The coupling of these terminal assembly 1430 may be accomplished by any known means, including laser welding (e.g., surface based vertical partial penetration weldment process). Once said terminal assemblies 1430 are coupled to the busbar 200, the elastically deformable electrical conductive assembly 350 is assembled and shown in FIGS. 31-35. From here, the male housing assembly 1100 can be installed around the elastically deformable electrical conductive assembly 350. Installation of said male housing assembly 1100 leads to the formation of the system 100 shown in FIGS. 36-40. While a number of steps are disclosed herein in a particular order, it should be understood that the order of these steps is not critical to the formation of the system 100. In other words, the disclosed steps can be performed in any order and some of the steps may be skipped or combined.

### C. Female Connector Assembly

Referring to FIGS. 55, 60, 63, 65 and 66, each battery module 60 includes two female connector assemblies 2000, wherein one female connector assembly 2000 is a negative female connector assembly 2000a, and the other female connector assembly 2000 is a positive female connector assembly 2000b. The female connector assemblies 2000 are comprised of: (i) a female housing 2100 and (ii) a female terminal assembly 2430. The female housing 2100 is designed to: (i) receive the female terminal assembly 2430, (ii) facilitate the coupling of the male terminal assembly 1430 with the female terminal assembly 2430, (iii) minimize the chance that a foreign object accidentally makes contact with the female terminal assembly 2430, and (iv) meet industry performance and reliability standards, such as USCAR specifications.

The female housing 2100 includes a wall arrangement 2110 having four sidewalls 2112a-2112d. Said sidewalls 2112a-2112d extend upward from an upper surface of a support structure and have a configuration that substantially matches the configuration of the female terminal assembly 2430. In the embodiment shown in the figures, the female terminal assembly 2430 has a cuboidal configuration and thus the sidewalls 2112a-2112d have a linear configuration and form a cuboidal receiver. However, it should be understood that alterations to the shape of the female terminal assembly 2430 (e.g., use of a cylindrical terminal) may require that the shape and configuration of the sidewalls 2112a-2112d be altered to mirror the shape of the terminal (e.g., hollow cylinder).

The sidewalls 2112a-2112d have a height that is greater than the height of the female terminal assembly 2430. The delta between these heights allows for the sidewalls 2112a-2112d to include at least one male compression means 2140. As shown in the Figures, the male compression means 2140 is a sloped or ramped surface 2144 that extends from an outermost edges 2120a-2120d of the sidewalls 2112a-2112d to the upper most edges 2430a-2430d of the female terminal assembly 2430. In the disclosed embodiment, the sloped or ramped surface 2144 extends from each of the outermost edges 2120a-2120d and has a substantially linear configuration. However, it should be understood that the sloped or ramped surface 2144 may only extend from one or two of the outermost edges 2120a-2120d. The male compression means 2140, and the sloped or ramped surface 2144 shown in the Figures, is designed to compress the contact arms 1494a-1494h as the male terminal assembly 1430 moves from being separated from the female terminal assembly 2430 in a disconnected state Sp to being positioned within an extent of the female terminal assembly 2430 in a fully connected state S_{FC} (see FIGS. 73). As such, the distance between opposed outermost edges 2120a-2120d is equal to a sidewall distance, wherein the sidewall distance is greater than the rearmost edge distance that extends between opposed rearmost edges 2124a-2124d of the sloped or ramped surface 2144. And wherein the rearmost edge distance is greater than or equal to a receiver distance that extends between opposed inner surfaces 2434a-2434d of the receptacle 2472 of the female terminal assembly 2430. In particular, the sidewall distance is between 0.1% and 15% larger than the receiver distance, and where the receiver distance is equal to or between 0.1% and 3% larger than the rearmost edge distance. In other words, the sloped or ramped surface 2144 is angled relative to the outer surface of the sidewalls 2112a-2112d and/or the inner surfaces 2434a-2434d of the receptacle 2472 of the female terminal assembly 2430. In particular, the interior angle that extends between the inner surface of the sloped or ramped surface 2144 and the outer surface of the sidewalls 2112a-2112d is between 0.1 degrees and 10 degrees.

This sloped or ramped surface 2144 is made from a polymer or plastic material and, as such has a coefficient of friction that is lower than a coefficient of friction associated with a metal surface. In other words, a first friction value is formed when the extent (e.g., a contact arm 1494a-1494h) of the boltless male terminal assembly 1430 engages with a male terminal compression means 2140 formed from a non-metallic material (e.g., plastic). In an alternative embodiment, a second friction value would be formed if the extent (e.g., a contact arm 1494a-1494h) of the boltless male terminal assembly 1430 was to engage with a male terminal compression means formed from a metallic material (e.g., copper). Comparing the friction value from the disclosed embodiment to the friction value alternative embodiment, it should be understood that the first or friction value from the disclosed embodiment is less than the second or friction value alternative embodiment.

The lower coefficient of friction reduces the force that is required to insert the male terminal assembly 1430 into the female terminal assembly 2430. This is beneficial because: (i) industry specifications, including USCAR 25, has requirements that the insertion force cannot be greater than 45 newtons for a class 2 connector and 75 newtons for a class 3 connector and (ii) the use of a greater spring biasing force, which thereby increases the insertion force, is desirable to help ensure that the contact arms of the male terminal assembly remain in contact with the inner surfaces 2434a-2434d of the receptacle 2472 of the female terminal assembly 2430. Further, this lower coefficient of friction is beneficial because the system 100 can move from the disconnected state S_{D} to a fully connected state S_{FC} while meeting class 2/class 3 USCAR specifications without requiring a lever assist. Eliminating the lever assist reduces the size, weight, and cost of manufacturing the connector system 100. It should be understood that to further reduce the coefficient of friction, the sloped or ramped surface 2144 may be coated with a substance that reduces this coefficient or the sloped or ramped surface 2144 may be made from a material that has an even lower coefficient of friction.

Due to the configuration of the male and female connector assemblies 1000, 2000, different levels of force are required during various stages of moving the connector system 100 from the disconnected state S_{D} to the fully connected state S_{FC}. For example, a first force is required to move the male terminal assembly 1430 when an extent (e.g., a contact arm 1494a-1494h) of the male terminal assembly 1430 is in sliding engagement with the male terminal compression means 2140 and a second force is required to move the male terminal assembly 1430 when the extent (e.g., a contact arm 1494a-1494h) male terminal assembly 1430 is positioned in the female terminal receiver 2473. Comparing the forces, it should be understood that the second force is less than the first force. This is beneficial because it provides the user with a tactical feedback to inform the user that the male terminal assembly 1430 is properly seated within the female terminal assembly 2430. In fact, this tactical feedback fells to the user like the boltless male terminal assembly 1430 is being pulled into the female terminal assembly 2430.

To minimize the chance that a foreign object accidentally makes contact with the female terminal assembly 2430, the housing 2100 may include an optional touch proof post 2200. As disclosed within PCT/US2019/036070, the touch proof post 2200 is configured to fit within a touch proof post opening 1510 that is formed within the front wall of the male terminal 1470. In particular, the distance between the outermost edges 2120a-2120d of the sidewalls 2112a-2112d and an outermost edge 2215 of the touch proof post 2200 is smaller than 10 mm and preferably less than 6 mm. The shape of the touch proof post opening 1510 is configured to substantially mirror the shape of the touch proof post 2200. Here, the touch proof probe opening 1510 has a substantially rectangular shape and, more specifically a substantially square shape, while the touch proof post 2200 is in the form of an elongated rectangular prism with two recesses formed in opposite sides of the prism. The mirror of these shapes helps ensure proper insertion of the touch proof post 2200 with the touch proof probe opening 1510 and may provide a reduction in the vibration between the male terminal assembly 1430 and the female terminal assembly 2430. This reduction in the vibration between these components may help reduce failures of the connector system. It should be understood that the touch proof post 2200 and its associated opening 1510 may be omitted or may have another configuration (e.g., as disclosed in U.S. Provisional Application No. 63/222,859, which is incorporated herein by reference).

To minimize the change that the male connector assembly 1000 can be disconnected from the female connector assembly 2000, the female connector assembly 2000 may include an optional non-deformable female CPA structure 2300 that is designed and configured to interact with the male CPA structures 1170, when the connector assemblies 1000, 2000 are coupled to one another. Said non-deformable female CPA structure 2300 is integrally formed with a sidewall 2112a-2112d of the housing 2100. Additional details about the structure and/or function of the female CPA structure 2300 are disclosed in PCTUS2019/036070, PCTUS2020/049870, PCTUS2021/033446, all of which are incorporated herein by reference.

The female terminal assembly 2430 of the female connector assembly 2000 is comprised of female terminal body 2432, which has a plurality of sidewalls 2434a-2434d are integrally formed with a rear wall 2434e. Each of the sidewalls 2434a-2434d and rear wall 2434e have inner surfaces 2436a-2436e, whose combination forms cuboidal terminal receptacle 2472. Said cuboidal terminal receptacle 2472 has a receiver distance that extends between the inner surfaces 2436a-2436d of opposed sidewalls 2434a-2434d. As discussed above, the receiver distance is: (i) less than the sidewall distance and (ii) equal to or greater than the rearmost edge distance. Additionally, the receiver distance is between 0.1% and 15% smaller than a male terminal assembly distance that extends between the outermost extents of opposed contact arms 1494a-1494h. By forming a terminal receptacle 2472 that has a receiver distance that is less than the male terminal assembly distance ensures that the contact arms 1494a-1494h are compressed when the male terminal assembly 1430 is inserted into the female terminal assembly 2430. This compression of the male terminal assembly 1430 compresses the internal spring member 1440c. As such, the spring member 1440c exerts an outwardly directed biasing force on the contact arms 1494a-1494h to help ensure that they remain in contact with the inner surfaces 2436a-2436d of the terminal receptacle 2472 to facilitate the electrical and mechanical coupling of the male terminal assembly 1430 with the female terminal assembly 2430.

The female terminal assembly 2430 is typically formed from metal and preferably a highly conductive metal, such as copper. The female terminal assembly 2430 may be plated or clad with Ni—Ag to prevent the busbar 200 from corroding during and/or after the female terminal assembly 2430 is welded to the busbar 200. As shown in the Figures, the sidewalls 2434a-2434d are not be integrally formed with one another and instead are only integrally formed with the rear wall 2434e. In other embodiments, the female terminal assembly 2430 may have integrally formed sidewalls 2434a-2434d, the sidewalls 2434a-2434d may be made from a different material, and/or the female terminal assembly 2430 may not be plated or clad with Ni—Ag. Once the female terminal assembly 2430 is fabricated, it can be coupled to the busbar and installed within the female housing 2100.

### D. Terminal Properties and Functionality

FIG. 73 depicts a cross-section of the male connector assembly 1000 coupled to the female connector assembly 2000 in the fully connected state S_{FC}. While the below disclosed is discussed in connection with an embodiment of the system 100, it should be understood that this disclosure applies in equal force to other systems, including the other embodiments shown in FIGS. 100-104. As best shown in FIG. 73, shown in the one or more outer surfaces of the spring arms 1452a-1452d contact the free ends 1488 of the respective contact arms 1494a-1494d. As discussed above, the outermost extent of the contact arms 1494a-1494d are slightly larger than the inner extent of the female terminal body 2432. As such, when these components are mated with one another, the spring member 1440c is compressed. This compression of the spring member 1440c creates an outwardly directed biasing force S_{BF} against the contact arms 1494a-1494d and away from the interior of the spring member 1440c.

The male terminal body 1472, including the contact arms 1494a-1494d, may be formed from a first material such as copper, a highly-conductive copper alloy (e.g., C151 or C110), aluminum and/or another suitable electrically conductive material. The first material preferably has an electrical conductivity of more than 80% of IACS (International Annealed Copper Standard, i.e., the empirically derived standard value for the electrical conductivity of commercially available copper). For example, C151 typically has 95% of the conductivity of standard, pure copper compliant with IACS. Likewise, C110 has a conductivity of 101% of IACS. In certain operating environments or technical applications, it may be preferable to select C151 because it has anti-corrosive properties desirable for high-stress and/or harsh weather applications. The first material for the male terminal body 1472 is C151 and is reported, per ASTM B747 standard, to have a modulus of elasticity (Young's modulus) of approximately 115-125 gigapascals (GPa) at room temperature and a coefficient of terminal expansion (CTE) of 17.6 ppm/degree Celsius (from 20-300 degrees Celsius) and 17.0 ppm/degree Celsius (from 20-200 degrees Celsius).

The spring member 1440c may be formed from a second material such as spring steel, stainless steel (e.g., 301SS, ¼ hard), and/or another suitable material having greater stiffness (e.g., as measured by Young's modulus) and resilience than the first material of the male terminal body 1472. The second material preferably has an electrical conductivity that is less than the electrical conductivity of the first material. The second material also has a Young's modulus that may be approximately 193 GPa at room temperature and a coefficient of terminal expansion (CTE) of 17.8 ppm/degree Celsius (from 0-315 degrees Celsius) and 16.9 ppm/degree Celsius (from 0-100 degrees Celsius). In contemplated high-voltage applications, the cross-sectional area of copper alloy forming the first connector is balanced with the conductivity of the selected copper alloy. For example, when a copper alloy having lower conductivity is selected, the contact arms 1494a-1494d formed therefrom have a greater cross-sectional area so as to adequately conduct electricity. Likewise, selection of a first material having a higher conductivity may allow for contact arms 1494a-1494d having a relatively smaller cross-sectional area while still meeting conductivity specifications.

In an example embodiment, the CTE of the second material may be greater than the CTE of the first material, i.e., the CTE of the spring member 1440c is greater than the CTE of the male terminal body 1472. Therefore, when the assembly of the male terminal body 1472 and the spring member 1440c is subjected to the high-voltage and high-temperature environment typical for use of the electrical connector described in the present disclosure, the spring member 1440c expands relatively more than the male terminal body 1472. Accordingly, the outward force S_{BF} produced by the spring member 1440c on the contact arms 1494a-1494d of the male terminal body 1472 is increased in accordance with the increased temperature, which is reference to below as a thermal spring force, S_{TF}.

An example application of the present disclosure, such as for use in a vehicle alternator, is suitable for deployment in a class 5 automotive environment, such as that found in passenger and commercial vehicles. Class 5 environments are often found under the hood of a vehicle, e.g., alternator, and present 150° Celsius ambient temperatures and routinely reach 200° Celsius. When copper and/or highly conductive copper alloys are subjected to temperatures above approximately 150° Celsius said alloys become malleable and lose mechanical resilience, i.e., the copper material softens. However, the steel forming the spring member 1440c retains hardness and mechanical properties when subjected to similar conditions. Therefore, when the male terminal body 1472 and spring member 1440c are both subjected to high-temperature, the first material of the male terminal body 1472 softens and the structural integrity of the spring member 1440c, formed from the second material, is retained, such that the force applied to the softened contact arms 1494a-1494d by the spring member 1440c more effectively displaces the softened contact arms 1494a-1494d outward relative the interior of the male terminal body 1472, in the fully connected position S_{FC}.

The male terminal body 1472, spring member 1440c, and female terminal body 2432, are configured to maintain conductive and mechanical engagement while withstanding elevated temperatures and thermal cycling resulting from high-power, high-voltage applications to which the system 100 is subjected. Further, the male terminal body 1472 and female terminal body 2432 may undergo thermal expansion as a result of the elevated temperatures and thermal cycling resulting from high-voltage, high-temperature applications, which increases the outwardly directed force applied by the male terminal body 1472 on the female terminal body 2432. The configuration of the male terminal body 1472, spring member 1440c, and the female terminal body 2432 increase the outwardly directed connective force therebetween while the connector system 100 withstands thermal expansion resulting from thermal cycling in the connected position Pc.

Based on the above exemplary embodiment, the Young's modulus and the CTE of the spring member 1440c is greater than the Young's modulus and the CTE of the male terminal body 1472. Thus, when the male terminal body 1472 is used in a high power application 10 that subjects the connector system 100 to repeated thermal cycling with elevated temperatures (e.g., approximately 150° Celsius) then: (i) the male terminal body 1472 become malleable and loses some mechanical resilience, i.e., the copper material in the male terminal body 1472 softens and (ii) the spring member 1440c does not become as malleable or lose as much mechanical stiffness in comparison to the male terminal body 1472.

Thus, when utilizing a spring member 1440c that is mechanically cold forced into shape (e.g., utilizing a die forming process) and the spring member 1440c is subjected to elevated temperatures, the spring member 1440c will attempt to at least return to its uncompressed state, which occurs prior to insertion of the male terminal assembly 1430 within the female terminal assembly 2430, and preferably to its original flat state, which occurs prior to the formation of the spring member 1440c. In doing so, the spring member 1440c will apply a generally outward directed thermal spring force, S_{TF}, (as depicted by the arrows labeled “S_{TF}” in FIG. 73) on the free ends 1488 of the contact arms 1494a-1494d. This thermal spring force, S_{TF}, is dependent upon local temperature conditions, including high and/or low temperatures, in the environment where the system 100 is installed. Accordingly, the combination of the spring biasing force, S_{BF}, and the thermal spring force, S_{TF}, provides a resultant biasing force, S_{RBF}, that ensures that the outer surface of the contact arms 1494a-1494d are forced into contact with the inner surface of the female terminal body 2432 when the male terminal assembly 2430 is inserted into the female terminal 2430 and during operation of the system 100 to ensure an electrical and mechanical connection. Additionally, with repeated thermal cycling events, the male terminal assembly 1430 will develop an increase in the outwardly directed resultant spring forces, S_{RBF}, that are applied to the female terminal assembly 2430 during repeated operation of the system 100.

Further illustrated in FIG. 73, in the fully connected state S_{FC}, the male terminal assembly 1430 provides 360° compliance with the female terminal assembly 2430 to ensure that a sufficient amount of outwardly directed force F_{B} is applied by the male terminal assembly 1430 to the female terminal assembly 2430 for electrical and mechanical connectivity in all four primarily directions. This attribute allows for omission of a keying feature and/or another feature designed to ensure a desired orientation of the components during connection. The 360° compliance attribute of the system 100 also aids in maintaining mechanical and electrical connection under strenuous mechanical conditions, e.g., vibration. In a traditional blade or fork-shaped connector with 180° compliance, i.e., connection on only two opposing sides, vibration may develop a harmonic resonance that causes the 180° compliant connector to oscillate with greater amplitude at specific frequencies. For example, subjecting a fork-shaped connector to harmonic resonance may cause the fork-shaped connector to open. Opening of the fork-shaped connector during electrical conduction is undesirable because momentary mechanical separation of the fork-shaped connector from an associated terminal may result in electrical arcing. Arcing may have significant negative effects on the 180° compliant terminal as well as the entire electrical system of which the 180° compliant terminal is a component. However, the 360° compliance feature of the present disclosure may prevent the possible catastrophic failures caused by strong vibration and electrical arcing.

As described above, it is desirable to form the male terminal 1470 from the same material as the female terminal body 2432 in order to: (i) help prevent corrosion and other degradation, (ii) reduce resistance between these structures, and (iii) facilitate the electrical and mechanical coupling of said structures. As such, the male and female terminal bodies 1472, 2432 are formed from copper in this exemplary embodiment. However, in order to utilize matching materials for the terminal bodies 1470, 2432 and avoid utilizing a bimetallic positive busbar, it should be understood that the bimetallic positive busbar may be replaced with an aluminum busbar and the male terminal 1470 may also be made from aluminum. In this embodiment, the male terminal 1470 associated with the negative external connection may be formed from copper, the exterior busbar may be formed from copper, the positive busbar may be formed from aluminum, and the male terminal 1470 associated with the positive external connection may be formed from aluminum. In further embodiments, the battery cells 75 may have different terminal configurations wherein the materials of the transport structure 82 may only utilize busbars made from a single material and the male terminal bodies 1470 can be made from this same material.

### E. Busbar Housing

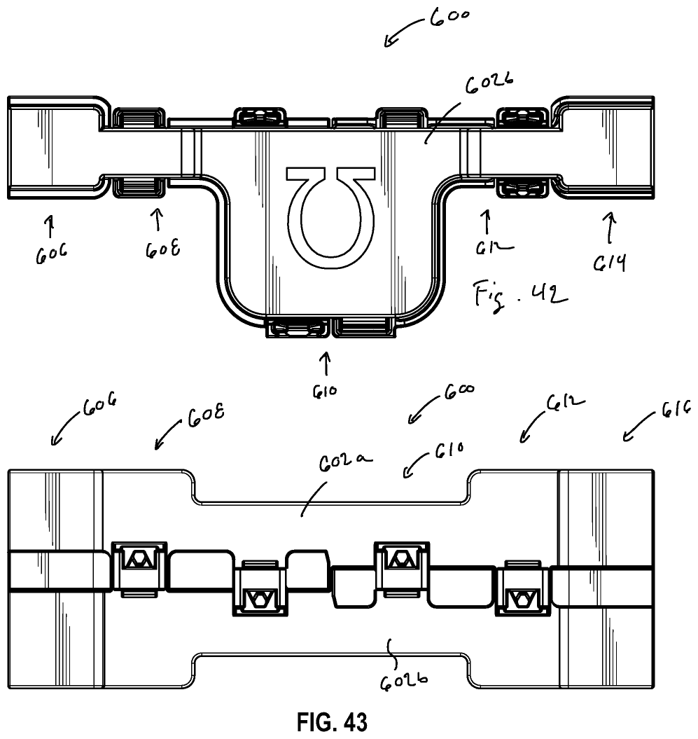

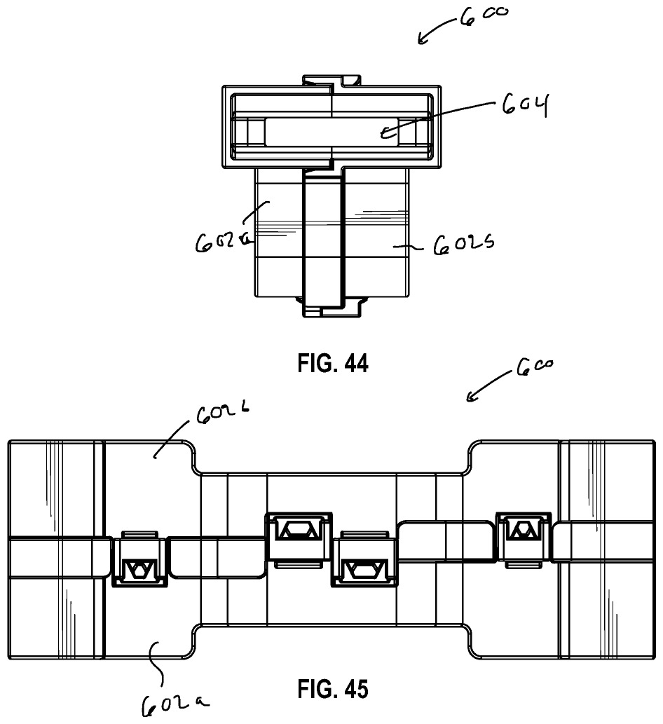

After the busbar 200 is fabricated and the terminals 1000 are coupled to said busbar 200, the busbar housing 600 can be coupled thereto to enclose a substantial extent of the busbar 200 and complete the build of the system 100. The busbar housing 600 is disclosed in connection with at least FIGS. 41-47, and includes a first component 602a and a second component 602b that are removably coupled together via couplers 597 (formed from projections 598 and receivers 599). When the first and second components 402a, 402b are coupled together, they form a receptacle 604 designed to receive the busbar 200. The receptacle 604 has five distinct extents, wherein the first extent 606 is designed to receive a portion of the connector assembly 1000, the second extent 608 is designed to receive a portion of the first peripheral connecting portion 402a, the third extent 610 is designed to receive the elastically deformable intermediate portion 410, the fourth extent 612 is designed to receive a portion of the second peripheral connecting portion portion 402b, and the fifth extent 614 is designed to receive a portion of the connector assembly 1000. The first extent 606 and the fifth extent 614 are designed to ensure that the male terminal 1430 and its housing 1100 can move laterally (e.g., sliding movement) between the compressed state S_{C} and the extended state S_{E} without revealing the busbar 200 or compressing the housing 600. As such, the first extent 606 and the fifth extent 614 of the receptacle 604 have a depth of the approximately 11 mm.

The second extent 608 and fourth extent 612 of the receptacle 604 match the configuration of the first and second peripheral connecting portions 402a, 402b of the busbar 200 and have a height of approximately 2-7 mm. As such, height and length of the third extent 610 of the receiver 604 are larger than the height and length of the elastically deformable intermediate portion 410 and are thus designed to allow for the elastic deformation of the intermediate portion 410 without interfering with or impeding the movement of the busbar 200. In other words, the third extent 610 of the receptacle 604 has a volume that is sufficient large to allow for the elastically deformable intermediate portion 410 to deform within said volume without restricting or impacting that deformation.

The housing 600 is preferably made from a non-conductive plastic and is designed to isolate and protect the elastically deformable electrical conductive assembly 350 from other foreign objects. The configuration and material choice of the housing 600 are designed to isolate the busbar 200, while still allowing the busbar 200 to elastically deform within all directions (e.g., X, Y, Z, and rotational). In other words, the housing 600 can flex or move as needed without damaging, breaking or reducing the performance of the busbar 200. The components 602a, 602b are symmetric and cooperatively dimensioned to one another in order to reduce part counts and simplify manufacturing/assembly of the system 100. However, in other embodiments, the components 602a, 602b may not be identical to one another. It should be understood that other housing 600 configurations are contemplated by this disclosure. For example, in certain applications, such as an installation with a controlled operating environment, the housing 600 can be omitted.

### II. First Embodiment of a Battery Pack

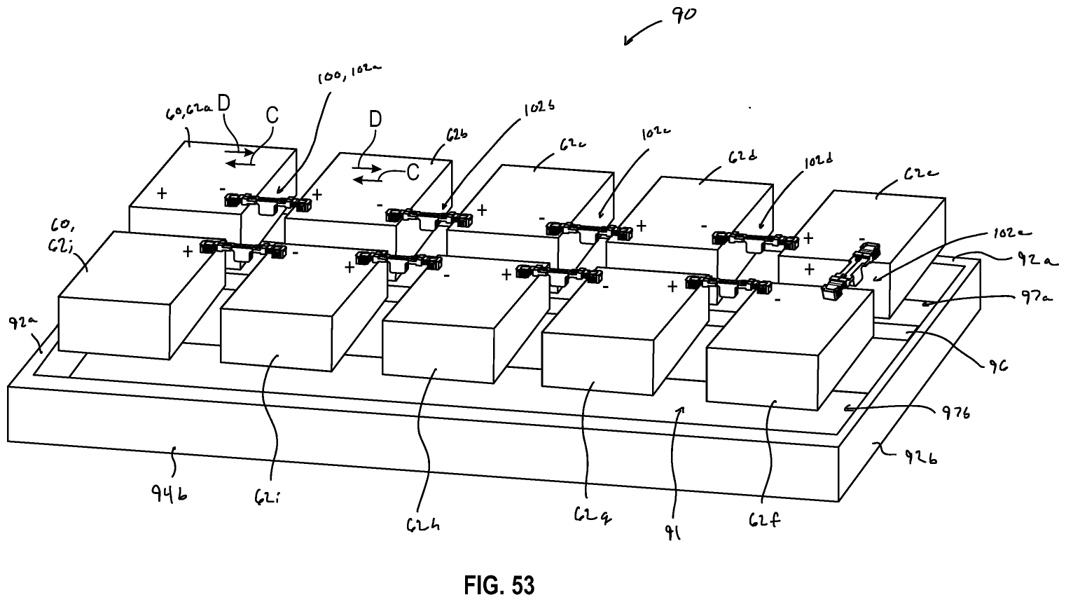

FIGS. 53-71 show a first embodiment of a battery pack 90 that includes a plurality of battery modules 60 and a plurality of elastically deformable battery module connector systems 100. In particular, the battery pack 90 includes ten battery modules 60 (62a-62j) that are electrically coupled to one another using nine elastically deformable battery module connector systems 100 (where specific numbers of elastically deformable battery module connector systems are labeled as 102a-102i)

### A. Battery Module

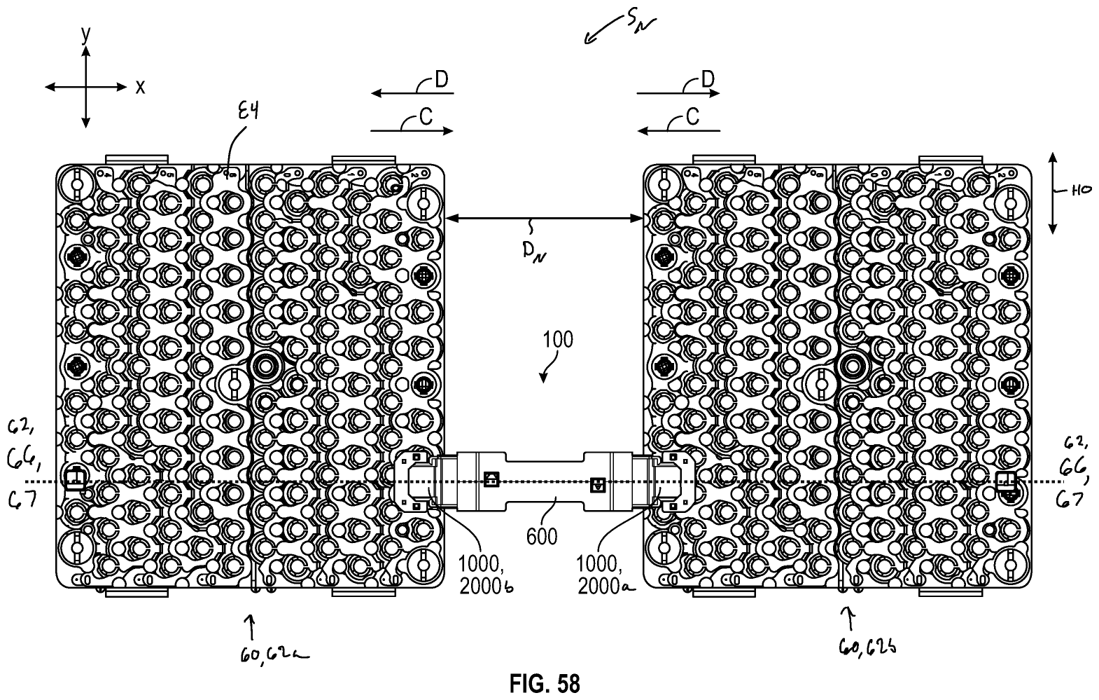

As shown in FIGS. 58-67, each of the ten battery modules 60 (62a-62j) generally includes: (i) a battery module housing 64, (ii) the battery cells 75, and (iii) the electrical transfer assembly 82.

i. Battery Module Housing

The battery module housing 64 includes a plurality of walls 66 (e.g., an arrangement of four side walls 68a-68d, a bottom wall 70a, and a top wall 70b) that form a receiver 72 configured to receive and protect: (i) the battery cells 75 and (ii) electrical transfer assembly 82. The top wall 70b includes at least two battery module openings 73a, 73b formed there through, wherein said openings 73a, 73b are configured to permit the female connector assembly 2000a, 2000b to be coupled to an extent of the electrical transfer assembly 82. In particular, current is configured to flow through the battery module openings 73a, 73b via the connection between the female connector assembly 2000a, 2000b and the electrical transfer assembly 82. While female connector assembly 2000a, 2000b are shown in connection with this first embodiment of the battery modules 60, it should be understood that the use of other connectors (e.g., bolted, clamped, pressure fitted) in contemplated by this disclosure. For example, a bolted connector is disclosed in connection with the second embodiment of the battery modules 60.

ii. Battery Cells

FIGS. 58-67 show that the battery modules 60 contain a plurality of cylindrical battery cells 75, wherein each battery cell 75 includes: (i) a housing 77, (ii) a positive terminal 80a, and (iii) a negative terminal 80b. The housing 77 has a longitudinal surface 78 and is designed to enclose and retain the materials that store the electrical charge, such as lithium or other similar metals. The positive and negative terminals 80a, 80b couple the materials contained within the housing 77 to the electrical transfer assembly 82. The terminals 80a, 80b may have a button-shape configuration; however, other terminal shapes are possible (e.g., boltless connectors, bolted connectors, tabs, other structures that can be welded, press-fit, or sandwiched by the electrical transfer assembly 82). The positive and negative terminals 80a, 80b are typically formed from different materials to facilitate the charging and discharging of the battery cell 75. For example, the positive terminal or anode 80a may be formed from: (i) graphite, (ii) silicon, or (iii) graphene, while the negative terminal or cathode 80b may be formed from: (i) cobalt, (ii) iron, (iii) nickel-magnesium, (iv) nickel, or (v) sulfur. It should be understood that other materials may be used for said terminals. The battery cells 75 may have an output voltage that is between 0.2 volts and 10 volts, an amperage hour rating between 10 Ah to 100 Ah, and may have an energy density that is between 20 Wh/kg and 500 Wh/kg (see Qiao, Y., et. al. A 500 Wh/kg Lithium-Metal Cell Based on Anionic Redox. Joule, this issue, 1445-1458, and Jason B. Quinn et al., Paper Review: Energy Density of Cylindrical Li-Ion Cells: A Comparison of Commercial 18650 to the 21700 Cells 2018 J. Electrochem. Soc. 165 A3284, both of which are hereby incorporated by reference). Examples of cylindrical battery cells 75 include: (i) 18650 (i.e., 18 mm diameter and 65 mm length), 21700 (i.e., 21 mm diameter and 70 mm length), 4680 (i.e., 46 mm diameter and 80 mm length). It should be understood that the battery cells 75 may use a number of different technologies and/or materials, including: (i) NiCd, (ii) NiMH, (iii) NaNiCl, (iv) Li-Polymer, (v) Li-Ion, or (vi) batteries that utilize other materials (e.g., LiO₂, AlO₂, LIS, LTO, LFP, NMC, NCA). Additionally, the battery cells may have any known configuration including cylindrical, prismatic, pouch, or any shape disclosed in U.S. Pat. Nos. 10,948,000, 10,429,006, 10,220,881, 10,473,177, 10,538,271, 10,300,947, 9,789,906, 9,889,887, 9,944,323, each of which is incorporated by reference herein.

iii. Electrical Transfer Assembly

FIGS. 58-67 show the electrical transfer assembly 82 positioned within each of the battery module 60, which couples: (i) a first layer 83a of battery cells 75 to a second layer 83b of battery cells 75, (ii) the battery cells 75 contained in the first and second layers 83a, 83b to one another, and (iii) the female connector assemblies 2000a, 2000b to the battery cells 75. As shown in this embodiment, each of the first and second layers 83a, 83b includes approximately 132 battery cells 75 that are arranged in a vertical orientation in comparison to the X-Y plane. This vertical orientation places positions: (i) the positive and negative terminals 80a, 80b in a plane that is substantially parallel with the X-Y plane, and (ii) an extent of the longitudinal surface 78 of the cells 75 is substantially parallel with the X-Z plane or Y-Z plane. As such, conductive plates 84 can be positioned in the X-Y plane and be coupled to the positive and negative terminals 80a, 80b of the cells 75. In particular, the coupling of the plates 84 have recesses cut therein to aid in laser welding the button-shaped terminals 80a, 80b to said plates 84. While this embodiment discloses the above configuration of the battery cells 75 and the associated components electrical transfer assembly 82, it should be understood that in other embodiments, the electrical transfer assembly 82 may have a different configuration. For example, said electrical transfer assembly 82 may be designed to coupling any number of battery cell 75 to one another (e.g., between 2 and 1000), and any number of battery cell layers 83a, 83b (e.g., between 1 and 40 layers) to one another.

Additionally, at least one female connector assembly 2000 is coupled to the plates 84. Preferably, the plates 84 of the electrical transfer assembly 82 are coupled to two female connector assemblies 2000a, 2000b, wherein: (i) a positive female connector assembly 2000b is (a) configured to provide a positive external connection for the battery module 60, and (b) designed to receive an extent of a positive male terminal assembly 1430, and (ii) a negative female connector assembly 2000a is (a) configured to provide a negative external connection for the battery module 60, and (b) designed to receive an extent of a negative male terminal assembly 1430. While the battery module 60 shown in the figures contains two female connector assemblies 2000a, 2000b, it should be understood the battery module 60 may have more or less female connector assemblies 2000. For example, the battery module 60 may only have a single female connector assembly 2000, or the battery module 60 may include over ten female connector assemblies 2000.

### B. Battery Pack

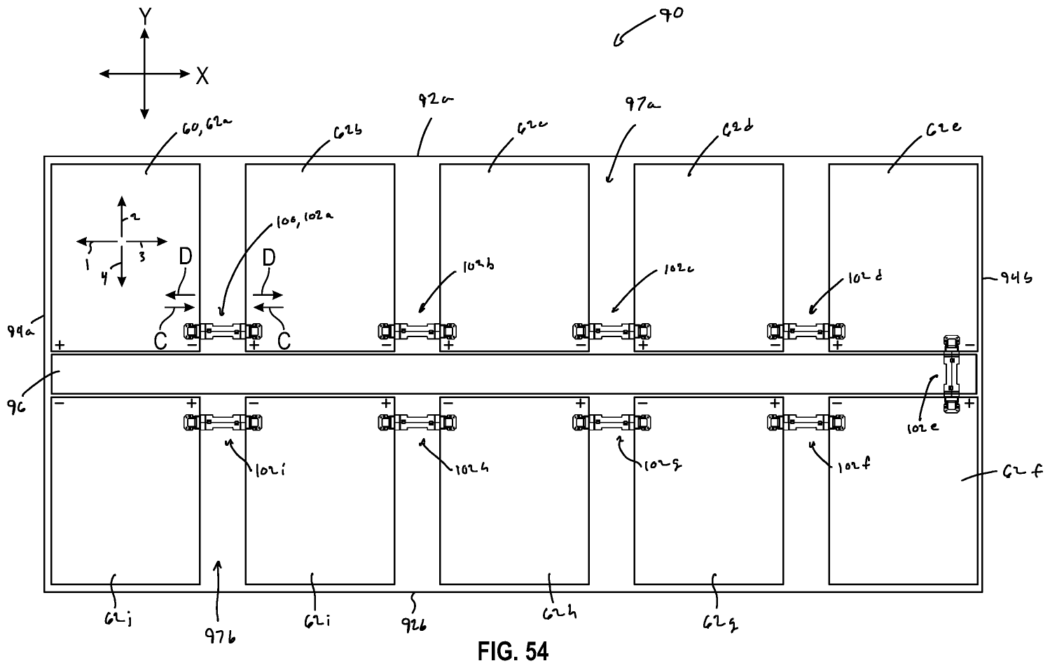

FIGS. 53 and 54 shows a first embodiment of a battery pack 90 that has a rectangular prism configuration and includes: (i) a bottom wall 91, (ii) a first or left end wall 92a, (iii) a second or right end wall 92b, (iv) a first or top side wall 94a, (v) a second of bottom side wall 94b, and (vi) a central divider 96 that is coupled to the first and second end walls 92a, 92b and is positioned between the first and second side walls 94a, 94b. The combinations of walls 92a, 92b, 94a, 94b, 96 are arranged to form a first or top receiver 97a and a second or bottom receiver 97b, wherein the top and bottom receivers 97a, 97b are designed to receive an extent of the battery modules 60 contained in the battery pack 90. At least one wall 92a, 92b, 94a, 94b includes a pack connector opening formed there through, wherein said opening(s) is configured to receive an extent of a connector that facilitates the charging and discharging of the battery pack 90. While an example of said connector that may be utilized is disclosed in PCT/US2021/043,686, this disclosure contemplates utilizing any known connector that can transfer the electrical current into and out of the pack. While the above disclosure focuses on the opening designed to receive the connector that facilitates the charging and discharging of the battery pack 90, it should be understood that other openings may be formed in the pack 90 to allow for the transfer of fluid in and out of the pack 90 or in order to make other mechanical or electrical connections within the pack 90.

The top receiver 97a of the battery pack 90 is configured to receive five battery modules 60 (62a-62e), while the bottom receiver 97b of the battery pack 90 is also configured to receive five battery modules 60 (62f-62j). In particular, the first battery module 62a is positioned in the top receivers 97a and is positioned between: (i) the first end wall 92a, (ii) the first side wall 94a, and (iii) central divider 96. In other words, the first battery module 62a is bounded on three sides by the walls and divider 92a, 94a, and 96. Like the first battery module 62a, the fifth battery module 62e is bounded on three sides by: (i) the second end wall 92b, (ii) the first side wall 94a, and (iii) central divider 96. The sixth battery module 62f is also bounded on three sides by: (i) the second end wall 92b, (ii) the second side wall 94b, and (iii) central divider 96, while the tenth battery module 62j is bounded on three sides by: (i) the first end wall 92a, (ii) the second side wall 94a, and (iii) central divider 96. In contrast to the first, fifth, sixth, and tenth battery modules 62a, 62e, 62f, 62j, the second, third, fourth battery modules, 62b, 62c, 62d, are positioned in the first receiver 97a and are only bounded by two sides: (i) the first side wall 94a, and (ii) central divider 96. Finally, like the second, third, fourth battery modules, 62b, 62c, 62d, the seventh, eighth, and ninth battery modules 62g, 62h, and 62i are positioned in the second receiver 97b and are only bounded by two sides: (i) the second side wall 94b, and (ii) central divider 96.

While FIGS. 53 and 54 show a battery pack 90 that has a rectangular prism configuration and is configured to hold ten battery modules 60, it should be understood that this disclosure is not limited to this design. Instead, the battery pack 90 may have any known configuration (e.g., any type of a polygonal prism) including a configuration where said pack 90 is built as an extent of the frame or chassis of the vehicle. It should also be understood that in other embodiments, the battery pack 90 may be configured to hold only a single battery module 60 or over a hundred individual battery modules 60. The battery cells 75 contained within the modules 60 may be connected in parallel, series, or any combination thereof. Additionally, the battery modules 60 contained within the battery pack 90 may be connected in parallel, series, or any combination thereof.

C. Connection of Battery Modules within the Battery Pack

Once the battery modules 60 (62a-62j) are positioned and secured in the receivers 97a, 97b of the battery pack 90, the battery modules 60 (62a-62j) can be coupled to one another using the disclosed elastically deformable battery module connector systems 100. In this embodiment, the battery pack 90 includes nine elastically deformable battery module connector systems 100 (where specific numbers of elastically deformable battery module connector systems are labeled as 102a-102i). Each of the elastically deformable battery module connector systems 100 are coupled to the battery modules 90 using a downwardly directed force (i.e., in the −Z direction). The disclosed configuration places the bottom surface 215b of the peripheral portions 402a, 402b substantially parallel to each of the following: (i) X-Y plane, (ii) the bottom wall 91 of the battery pack 90, (iii) the top and bottom walls 70a, 70b of the battery module housing 64, (iv) the upper surface of the conductive plates 84 of the transfer assembly 82, and (v) an extent of the positive and negative terminals 80a, 80b of the battery cells 75. Additionally, said configuration places the bottom surface 215b of the peripheral portions 402a, 402b substantially perpendicular to each of the following: (i) X-Z plane, (ii) Y-Z plane, (iii) the side and end walls 92a, 92b, 94a, 94b of the battery pack 90, (iii) the side walls 68a-68d of the battery module housing 64, (iv) the longitudinal surface 78 of the battery cells 75. Further, said configuration places causes the intermediate portion 410 to extend downward from the peripheral portion plane in the −Z direction and be positioned between a fourth side walls 68d of a battery module 60 (e.g., 62a) and a side wall 68a of an adjacent battery module 60 (e.g., 62b). Moreover, the length L_{IPB} of the busbar 200 extends in a direction that is substantially parallel with the X axis, while the width of the busbar 200 extends in a direction that is substantially parallel with the Y axis.

This first embodiment of the elastically deformable battery module connector systems 100 installed in battery pack 90 utilizing the connector assemblies 1000, 2000. These connector assemblies 1000, 2000 allows for the connections between the battery modules 60 to be: (i) boltless, (ii) PCT compliant, (iii) 360° compliant, (vi) fast and efficient compared to conventional battery pack connectors, (vii) straightforward, without requiring special tools or machines, (viii) meets USCAR and other industry specifications, (ix) is lighter weight than conventional battery pack connectors, and (x) other benefits that are obvious to one of skill in the art. Once the battery modules 60 and all other necessary components (e.g., battery management assembly, battery cooling or heating assemblies, etc.) are installed in the battery pack 90, said pack 90 can be installed in an application 10.

### D. Dynamic Movement of the Battery Modules

As shown in FIGS. 53-54, the battery pack 90 includes multiple modules 60, wherein each modules 60 will experience an extent of dynamic movement during usage of the battery pack 90, including during operation of a power distribution system in which the battery pack 90 is installed. Therefore, the forces applied to the connector systems 100 contained in the battery pack 90 are largely dependent upon and influenced by the behavior of: (i) other interconnect battery modules 90, including the configuration of the battery cells 75 contained therein, (ii) configuration of the battery pack 90, and (iii) operating conditions of the battery pack 90, including the vehicle in which the battery pack 90 is installed. For example, the first set of five battery modules 62a-62e, which are contained in the first receptacle 97a, will at least substantially balance or entirely balance the forces generated and applied on these modules 62a-62d by expansion or contraction of the battery module connector systems 102a-102d. Likewise, the second set of five battery modules 62f-62i, which are contained in the second receptacle 97b, will at least substantially balance or entirely balance the forces generated and applied on these modules 62a-62d by expansion or contraction of the battery module connector systems 102f-102i. However, the forces applied between the first and tenth battery modules 62a, 62j will be impacted, and likely restricted, by the walls and the divider 92a, 92b, 96 due to the configuration of the battery pack 90, including the layout of the modules 62a-62j and connector systems 102a-i.

While the battery pack 90 will attempt to at least substantially balance or entirely balance the forces applied on these modules 62a-62d by expansion or contraction of the connector systems 102a-102d, it should be understood that the configuration of the pack 90 may limit the balancing of these forces. For example, the first connector system 102a could experience different forces in comparison to the second connector system 102b due to: (i) the coupling of the first battery module 62 to the end wall 92a, and (ii) the configuration of the walls and divider 92a, 94a, 96 of the pack 90. Specifically and as shown in FIG. 54, the expansion or contraction of the first battery module 62a may be limited by the battery pack 90 in the: (i) first direction or along the negative (−) X axis by the end wall 92a, (ii) second direction or along the positive (+) Y axis by the top wall 94a, and (iii) fourth direction or along the negative (−) Y axis by the central divider 96. Thus, the battery pack 90 may only allow the first battery module 62a to expand or contract in the third direction or along the positive (+) X axis. In contrast, the expansion or contraction of the second battery module 62b may be limited in the: (i) second direction or along the positive (+) Y axis by the top wall 94a, and (ii) fourth direction or along the negative (−) Y axis by the central divider 96. However, the expansion or contraction of the second battery module 62b may not be limited in either of the: (i) first direction or along the negative (−) X axis by the end wall 92a, or (ii) third direction or along the positive (+) X axis.

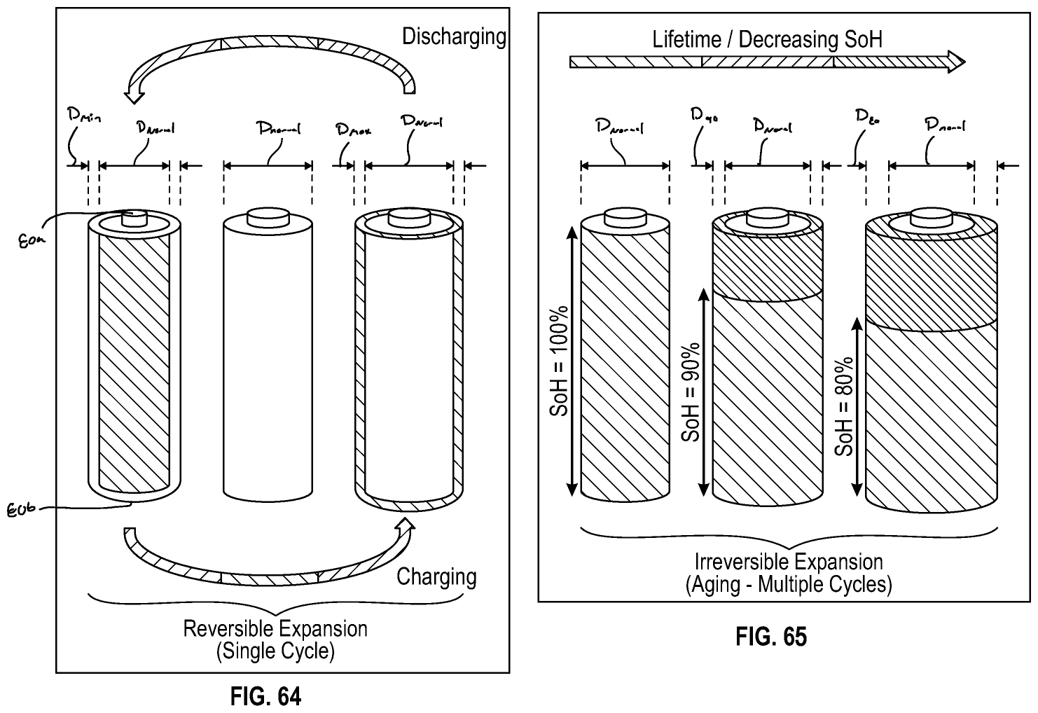

The schematic views of the battery cells 75 in FIG. 64 illustrates how the movement of lithium ions from the cathode to the anode alters the size of the battery cells 75, namely: (i) charging causes circumferential or radially outward expansion of the cylindrical battery cell 75 to charge diameter Dₘₐₓ, and (ii) discharging causes circumferential or radially inward contraction of the cylindrical battery cell 75 to discharge diameter Dₘᵢₙ. In fact, it has been demonstrated that the movement of lithium ions from the cathode to the anode within a cylindrical battery cell 75 having an 18.15 mm diameter may cause: (i) the average diameter of the battery cell 75 to increase by 2 μm (0.01% increase), and (ii) specific locations within the diameter of the battery cell 75 to increase up to 37 μm (0.2% increase). As such, the diameter of the battery cell 75 may increase to Dₘₐₓ when the battery is 100% charged or fully charged, move to Dₙₒᵣₘₐₗ when the battery is at 50% charge or half charged, and decrease to Dₘᵢₙ when the battery is at 0% charged or not charged or fully discharged, wherein Dₘₐₓ>Dₙₒᵣₘₐₗ>Dₘᵢₙ. In other words, charging the battery cells 75 contained in the battery module 60 from a 50% charge level to a 100% charge level will increase the diameter of the cells 75 in the module 60 from Dₙₒᵣₘₐₗ to Dₘₐₓ, and discharging the battery cells 75 contained in the battery module 60 from a 50% charge level to a 0% charge level will decrease the diameter of the cells 75 in the module 60 from Dₙₒᵣₘₐₗ to Dₘᵢₙ. Additionally, FIG. 65 illustrates how the diameter of the cells 75 irreversibly increase (from Dₙₒᵣₘₐₗ to D₉₀ to D₈₀) with decreasing state of battery health (“SoH”) due to solid electrolyte interphase layer thickness growth, defects in graphite, and pressure rise due to side reactions over the lifetime of a cylindrical Li-ion cell. It should be understood that FIGS. 64-65 are not to scale and are for schematic purposes only.

In light of this above disclosure, a primary factor that contributes to the dynamic movement of the battery modules 60 within the pack 90 is the state of charge of said battery modules 60. In the first embodiment shown in FIGS. 53-61, the cylindrical cells 75 are arranged in the vertical orientation in comparison to the X-Y plane, wherein an extent of the longitudinal surface 78 of the cells 75 is substantially parallel with the X-Z or Y-Z planes. Accordingly, the circumferential expansion and contraction of the battery cell 75, from Dₙₒᵣₘₐₗ to Dₘₐₓ or Dₙₒᵣₘₐₗ to Dₘᵢₙ, primarily causes expansion and contraction of the battery modules 60 in the X-Y plane. There is minimal, if any, axial expansion and contraction in the X-Z or Y-Z planes because the movement of the lithium ions is primarily directed laterally, namely radially outward or inward, and lacks an appreciable vertical or axial movement component. Because the expansion and contraction of the battery modules 60 is primarily in the X-Y plane, the designer of the battery pack 90: (i) positions the bottom surface 215b of the peripheral portions 402a, 402b substantially parallel to X-Y plane, and (ii) arranges the intermediate portion 410 of the busbar 200 to extend downward from the peripheral portion plane in the negative (−) Z direction. As discussed in detail below, this disclosed configuration will allow the intermediate portion 410 of the busbar 200 to continually elastically deform in order to absorb the expansion and contraction of the battery modules 60 in said X-Y plane.

i. System in Neutral State

While it is clear from the above disclosure that individual elastically deformable battery module connector system 100 contained in the battery pack 90 may experience different expansion and/or contraction forces, the general concepts disclosed in connection with the following disclosure in relation to the first battery module connector system 102a, the first battery module 62a, and second battery module 62b applies to all systems 100 contained in the battery pack 90. FIGS. 55-63 and 69 show the elastically deformable battery module connector system 100 in a neutral state S_{N}, where neither tension nor compression is applied to the system 100. In the neutral state S_{N}: (i) the battery cells 75 are 100% state of battery health (“SoH”), (ii) the battery cells 75 are charged to 50% charge level, (iii) the rear wall of each of the male terminal housings 1100 is positioned a housing gap L_{HG} (e.g., approximately 2-4 mm) away from an interior wall of the busbar housing 600, (iv) the formed length L_{BN} of the busbar 200 is approximately 110-120 mm, preferably 115-117 mm, and most preferably 116 mm (i.e., the length L_{IPN} of the intermediate portion is between 23 mm and 31 mm, and preferably 27 mm), (v) the height H_{BN} of the busbar 200, defined between the lowermost conductor 203a and the outer surface of the outermost conductor at the midpoint of the intermediate portion 410. is 15-30 mm, preferably 20-25 mm (i.e., the height H_{IPN} of the intermediate portion is greater than 5 mm, preferably greater than 12 mm, more preferably between 20 mm and 28 mm, and most preferably 23 mm), and the width W_{BN} of the busbar 200 is 15-25 mm, preferably 20 mm, (vi) the length L_{SN} of the system 100 is approximately 150-200 mm, preferably 160-190 mm, and most preferably 182 mm, the height of the system 100 is 35-40 mm, preferably 37 mm, and the width of the system 100 is 25-35 mm, preferably 31 mm, (vii) the distance DN between the battery modules 62a, 62b is at a neutral length (e.g., 100-120 mm, preferably 110 mm), (viii) the length of the neck L_{NN} defined between the external recesses 264a, 264b of the busbar 200 in the neutral state is 25-30 mm, preferably 22 mm, (ix) the length of the gap L_{GN} defined between opposed inner surfaces of the external recesses 264a, 264b of the busbar 200 in the neutral state is 14 and 22 mm, preferably 22 mm, (x) the ratio between the height H_{BN} of the busbar 200 and the formed length L_{BN} of the busbar 200 is 20-25%, preferably 21.5%, (xi) the bottom surface 215b of the peripheral portions 402a, 402b are substantially parallel to the X-Y plane and are substantially perpendicular to X-Z and Y-Z planes, (xii) the bottom surface 215b of the peripheral portions 402a, 402b substantially parallel to both the upper surface of the conductive plates 84 of the transfer assembly 82 and an extent of the positive and negative terminals 80a, 80b of the battery cells 75, (xiii) the bottom surface 215b of the peripheral portions 402a, 402b are substantially perpendicular to longitudinal surface 78 of the battery cells 75, and (ivx) intermediate portion 410 is positioned between a fourth side walls 68d of a battery module 62a and a first side wall 68a of an adjacent battery module 62b.

ii. System in Contracted State

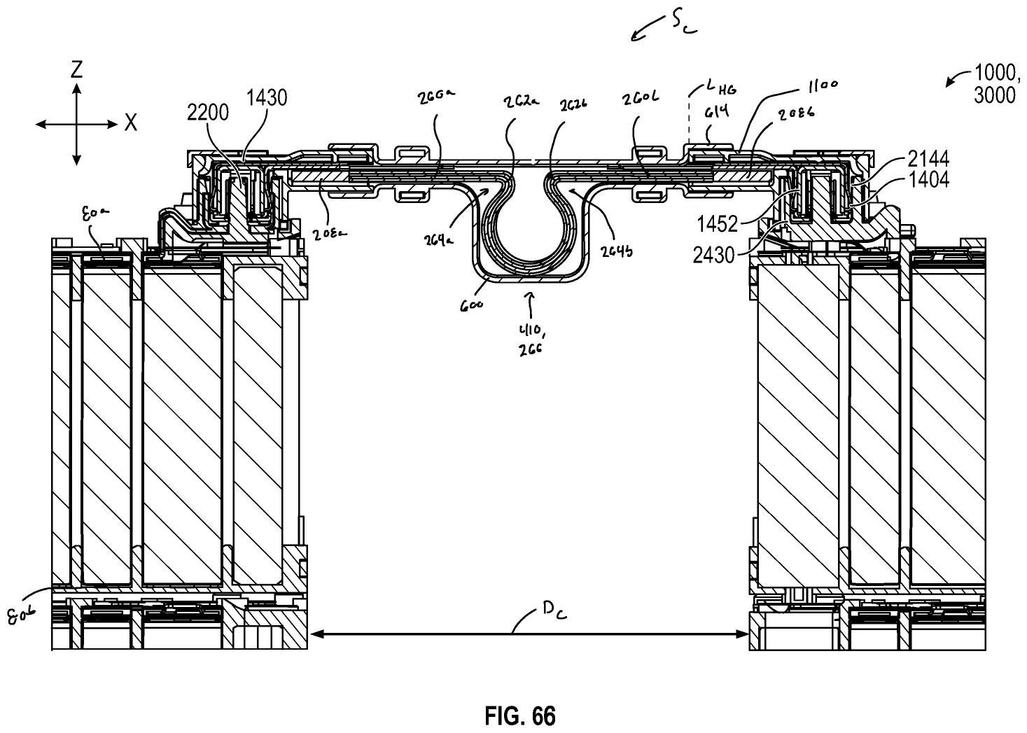

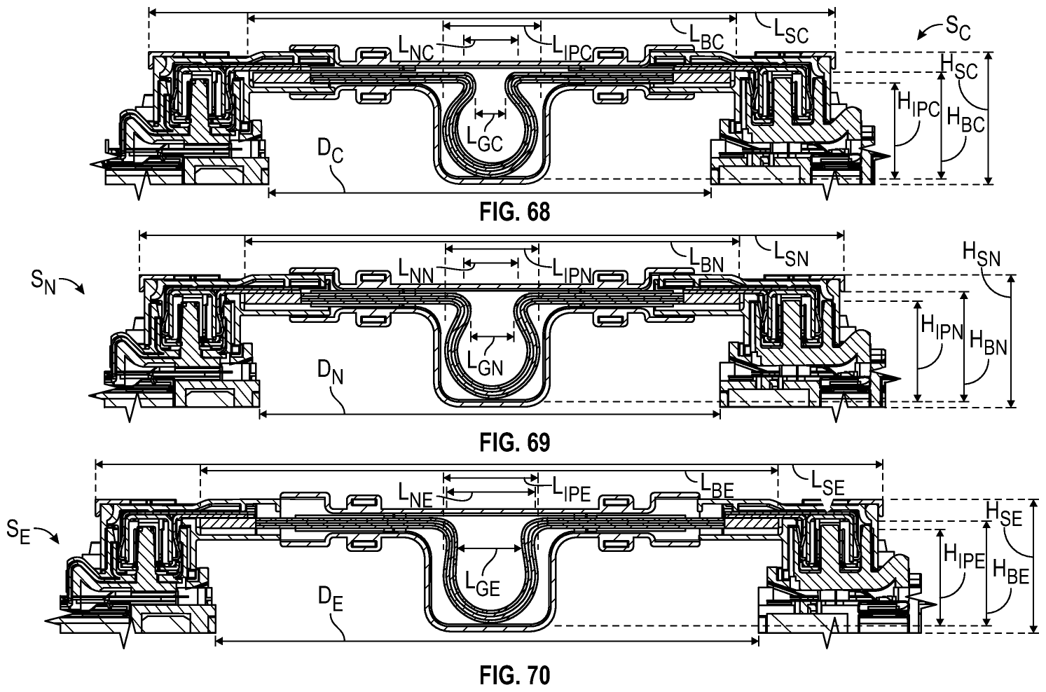

FIGS. 66 and 68 show the elastically deformable battery module connector system 100 in a compressed state S_{C}, where the busbar 200 is under a maximum compression Cₘₐₓ force. In this embodiment, the maximum compression Cₘₐₓ force is between 38 and 46 N, and preferably 42 N. This maximum compression Cₘₐₓ force is applied to the system 100 in the third direction (along the positive (+) X axis) via battery module 62a and in the first direction (along the negative (−) X axis) via the expansion of the battery modules 62a, 62b due to the increased level of charge in the battery cells 75. In particular, charging the battery cells 75 from a 50% charge state to a 100% charge, causes: (i) the diameter of the cells 75 to increase from Dₙₒᵣₘₐₗ to Dₘₐₓ, (ii) the size of the battery modules 62a, 62b to increase, (iii) the distance DN between the battery modules 62a, 62b to decrease from the neutral length (e.g., 110 mm) to a compressed length (e.g., 106 mm), and (iv) each of the rear wall of the male terminal housings 1100 slides towards the interior wall of the busbar housings 600. It should be understood that movement from the neutral state S_{N} to compressed state S_{C} occurs on a continuum. When the battery modules 60 are 75% charged, the compression on the connector system 100 is between the neutral state S_{N} and the compressed state S_{C}. In this state, the overall distance between the connectors 1000 may be reduced by 2 mm in comparison to the distance between the connectors 1000 in the neutral state S_{N}.

In the compressed state S_{C}: (i) the battery cells 75 are 100% state of battery health (“SoH”), (ii) the battery cells 75 are charged to 100% charge level, (iii) the rear wall of each of the male terminal housings 1100 is positioned a housing gap L_{HG} (e.g., approximately 0-0.05 mm or adjacent) to the interior wall of the busbar housing 600, (iv) the length L_{BC} of the busbar 200 is approximately 106-116 mm, preferably 111-113 mm, and most preferably 112 mm (i.e., the length L_{IPC} of the intermediate portion is between 23 mm and 31 mm, and preferably 27 mm), the height H_{BC} of the busbar 200 is 15-30 mm, preferably 20-25 mm (i.e., the height H_{IPC} of the intermediate portion is between 20 mm and 28 mm, and preferably 23 mm), and the width W_{BC} of the busbar 200 is 15-25 mm, preferably 20 mm, (v) the length L_{SC} of the system 100 is approximately 178 mm, the height H_{SC} of the system 100 is 37 mm, and the width W_{SC} of the system 100 is 31 mm, (vi) the distance D_{C} between the battery modules 62a, 62b is at a compressed length (e.g., 106 mm), (vii) the length of the neck L_{NC} defined between the external recesses 264a, 264b of the busbar 200 in the compressed state is 21-26 mm, preferably 18 mm, (viii) the length of the gap Loc defined between opposed inner surfaces of the external recesses 264a, 264b of the busbar 200 in the compressed state is 10 and 18 mm, preferably 14 mm, (ix) the ratio between the height H_{BC} of the busbar 200 and the length L_{BC} of the busbar 200 is 22.3%, (x) the bottom surface 215b of the peripheral portions 402a, 402b are substantially parallel to the X-Y plane and are substantially perpendicular to X-Z and Y-Z planes, (xi) the bottom surface 215b of the peripheral portions 402a, 402b substantially parallel to both the upper surface of the conductive plates 84 of the transfer assembly 82 and an extent of the positive and negative terminals 80a, 80b of the battery cells 75, (xii) the bottom surface 215b of the peripheral portions 402a, 402b are substantially perpendicular to longitudinal surface 78 of the battery cells 75, and (xiii) intermediate portion 410 is positioned between a fourth side walls 68d of a battery module 62a and a first side wall 68a of an adjacent battery module 62b.

iii. System in Extended State

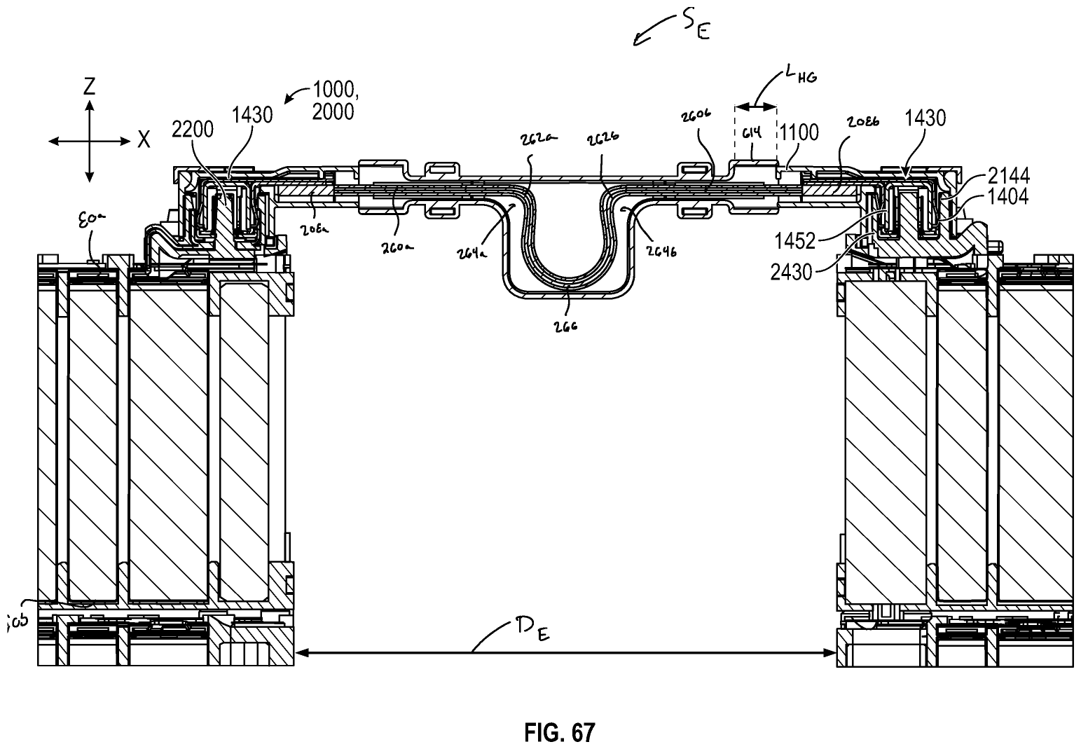

FIGS. 67 and 70 show the elastically deformable battery module connector system 100 in an extended state S_{E}, where the busbar 200 is a maximum tension TEₘₐₓ force. In this embodiment, the maximum tension TEₘₐₓ force is between 38 and 46 N, and preferably 42 N. This maximum tension TEₘₐₓ force is applied to the system 100 in the first direction (along the negative (−) X axis) via battery module 62a and in the third direction (along the positive (+) X axis) via the contraction of the battery modules 62a, 62b due to the decrease in the level of charge in the battery cells 75. In particular, charging the battery cells 75 from a 50% charge state to a 0% charge, causes: (i) the diameter of the cells 75 to decrease from Dₙₒᵣₘₐₗ to Dₘᵢₙ, (ii) the size of the battery modules 62a, 62b to decrease, (iii) the distance D_{E} between the battery modules 62a, 62b to increase from the neutral length (e.g., 110 mm) to an extended length (e.g., 114 mm), and (iv) the rear wall of each of the male terminal housings 1100 slides further away from the interior wall of the busbar housings 600. It should be understood that movement from the neutral state S_{N} to the extended state S_{E} occurs on a continuum. When the battery modules 60 are 25% charged, the tension on the connector system 100 is between the neutral state S_{N} and the extended state S_{E}. In this state, the overall distance between the connectors 1000 may be increased by 2 mm in comparison to the distance between the connectors 1000 in the neutral state S_{N}.

In the extended state S_{E}: (i) the battery cells 75 are 100% state of battery health (“SoH”), (ii) the battery cells 75 are charged to 0% charge level, (iii) the rear wall of each of the male terminal housings 1100 is positioned a housing gap L_{HG} (e.g., approximately 4-6 mm) from the interior wall of the busbar housing 600, (iv) the length L_{BE} of the busbar 200 is approximately 114-124 mm, preferably 119-121 mm, and most preferably 120 mm (i.e., the length L_{IPE} of the intermediate portion is between 23 mm and 31 mm, and preferably 27 mm), the height H_{BE} of the busbar 200 is 15-30 mm, preferably 20-25 mm (i.e., the height H_{IPE} of the intermediate portion is between 20 mm and 28 mm, and preferably 23 mm), and the width W_{BE} of the busbar 200 is 15-25 mm, preferably 20 mm, (v) the length L_{SE} of the system 100 is approximately 186 mm, the height of the system 100 is 37 mm, and the width of the system 100 is 31 mm, (vi) the distance DN between the battery modules 62a, 62b is at an extended length (e.g., 114 mm), (vii) the length of the neck L_{NE} defined between the external recesses 264a, 264b of the busbar 200 in the compressed state is 29-34 mm, preferably 22 mm, (viii) the length of the gap L_{GE} defined between opposed inner surfaces of the external recesses 264a, 3264b of the busbar 200 in the compressed state is 18 and 26 mm, preferably 24 mm the busbar 200 in the compressed state is 10 and 18 mm, preferably 14 mm, (viii) the ratio between the height H_{BE} of the busbar 200 and the length L_{BE} of the busbar 200 is 20.8%, (ix) the bottom surface 215b of the peripheral portions 402a, 402b are substantially parallel to the X-Y plane and are substantially perpendicular to X-Z and Y-Z planes, (x) the bottom surface 215b of the peripheral portions 402a, 402b substantially parallel to both the upper surface of the conductive plates 84 of the transfer assembly 82 and an extent of the positive and negative terminals 80a, 80b of the battery cells 75, (xi) the bottom surface 215b of the peripheral portions 402a, 402b are substantially perpendicular to longitudinal surface 78 of the battery cells 75, and (xii) intermediate portion 410 is positioned between a fourth side walls 68d of a battery module 62a and a first side wall 68a of an adjacent battery module 62b.

iv. Summary

In summary, the above disclosure is focused on battery cells 75 that have a battery health (“SoH”) that is 100%. As shown in FIG. 65, as this state of health decreases the diameter of the cells 75 increase, which will reduce the ability for the system 100 to reach the extended state S_{E}; instead, the system 100 will primarily move between the neutral state S_{N} and the compressed state S_{C}. Also, as shown in the below table, the height of the busbar 200 and the bend height H_{IPN} and bend length L_{IPN} of the intermediate portion 410 remains substantially constant regardless of the busbar state. Remaining substantially constant in all states is beneficial because it reduces potential failures due to unplanned expansions or contractions in the busbar 200 height. It should be understood that remaining substantially constant means that the height or length will change less than 2.5%, when said busbar 200 is moved from the neutral state S_{N} to the compressed state S_{C} or from the neutral state S_{N} to the extended state S_{E}. Also, as shown in the below table, the formed length (i.e., L_{BC} to L_{BN} to L_{BE}) of the busbar 200 does not remain substantially constant as the busbar 200 moves from the compressed state to the extended state between states. Instead, formed length changes by approximately 5%, when said busbar 200 moves from the compressed state to the extended state. It should be understood that the numbers contained in the above paragraphs and the below table are only exemplary and are not limiting in any manner. As such, other embodiments of the busbar 200 may have different values associated therewith.

TABLE 2
Charge Levels and Dimensions at Various Busbar States

| | Battery Cell | | | | | |
|---|---|---|---|---|---|---|
| Busbar | Charge Level | L_{BC}, L_{BN}, | H_{BC}, H_{BN}, | H_{IPC}, H_{IPN}, | L_{GC}, L_{GN}, | L_{SC}, L_{SN}, |
| State | (%) | L_{BE} (mm) | H_{BE} (mm) | H_{IPE} (mm) | L_{GE} (mm) | L_{SE} (mm) |
| Neutral | 50% | 116 | 25 ± 2.5% | 23 ± 2.5% | 20 | 182 |
| State S_{N} | | | | | | |
| Compressed | 100% | 112 | 25 ± 2.5% | 23 ± 2.5% | 16 | 178 |
| State S_{C} | | | | | | |
| Extended | 0% | 120 | 25 ± 2.5% | 23 ± 2.5% | 24 | 186 |
| State S_{E} | | | | | | |

v. Other Movement

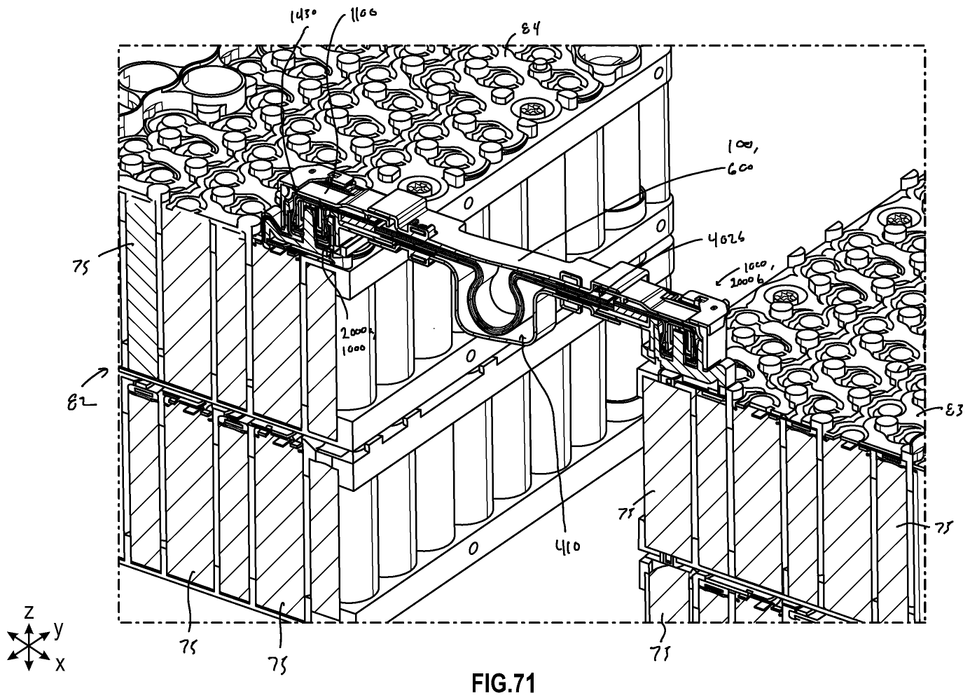

While the above disclosure focused on the dynamic movement of the modules 60 associated with the state of charge of the battery module 60, other factors can cause dynamic movement of the battery modules 60 within the battery pack 90. For example, increasing the temperature of the battery pack 90, the power distribution system 50 and/or the application 10 will likely cause expansion of all components in all planes; thus, compressing the system 100. Further, harsh and/or rough operating environments for the application 10, such as motor vehicle 20, will also likely cause dynamic movement in all planes; thus, compressing and/or expanding the system 100. Specifically, FIG. 71 shows movement between the battery modules 62a, 62b in the second and fourth (along the positive/negative (+/−) Y axis) directions. Finally, other mechanical or chemical forces may also compress or expand the system 100. Because the system 100 is specifically designed to account for expansion and contraction in the X-Y plane and can compensate for movement in the X-Z plane and the Y-Z plane, the system 100 significantly reduces, and largely eliminates, a significant number of movement-attributed failure modes from battery packs 90 and applications 10 that include a battery pack 90, such as a motor vehicle.

### III. Second Embodiment of the Battery Pack

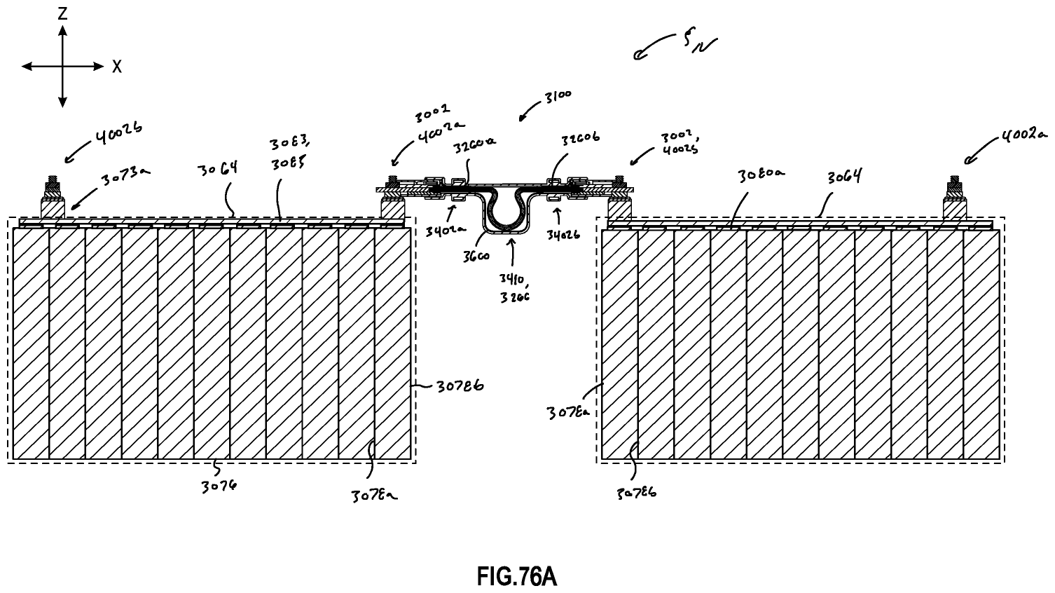

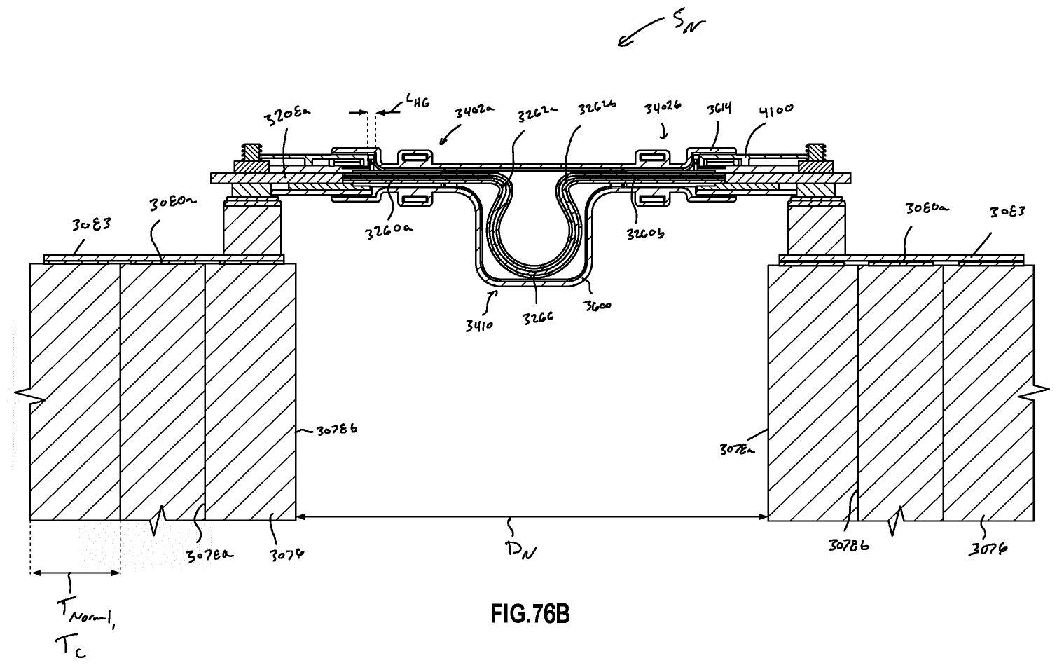

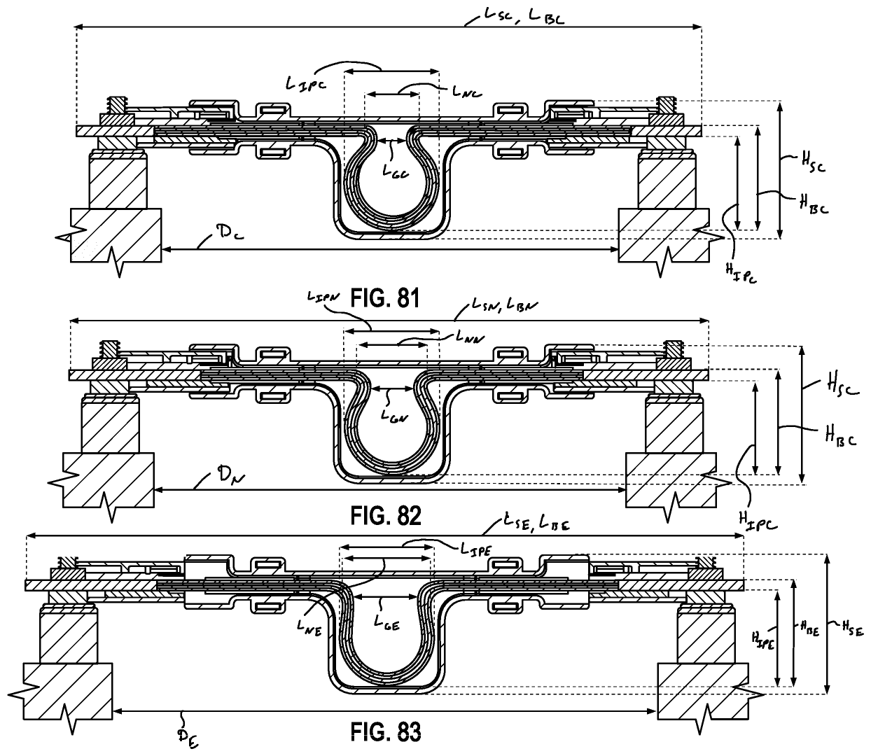

FIGS. 74-83 show a second embodiment of battery modules 3060 and a plurality of second embodiment elastically deformable battery module connector systems 3100. The combination of the battery modules 3060 and systems 3100 are configured to be positioned within the battery pack 90 disclosed above. For sake of brevity, the above disclosure in connection with battery pack 90 will not be repeated below, but it should be understood that across embodiments like numbers represent like structures. For example, the disclosure relating to busbar housing 600 applies in equal force to busbar housing 3600. It should be understood that any one or more features of the battery modules 60 and systems 100 can be used in conjunction with those disclosed regarding the battery modules 3060 and systems 3100, and that any one or more features of the battery modules 3060 and systems 3100 can be used in conjunction with those disclosed regarding the battery modules 60 and systems 100.

### A. Battery Module

As shown in FIGS. 74-83, each of the battery modules 3060 (3062a-3062b) generally includes: (i) a battery module housing 3064, (ii) the battery cells 3076, and (iii) the electrical transfer assembly 3083.

i. Battery Module Housing

The battery module housing 3064 includes a plurality of walls 3066 (e.g., an arrangement of four side walls 3068a-3068d, a bottom wall 3070a, and a top wall 3070b) that form a receiver 3072 configured to receive and protect: (i) the battery cells 3076 and (ii) electrical transfer assembly 3083. The top wall 3070b includes at least two battery module openings 3073a, 3073b formed there through, wherein said openings 3073a, 3073b are configured to permit the bolted connector assembly 4002a, 4002b to be coupled to an extent of the electrical transfer assembly 3083. In particular, current is configured to flow through the battery module openings 3073a, 3073b via the connection between the bolted connector assembly 4002a, 4002b and the electrical transfer assembly 3083. While bolted connector assembly 4002a, 4002b are shown in connection with this second embodiment 3060, it should be understood that the use of other connectors (e.g., boltedless, clamped, pressure fitted) in contemplated by this disclosure. For example, a boltedless connector is disclosed in connection with the first embodiment of the battery modules 3060.

ii. Battery Cells

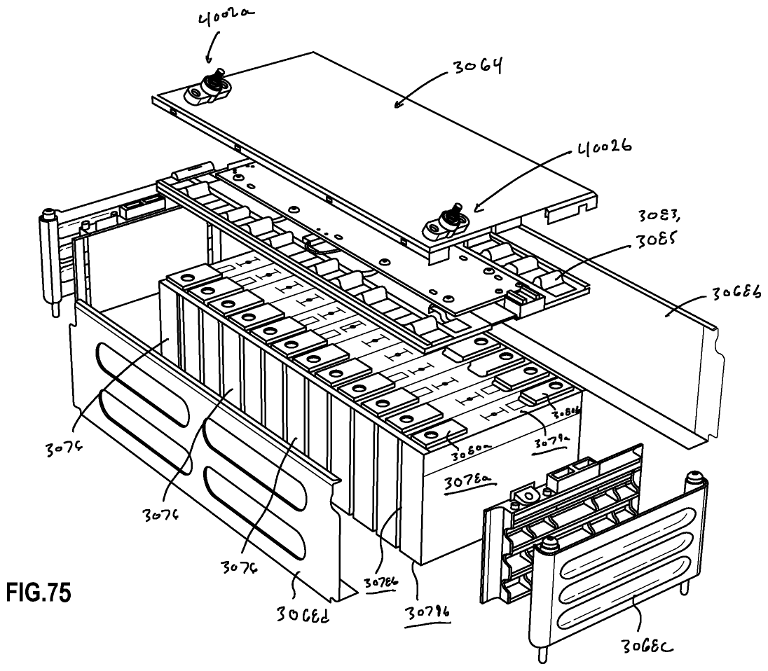

FIGS. 75-80 show that the battery modules 3060 contain a plurality of prismatic battery cells 3076, wherein each battery cell 3076 includes: (i) a housing 3077, (ii) a positive terminal 3080a, and (iii) a negative terminal 3080b. The housing 3077 has vertical side surfaces 3078a, 3078b and a horizontal top and bottom surfaces 3079a, 3079b and is designed to enclose and retain the materials that store the electrical charge, such as lithium or other similar metals. In other words, the battery cells has a thickness T_{C}, a width W_{CELL}, and a length L_{CELL}. The positive and negative terminals 3080a, 3080b couple the materials contained within the housing 3077 to the electrical transfer assembly 3083. The terminals 3080a, 3080b may have a tab-shape configuration; however, other terminal shapes are possible (e.g., boltless connectors, bolted connectors, button, other structures that can be welded, press-fit, or sandwiched by the electrical transfer assembly 3083). The positive and negative terminals 3080a, 3080b are typically formed from different materials to facilitate the charging and discharging of the battery cell 3076. For example, the positive terminal or anode 3080a may be formed from: (i) graphite, (ii) silicon, or (iii) graphene, while the negative terminal or cathode 3080b may be formed from: (i) cobalt, (ii) iron, (iii) nickel-magnesium, (iv) nickel, or (v) sulfur. It should be understood that other materials may be used for said terminals. The battery cells 3076 may have an output voltage that is between 0.2 volts and 10 volts, an amperage hour rating between 10 Ah to 100 Ah, and may have an energy density that is between 20 Wh/kg and 500 Wh/kg. It should be understood that the battery cells 3076 may use a number of different technologies and/or materials, including: (i) NiCd, (ii) NiMH, (iii) NaNiCl, (iv) Li-Polymer, (v) Li-Ion, or (vi) batteries that utilize other materials (e.g., LiO₂, AlO₂, LiS, LTO, LFP, NMC, NCA).

iii. Electrical Transfer Assembly

FIGS. 74-80 show the electrical transfer assembly 3083 positioned within each of the battery module 3060, which couples: (i) the battery cells 3076 to one another, and (iii) the female connector assemblies 4002a, 4002b to the battery cells 3076. As shown in this embodiment, each battery module 3060 includes approximately 11 battery cells 3076 that are arranged in a vertical orientation in comparison to the X-Y plane. This vertical orientation places positions: (i) the positive and negative terminals 3080a, 3080b in a plane that is substantially parallel with the X-Y plane, (ii) an extent of the vertical side surfaces 3078a, 3078b of the cells 3076 is substantially parallel with the Y-Z plane, and (iii) the thickness T_{C} of the cell 3076 parallel with the X-axis. As such, conductive plates 3085 can be positioned in the X-Y plane and be coupled to the positive and negative terminals 3080a, 3080b of the cells 3076. While this embodiment discloses the above configuration of the battery cells 3076 and the associated components electrical transfer assembly 3083, it should be understood that in other embodiments, the electrical transfer assembly 3083 may have a different configuration. For example, said electrical transfer assembly 3083 m may be designed to coupling any number of battery cell 3076 to one another (e.g., between 2 and 3998).

Additionally, the plates 3085 are coupled to at least one bolted connector 4002. Preferably, the plates 3085 of the electrical transfer assembly 3083 are coupled to two bolted connectors 4002a, 4002b, wherein: (i) a positive bolted connector 4002b is (a) configured to provide a positive external connection for the battery module 3060, and (b) designed to be received by an opening formed in an extent of the system 3100, and (ii) a negative bolted connector 4002a is (a) configured to provide a negative external connection for the battery module 3060, and (b) designed to be received by an opening formed in an extent of the system 3100. While the battery module 3060 shown in the figures contains two bolted connectors 4002a, 4002b, it should be understood the battery module 3060 may have more or less bolted connectors 4002. For example, the battery module 3060 may only have a single bolted connector 4002, or the battery module 3060 may include over ten bolted connectors 4002.

### B. Battery Pack

As discussed above, the second embodiment of the battery module 3090 is designed to fit within the rectangular prism configuration of the battery pack 90, shown in FIGS. 53-54. While FIGS. 53 and 54 show a battery pack 90 that has a configuration and is configured to hold ten battery modules 3060, it should be understood that this disclosure is not limited to this design. Instead, the battery pack 90 may have any known configuration (e.g., any type of a polygonal prism) including a configuration where said pack 90 is built as an extent of the frame or chassis of the vehicle. It should also be understood that in other embodiments, the battery pack 90 may be configured to hold only a single battery module 3060 or over a hundred individual battery modules 3060. The battery cells 3076 contained within the modules 3060 may be connected in parallel, series, or any combination thereof. Additionally, the battery modules 3060 contained within the battery pack 90 may be connected in parallel, series, or any combination thereof.

C. Connection of Battery Modules within the Battery Pack

Once the battery modules 3060 (3062a-3062j) are positioned and secured in the receivers 97a, 97b of the battery pack 3060, the battery modules 3060 (3062a-3062j) can be coupled to one another using the disclosed elastically deformable battery module connector systems 3100. In this embodiment, the battery pack 90 includes nine elastically deformable battery module connector systems 3100 (3102a-3102i). Each of the elastically deformable battery module connector systems 3100 are coupled to the battery modules 90 positioning the threaded rod of the bolted connectors 4002 into the opening 3002 formed in the end sectors 3208a, 3208b of the busbar 3200, and then securing end sectors 3208a, 3208b to the bolted connectors 4002 using a threaded fastener. The disclosed configuration places the bottom surface 3215b of the peripheral portions 3402a, 3402b substantially parallel to each of the following: (i) X-Y plane, (ii) the bottom wall 91 of the battery pack 90, (iii) the top and bottom walls 3070a, 3070b of the battery module housing 3064, (iv) the upper surface of the conductive plates 3085 of the transfer assembly 3083, and (v) an extent of the positive and negative terminals 3080a, 3080b of the battery cells 3076. Additionally, said configuration places the bottom surface 3215b of the peripheral portions 3402a, 3402b substantially perpendicular to each of the following: (i) X-Z plane, (ii) Y-Z plane, (iii) the side and end walls 92a, 92b, 94a, 94b of the battery pack 90, (iii) the side walls 3068a-3068d of the battery module housing 3064, (iv) the an extent of the vertical side surfaces 3078a, 3078b of the battery cells 3076. Further, said configuration places causes the intermediate portion 3410 to extend downward from the peripheral portion plane in the −Z direction and be positioned between a fourth side walls 3068d of a battery module 3060 (e.g., 3062a) and a side wall 3068a of an adjacent battery module 3060 (e.g., 3062b). Moreover, the length L_{B} of the busbar 3200 extends in a direction that is substantially parallel with the X axis, while the width of the busbar 3200 extends in a direction that is substantially parallel with the Y axis.

This first embodiment of the elastically deformable battery module connector systems 3100 installed in battery pack 90 utilizing the connector assemblies 3998, 4002. These connector assemblies 3998, 4002 allows for the connections between the battery modules 3060 to be secured using a bolted configuration. Once the battery modules 3060 and all other necessary components (e.g., battery management assembly, battery cooling or heating assemblies, etc.) are installed in the battery pack 90, said pack 90 can be installed in an application 10.

### D. Dynamic Movement of the Battery Modules

The schematic views of the battery cells 3076 in FIG. 77 illustrates how the movement of lithium ions from the cathode to the anode alters the size of the battery cells 3076, namely: (i) charging causes an increase in thickness or lateral outward expansion of the prismatic battery cell 3076, and (ii) discharging causes a decrease in thickness or lateral inward contraction of the prismatic battery cell 3076. As such, the thickness of the cell 3076 may increase to Tₘₐₓ when the battery is 100% charged or fully charged, move to Tₙₒᵣₘₐₗ when the battery is at 50% charge or ½ charged, and decrease to Tₘᵢₙ when the battery is at 0% charge or are not charged, wherein Tₘₐₓ>Tₙₒᵣₘₐₗ>Tₘᵢₙ. In other words, charging the battery cells 3076 contained in the battery module 3060 from a 50% charge level to a 100% charge level will increase the thickness of the cells 3076 in the module 3060 from Tₙₒᵣₘₐₗ to Tₘₐₓ, and discharging the battery cells 3076 contained in the battery module 3060 from a 50% charge level to a 0% charged level will decrease the thickness of the cells 3076 in the module 3060 from Tₙₒᵣₘₐₗ to Tₘᵢₙ. Additionally, FIG. 78 illustrates how the thickness of the cells 3076 irreversibly increase (i.e., from Tₙₒᵣₘₐₗ to T₉₀ to T₈₀) with decreasing state of battery health (“SoH”) due to solid electrolyte interphase layer thickness growth, defects in graphite, and pressure rise due to side reactions over the lifetime of a prismatic lithium ions cell. It should be understood that FIGS. 77-78 are not to scale and are for illustration purposes only.

In light of this above disclosure, a primary factor that contributes to the dynamic movement of the battery modules 3060 within the pack 90 is the state of charge of said battery modules 3060. In this second embodiment, the prismatic cells 3076 are arranged in the vertical orientation in comparison to the X-Y plane, wherein: (i) an extent of the vertical side surfaces 3078a, 3078b of the cells 3076 is substantially parallel with the Y-Z plane, (ii) an extent of the horizontal top and bottom surfaces 3079a, 3079b of the cells 3076 is substantially parallel with the X-Y plane, and (iii) the thickness T_{C} of the cell 3076 parallel with the X-axis. Accordingly, the thickness expansion and contraction, from Tₙₒᵣₘₐₗ to Tₘₐₓ or Tₙₒᵣₘₐₗ to Tₘᵢₙ, of the battery cell 3076 primarily causes expansion and contraction of the battery modules 3060 along the X axis. There is minimal, if any, expansion and contraction along the Y axis or Z axis because the movement of the Li ions is primarily directed laterally and lacks other appreciable components. Because the expansion and contraction of the battery modules 3060 is primarily in the X axis, the designer: (i) positions the bottom surface 3215b of the peripheral portions 3402a, 3402b substantially parallel to X axis, and (ii) arranges the intermediate portion 3410 to extend downward from the peripheral portion plane in the negative (−) Z direction. As discussed in detail below, this disclosed configuration of the system 100 will allow the intermediate portion 3410 to elastically deform in order to absorb the expansion and contraction of the battery modules 3060 in said X axis.

i. System in Neutral State

While it is clear from the above disclosure that individual elastically deformable battery module connector system 3100 contained in the battery pack 90 may experience different expansion and/or contraction forces, the general concepts disclosed in connection with the following disclosure in relation to the first system 3102a, the first battery module 3062a, and second battery module 3062b applies to all systems 3100 contained in the battery pack 90. FIGS. 74-76B and 81 show the elastically deformable battery module connector system 3100 in a neutral state S_{N}, where neither tension nor compression is applied on the system 3100. In the neutral state S_{N}: (i) the battery cells 3076 are 100% state of battery health (“SoH”), (ii) the battery cells 3076 are charged to 50% charge level, (iii) the rear wall of each of the male terminal housings 1100 is positioned a housing gap L_{HG} (e.g., approximately 2-4 mm) away from an interior wall of the busbar housing 3600, (iv) the formed length L_{BN} of the busbar 200 is approximately 110-120 mm, preferably 115-117 mm, and most preferably 116 mm (i.e., the length L_{IPN} of the intermediate portion is between 23 mm and 31 mm, and preferably 27 mm), the height H_{BN} of the busbar 200 is 15-30 mm, preferably 20-25 mm (i.e., the height H_{IPN} of the intermediate portion is between 20 mm and 28 mm, and preferably 23 mm), and the width W_{BN} of the busbar 200 is 15-25 mm, preferably 20 mm, (v) the length L_{SN} of the system 3100 is approximately 150-200 mm, preferably 160-190 mm, and most preferably 182 mm, the height of the system 3100 is 35-40 mm, preferably 37 mm, and the width W_{SN} of the system 3100 is 25-35 mm, preferably 31 mm, (vi) the distance DN between the battery modules 3062a, 3062b is at a neutral length (e.g., 100-120 mm, preferably 110 mm), (vii) the length of the neck L_{NN} defined between the external recesses 3264a, 3264b of the busbar 3200 in the neutral state is 25-30 mm, preferably 22 mm, (viii) the length of the gap L_{GN} defined between opposed inner surfaces of the external recesses 3264a, 3264b of the busbar 3200 in the neutral state is 14 and 22 mm, preferably 22 mm, (ix) the ratio between the height H_{BN} of the busbar 3200 and the formed length L_{BN} of the busbar 3200 is 20-25%, preferably 21.5%, (x) the bottom surface 3215b of the peripheral portions 3402a, 3402b are substantially parallel to the X-Y plane and are substantially perpendicular to X-Z and Y-Z planes, (xi) the bottom surface 3215b of the peripheral portions 3402a, 3402b substantially parallel to both an extent of the upper surface of the conductive plates 3085 of the transfer assembly 3083 and an extent of the positive and negative terminals 3080a, 3080b of the battery cells 3076, (xii) the bottom surface 3215b of the peripheral portions 3402a, 3402b are substantially perpendicular to an extent of the vertical side surfaces 3078a, 3078b of the cells 3076, (xiii) intermediate portion 3410 is positioned between a fourth side walls 3068d of a battery module 3062a and a first side wall 3068a of an adjacent battery module 3062b, and (xiv) the formed length L_{BN} of the busbar 200 and the length L_{SN} of the system 3100 are substantially parallel to both the thickness T_{C} of the battery cell 3076 and X axis.

ii. System in Contracted State

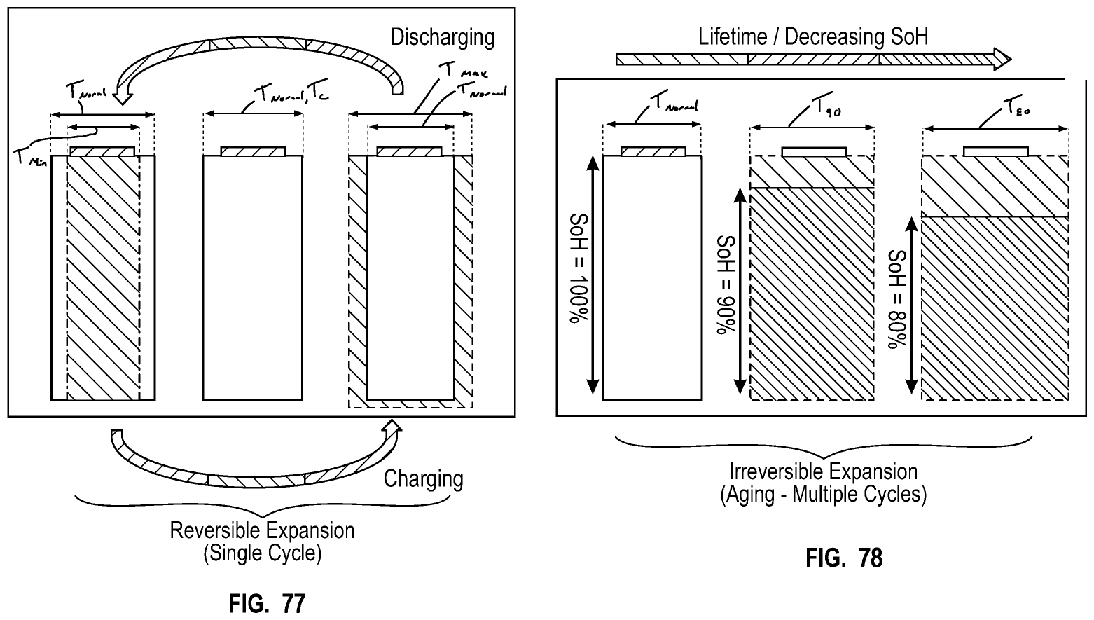

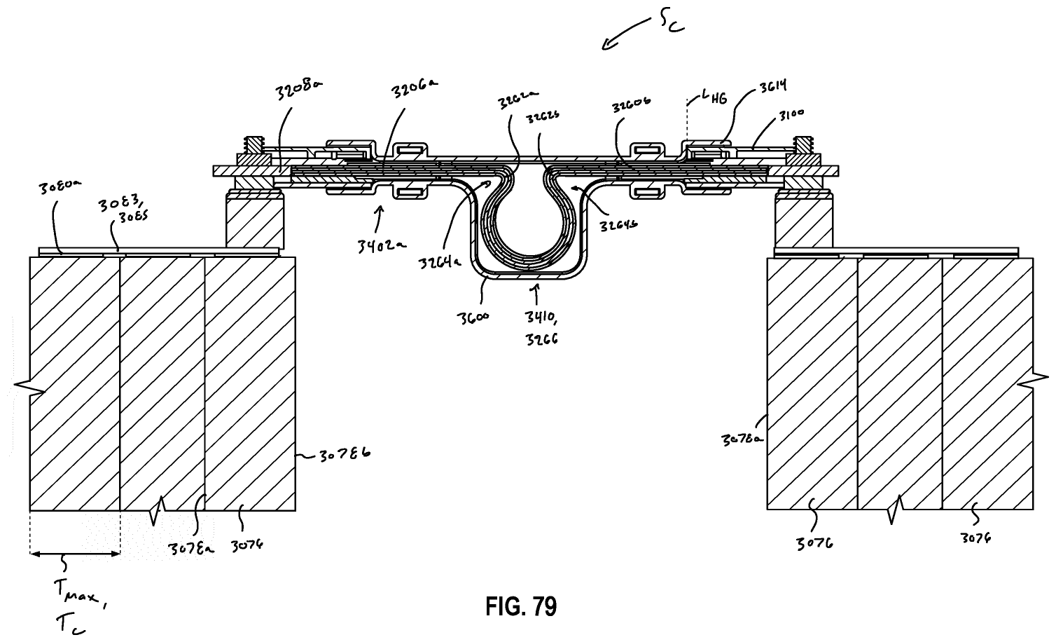

FIGS. 79 and 82 show the elastically deformable battery module connector system 3100 in a compressed state S_{C}, where the busbar 3200 is under a maximum compression Cₘₐₓ force. In this embodiment, the maximum compression Cₘₐₓ force is between 38 and 46 N, and preferably 42 N. This maximum compression Cₘₐₓ force is applied to the system 3100 in the third direction (along the positive (+) X axis) via battery module 3062a and in the first direction (along the negative (−) X axis) via the expansion of the battery modules 3062a, 3062b due to the increased in the level of charge in the battery cells 3076. In particular, charging the battery cells 3076 from a 50% charge state to a 100% charge, causes: (i) the thickness of the cells 3076 to increase from Tₙₒᵣₘₐₗ to Tₘₐₓ, (ii) the size of the battery modules 3062a, 3062b to increase, (iii) the distance DN between the battery modules 3062a, 3062b to decrease from the neutral length (e.g., 110 mm) to a compressed length (e.g., 106 mm), and (iv) each of the rear wall of the male terminal housings 1100 slides towards the interior wall of the busbar housings 3600. It should be understood that movement from the neutral state S_{N} to compressed state S_{C} occurs on a continuum. When the battery modules 3060 are 75% charged, the compression on the connector system 3100 is between the neutral state S_{N} and the compressed state S_{C}. In this state, the overall distance between the connectors 3998 may be reduced by 2 mm in comparison to the distance between the connectors 3998 in the neutral state S_{N}.

In the compressed state S_{C}: (i) the battery cells 3076 are 100% state of battery health (“SoH”), (ii) the battery cells 3076 are charged to 100% charge level, (iii) the rear wall of each of the male terminal housings 1100 is positioned a housing gap L_{HG} (e.g., approximately 0-0.5 mm or adjacent) from the interior wall of the busbar housing 3600, (iv) the length L_{BC} of the busbar 200 is approximately 106-116 mm, preferably 111-113 mm, and most preferably 112 mm (i.e., the length L_{IPC} of the intermediate portion is between 23 mm and 31 mm, and preferably 27 mm), the height H_{BC} of the busbar 200 is 15-30 mm, preferably 20-25 mm (i.e., the height H_{IPC} of the intermediate portion is between 20 mm and 28 mm, and preferably 23 mm), and the width W_{BC} of the busbar 200 is 15-25 mm, preferably 20 mm, (v) the length L_{SC} of the system 3100 is approximately 178 mm, the height of the system 3100 is 37 mm, and the width of the system 3100 is 31 mm, (vi) the distance DN between the battery modules 3062a, 3062b is at a compressed length (e.g., 106 mm), (vii) the length of the neck L_{NC} defined between the external recesses 3264a, 3264b of the busbar 3200 in the compressed state is 21-26 mm, preferably 18 mm, (viii) the length of the gap L_{GC} defined between opposed inner surfaces of the external recesses 3264a, 3264b of the busbar 3200 in the compressed state is 10 and 18 mm, preferably 14 mm, (ix) the ratio between the height H_{BC} of the busbar 3200 and the length L_{BC} of the busbar 3200 is 22.3%, (x) the bottom surface 3215b of the peripheral portions 3402a, 3402b are substantially parallel to the X-Y plane and are substantially perpendicular to X-Z and Y-Z planes, (xi) the bottom surface 3215b of the peripheral portions 3402a, 3402b substantially parallel to both an extent of the upper surface of the conductive plates 3085 of the transfer assembly 3083 and an extent of the positive and negative terminals 3080a, 3080b of the battery cells 3076, (xii) the bottom surface 3215b of the peripheral portions 3402a, 3402b are substantially perpendicular to an extent of the vertical side surfaces 3078a, 3078b of the battery cells 3076, (xiii) intermediate portion 3410 is positioned between a fourth side walls 3068d of a battery module 3062a and a first side wall 3068a of an adjacent battery module 3062b, and (ivx) the length L_{BC} of the busbar 200 and the length L_{SC} of the system 3100 are substantially parallel to both the thickness T_{C} of the battery cell 3076 and X axis.

iii. System in Extended State

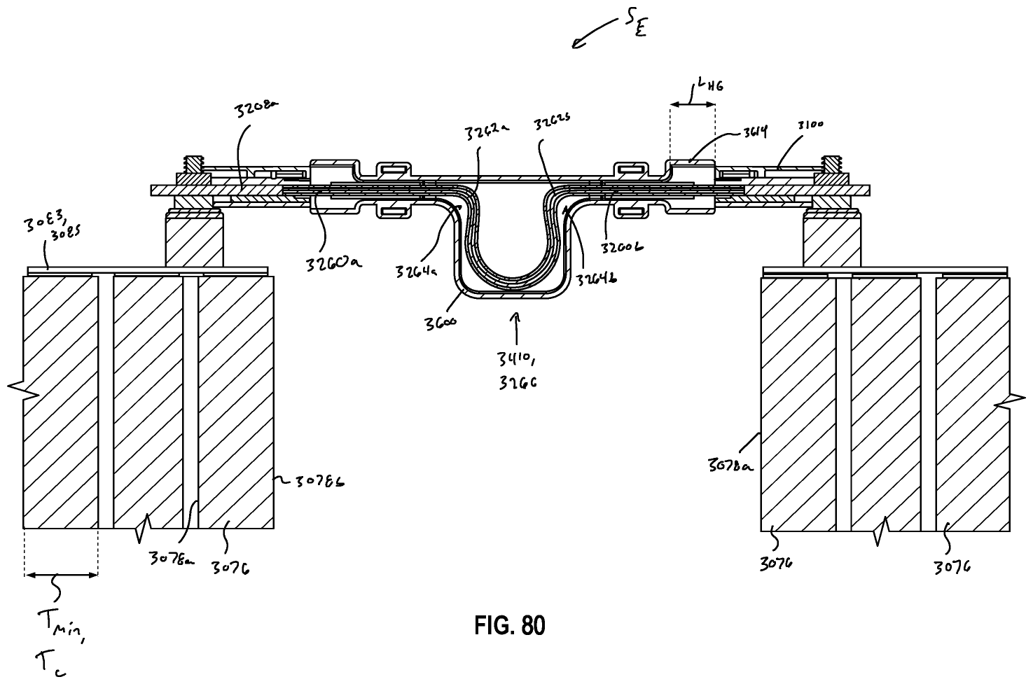

FIGS. 80 and 83 show the elastically deformable battery module connector system 3100 in an extended state S_{E}, where the busbar 3200 is a maximum tension TEₘₐₓ force. In this embodiment, the maximum tension TEₘₐₓ force is between 38 and 46 N, and preferably 42 N. This maximum tension TEₘₐₓ force is applied to the system 3100 in the first direction (along the negative (−) X axis) via battery module 3062a and in the third direction (along the positive (+) X axis) via the contraction of the battery modules 3062a, 3062b due to the decrease in the level of charge in the battery cells 3076. In particular, charging the battery cells 3076 from a 50% charge state to a 0% charge, causes: (i) the thickness of the cells 3076 to decrease from Tₙₒᵣₘₐₗ to Tₘᵢₙ, (ii) the size of the battery modules 3062a, 3062b to decrease, (iii) the distance DN between the battery modules 3062a, 3062b to increase from the neutral length (e.g., 110 mm) to an extended length (e.g., 114 mm), and (iv) the rear wall of each of the male terminal housings 1100 slides further away from the interior wall of the busbar housings 3600. It should be understood that movement from the neutral state S_{N} to the extended state S_{E} occurs on a continuum. When the battery modules 3060 are 25% charged, the tension on the connector system 3100 is between the neutral state S_{N} and the extended state S_{E}. In this state, the overall distance between the connectors 3998 may be increased by 2 mm in comparison to the distance between the connectors 3998 in the neutral state S_{N}.

In the extended state S_{E}: (i) the battery cells 3076 are 100% state of battery health (“SoH”), (ii) the battery cells 3076 are charged to 0% charge level, (iii) the rear wall of each of the male terminal housings 1100 is positioned a housing gap L_{HG} (e.g., approximately 4-6 mm) from the interior wall of the busbar housing 3600, (iv) the length L_{BE} of the busbar 200 is approximately 114-124 mm, preferably 119-121 mm, and most preferably 120 mm (i.e., the length L_{IPE} of the intermediate portion is between 23 mm and 31 mm, and preferably 27 mm), the height H_{BE} of the busbar 200 is 15-30 mm, preferably 20-25 mm (i.e., the height H_{IPE} of the intermediate portion is between 20 mm and 28 mm, and preferably 23 mm), and the width W_{BE} of the busbar 200 is 15-25 mm, preferably 20 mm, (v) the length L_{SE} of the system 3100 is approximately 186 mm, the height of the system 3100 is 37 mm, and the width of the system 3100 is 31 mm, (vi) the distance DN between the battery modules 3062a, 3062b is at an extended length (e.g., 114 mm), (vii) the length of the neck L_{NE} defined between the external recesses 3264a, 3264b of the busbar 3200 in the compressed state is 29-34 mm, preferably 22 mm, (viii) the length of the gap L_{GE} defined between opposed inner surfaces of the external recesses 3264a, 3264b of the busbar 3200 in the compressed state is 18 and 26 mm, preferably 24 mm, (ix) the ratio between the height H_{BE} of the busbar 3200 and the length L_{BE} of the busbar 3200 is 20.8%, (x) the bottom surface 3215b of the peripheral portions 3402a, 3402b are substantially parallel to the X-Y plane and are substantially perpendicular to X-Z and Y-Z planes, (xi) the bottom surface 3215b of the peripheral portions 3402a, 3402b substantially parallel to both the upper surface of the conductive plates 3085 of the transfer assembly 3083 and an extent of the positive and negative terminals 3080a, 3080b of the battery cells 3076, (xii) the bottom surface 3215b of the peripheral portions 3402a, 3402b are substantially perpendicular to an extent of the vertical side surfaces 3078a, 3078b of the battery cells 3076, (xiii) intermediate portion 3410 is positioned between a fourth side walls 3068d of a battery module 3062a and a first side wall 3068a of an adjacent battery module 3062b, and (ivx) the length L_{BE} of the busbar 200 and the length L_{SE} of the system 3100 are substantially parallel to both the thickness T_{CELL} of the battery cell 3076 and X axis.

### IV. Third Embodiment of the Battery Pack

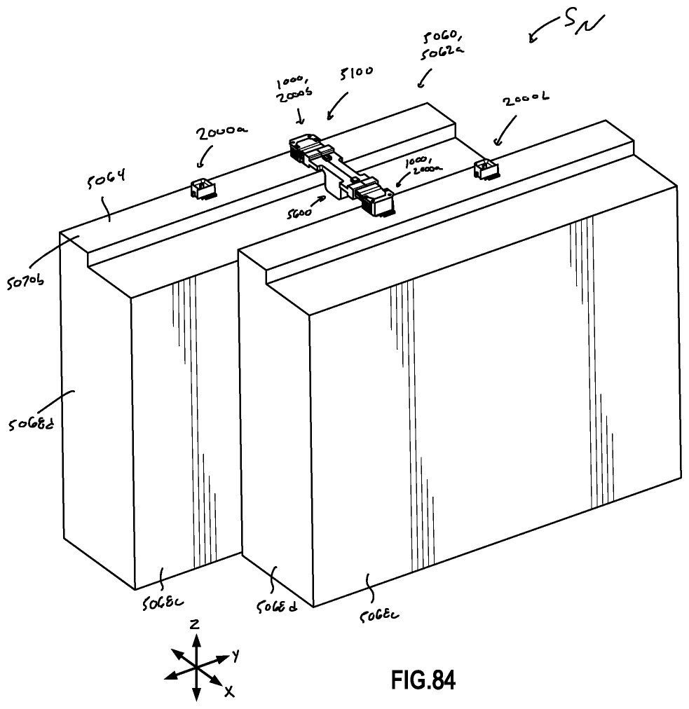

FIGS. 84-88 show a third embodiment of battery modules 5060 and a plurality of second embodiment elastically deformable battery module connector systems 5100. The combination of the battery modules 5060 and systems 5100 are configured to be positioned within the battery pack 90 disclosed above. For sake of brevity, the above disclosure in connection with battery pack 90 will not be repeated below, but it should be understood that across embodiments like numbers represent like structures. For example, the disclosure relating to busbar housing 5600 applies in equal force to busbar housing 5600. It should be understood that any one or more features of the battery modules 5060 and systems 5100 can be used in conjunction with those disclosed regarding the battery modules 5060 and systems 5100, and that any one or more features of the battery modules 5060 and systems 5100 can be used in conjunction with those disclosed regarding the battery modules 5060 and systems 5100.

### A. Battery Module

As shown in FIGS. 84-88, each of the battery modules 5060 (5062a-5062j) generally includes: (i) a battery module housing 5064, (ii) the battery cells 5076, and (iii) the electrical transfer assembly 5081.

i. Battery Module Housing

The battery module housing 5064 includes a plurality of walls 5066 (e.g., an arrangement of four side walls 5068a-5068d, a bottom wall 5070a, and a top wall 5070b) that form a receiver 5072 configured to receive and protect: (i) the battery cells 5076 and (ii) electrical transfer assembly 5081. The top wall 5070b includes at least two battery module openings 5073a, 5073b formed there through, wherein said openings 5073a, 5073b are configured to permit the female connector assembly 2000a, 2000b to be coupled to an extent of the electrical transfer assembly 5081. In particular, current is configured to flow through the battery module openings 5073a, 5073b via the connection between the female connector assembly 2000a, 2000b and the electrical transfer assembly 5081. While female connector assembly 2000a, 2000b are shown in connection with this third embodiment of the battery modules 5060, it should be understood that the use of other connectors (e.g., bolted, clamped, pressure fitted) in contemplated by this disclosure. For example, a bolted connector is disclosed in connection with the second embodiment of the battery modules 5060.

ii. Battery Cells

FIGS. 84-88 show that the battery modules 5060 contain a plurality of pouch battery cells 5076, wherein each battery cell 5076 includes: (i) a housing 5077, (ii) a positive terminal 5080a, and (iii) a negative terminal 5080b. The housing 5077 has horizontal side surfaces 5078a, 5078b and a vertical top and bottom surfaces 5079a, 5079b and is designed to enclose and retain the materials that store the electrical charge, such as lithium or other similar metals. In other words, the battery cells has a thickness T_{C}, a width W_{CELL}, and a length L_{CELL}. The positive and negative terminals 5080a, 5080b couple the materials contained within the housing 5077 to the electrical transfer assembly 5081. The terminals 5080a, 5080b may have a tab-shape configuration; however, other terminal shapes are possible (e.g., boltless connectors, bolted connectors, button, other structures that can be welded, press-fit, or sandwiched by the electrical transfer assembly 5081). The positive and negative terminals 5080a, 5080b are typically formed from different materials to facilitate the charging and discharging of the battery cell 5076. For example, the positive terminal or anode 5080a may be formed from: (i) graphite, (ii) silicon, or (iii) graphene, while the negative terminal or cathode 5080b may be formed from: (i) cobalt, (ii) iron, (iii) nickel-magnesium, (iv) nickel, or (v) sulfur. It should be understood that other materials may be used for said terminals. The battery cells 5076 may have an output voltage that is between 0.2 volts and 10 volts, an amperage hour rating between 10 Ah to 100 Ah, and may have an energy density that is between 20 Wh/kg and 500 Wh/kg. It should be understood that the battery cells 5076 may use a number of different technologies and/or materials, including: (i) NiCd, (ii) NiMH, (iii) NaNiCl, (iv) Li-Polymer, (v) Li-Ion, or (vi) batteries that utilize other materials (e.g., LiO₂, AlO₂, LiS, LTO, LFP, NMC, NCA).

iii. Electrical Transfer Assembly

FIGS. 58-67 show the electrical transfer assembly 5081 positioned within each of the battery module 5060, which couples: (i) the battery cells 5076 to one another, and (iii) the female connector assemblies 2000a, 2000b to the battery cells 5076. As shown in this embodiment, each of the first and second stacks each include approximately 26 battery cells 5076 that are arranged in a horizontal orientation in comparison to the X-Y plane. This horizontal orientation places positions: (i) the positive and negative terminals 5080a, 5080b in a plane that is substantially parallel with the Y-Z plane, (ii) an extent of the horizontal side surfaces 5078a, 5078b of the cells 5076 is substantially parallel with the X-Y plane, and (iii) the thickness T_{C} of the cell 3076 parallel with the Z-axis. As such, conductive plates 5084 can be positioned in the Y-Z plane and be coupled to the positive and negative terminals 5080a, 5080b of the cells 5076. While this embodiment discloses the above configuration of the battery cells 5076 and the associated components electrical transfer assembly 5081, it should be understood that in other embodiments, the electrical transfer assembly 5081 may have a different configuration. For example, said electrical transfer assembly 5081 may be designed to coupling any number of battery cell 5076 to one another (e.g., between 2 and 1000), and any number of battery columns (e.g., between 1 and 40 columns) to one another.

Additionally, at least one female connector assembly 2000 is coupled to the plates 5086. Preferably, the plates 5086 of the electrical transfer assembly 5081 are coupled to two female connector assemblies 2000a, 2000b, wherein: (i) a positive female connector assembly 2000b is (a) configured to provide a positive external connection for the battery module 5060, and (b) designed to receive an extent of a positive male terminal assembly 1430, and (ii) a negative female connector assembly 2000a is (a) configured to provide a negative external connection for the battery module 5060, and (b) designed to receive an extent of a negative male terminal assembly 1430. While the battery module 5060 shown in the figures contains two female connector assemblies 2000a, 2000b, it should be understood the battery module 5060 may have more or less female connector assemblies 2000. For example, the battery module 5060 may only have a single female connector assembly 2000, or the battery module 5060 may include over ten female connector assemblies 2000.

### B. Battery Pack

As discussed above, the third embodiment of the battery module 5090 is designed to fit within the rectangular prism configuration of the battery pack 90, shown in FIGS. 53-54. While FIGS. 53 and 54 show a battery pack 90 that has a configuration and is configured to hold ten battery modules 5060, it should be understood that this disclosure is not limited to this design. Instead, the battery pack 90 may have any known configuration (e.g., any type of a polygonal prism) including a configuration where said pack 90 is built as an extent of the frame or chassis of the vehicle. It should also be understood that in other embodiments, the battery pack 90 may be configured to hold only a single battery module 5060 or over a hundred individual battery modules 5060. The battery cells 5076 contained within the modules 5060 may be connected in parallel, series, or any combination thereof. Additionally, the battery modules 5060 contained within the battery pack 90 may be connected in parallel, series, or any combination thereof.

C. Connection of Battery Modules within the Battery Pack

Once the battery modules 5060 (5062a-5062j) are positioned and secured in the receivers 97a, 97b of the battery pack 90, the battery modules 5060 (5062a-5062j) can be coupled to one another using the disclosed elastically deformable battery module connector systems 5100. In this embodiment, the battery pack 90 includes nine elastically deformable battery module connector systems 5100 (5102a-102i). Each of the elastically deformable battery module connector systems 5100 are coupled to the battery modules 90 using a downwardly directed force (i.e., in the negative (−) Z direction). The disclosed configuration places the bottom surface 5215b of the peripheral portions 5402a, 5402b substantially parallel to each of the following: (i) X-Y plane, (ii) the bottom wall 91 of the battery pack 90, (iii) the top and bottom walls 5070a, 5070b of the battery module housing 5064, and (iv) an extent of the positive and negative terminals 5080a, 5080b of the battery cells 5076. Additionally, said configuration places the bottom surface 5215b of the peripheral portions 5402a, 5402b substantially perpendicular to each of the following: (i) X-Z plane, (ii) Y-Z plane, (iii) the side and end walls 92a, 92b, 94a, 94b of the battery pack 90, (iii) the side walls 5068a-5068d of the battery module housing 5064, (iv) the longitudinal surface 78 of the battery cells 5076. Further, said configuration places causes the intermediate portion 5410 to extend downward from the peripheral portion plane in the −Z direction and be positioned between a fourth side walls 5068d of a battery module 5060 (e.g., 5062a) and a side wall 5068a of an adjacent battery module 5060 (e.g., 5062b). Moreover, the length L_{B} of the busbar 5200 extends in a direction that is substantially parallel with the X axis, while the width of the busbar 5200 extends in a direction that is substantially parallel with the Y axis.

This third embodiment of the elastically deformable battery module connector systems 5100 installed in battery pack 90 utilizing the connector assemblies 1000, 2000. These connector assemblies 1000, 2000 allows for the connections between the battery modules 5060 to be: (i) boltless, (ii) PCT compliant, (iii) 360° compliant, (vi) fast and efficient compared to conventional battery pack connectors, (vii) straightforward, without requiring special tools or machines, (viii) meets USCAR and other industry specifications, (ix) is lighter weight than conventional battery pack connectors, and (x) other benefits that are obvious to one of skill in the art. Once the battery modules 5060 and all other necessary components (e.g., battery management assembly, battery cooling or heating assemblies, etc.) are installed in the battery pack 90, said pack 90 can be installed in an application 10.

### D. Material Condition of the Battery Modules

The second embodiment, movement of lithium ions from the cathode to the anode will cause the thickness of the cell 5076 may increase to Tₘₐₓ when the battery is 100% charged or fully charged, move to Tₙₒᵣₘₐₗ when the battery is at 50% charge or ½ charged, and decrease to Tₘᵢₙ when the battery is at 0% charge or are not charged, wherein Tₘₐₓ>Tₙₒᵣₘₐₗ>Tₘᵢₙ. In light of this above disclosure, a primary factor that contributes to the dynamic movement of the battery modules 5076 within the pack 90 is not associated with the state of charge of said battery modules 5076. This is because the prismatic cells 3076 are arranged in the horizontal orientation in comparison to the X-Y plane, wherein: (i) an extent of the horizontal side surfaces 5078a, 5078b of the cells 5076 is substantially parallel with the X-Y plane, and (iii) the thickness T_{C} of the cell 3076 parallel with the Z-axis. Accordingly, the thickness expansion and contraction, from Tₙₒᵣₘₐₗ to Tₘₐₓ or Tₙₒᵣₘₐₗ to Tₘᵢₙ, of the battery cell 5076 primarily causes expansion and contraction of the battery modules 5076 along the Z axis. There is minimal, if any, expansion and contraction along the X axis or Y axis because the movement of the Li ions is primarily directed vertical and lacks other appreciable components. Because the pack 90 lacks requirements to electrically couple individual modules 5060 to the top surface of the pack 90, expansion of the individual modules 5060 along the Z-axis is not dependent on other modules 5060, the length L_{S} of the system 100 is not positioned in a direction that is parallel to the Z-axis and instead is positioned in a direction that is parallel with the X-axis. This configuration allow said system 100 to couple the individual modules 5060 be coupled to one another. However, as disclosed above, the expansion and contraction of the battery modules 5076 due to movement of lithium ions is primarily along the Z axis and not the X-axis. As such, the system 100 (namely, the intermediate portion 5410) will not elastically deform in order to absorb the expansion and contraction of the battery modules 5076 in said Z axis.

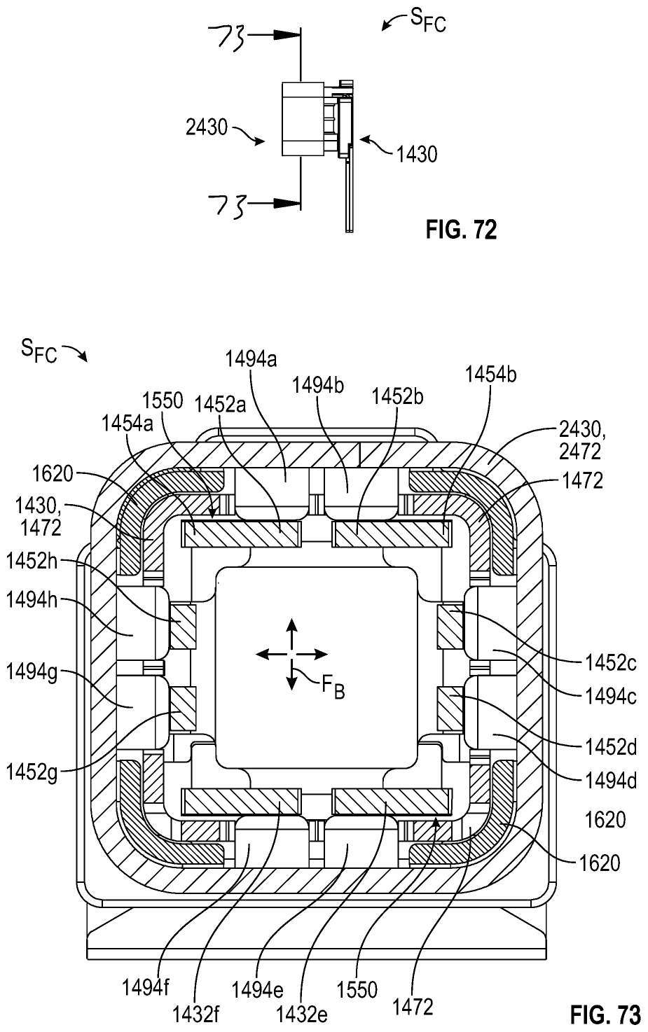

In contrast to how FIGS. 53-83 disclosed that the system 100 is configured to beneficially absorb the forces associated with dynamic movement of the modules 5076, FIGS. 84-88 disclose that the system 100 can also beneficially account for various material conditions that are associated with the battery pack 90.

i. System in Neutral State

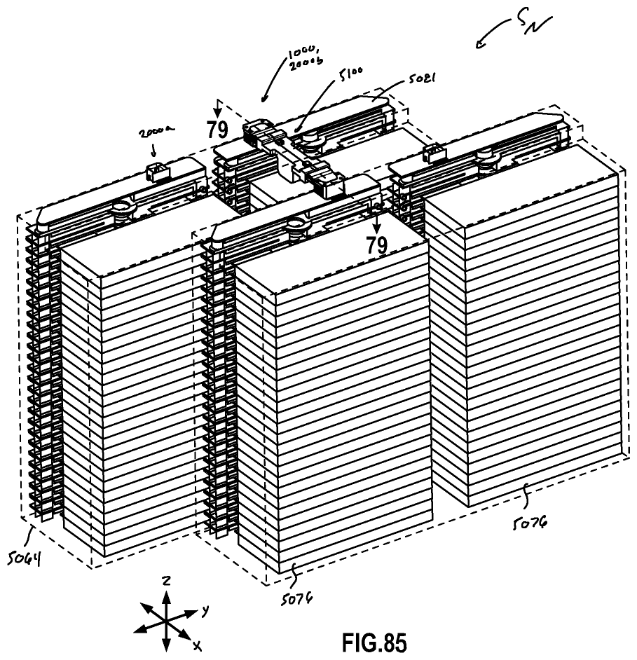

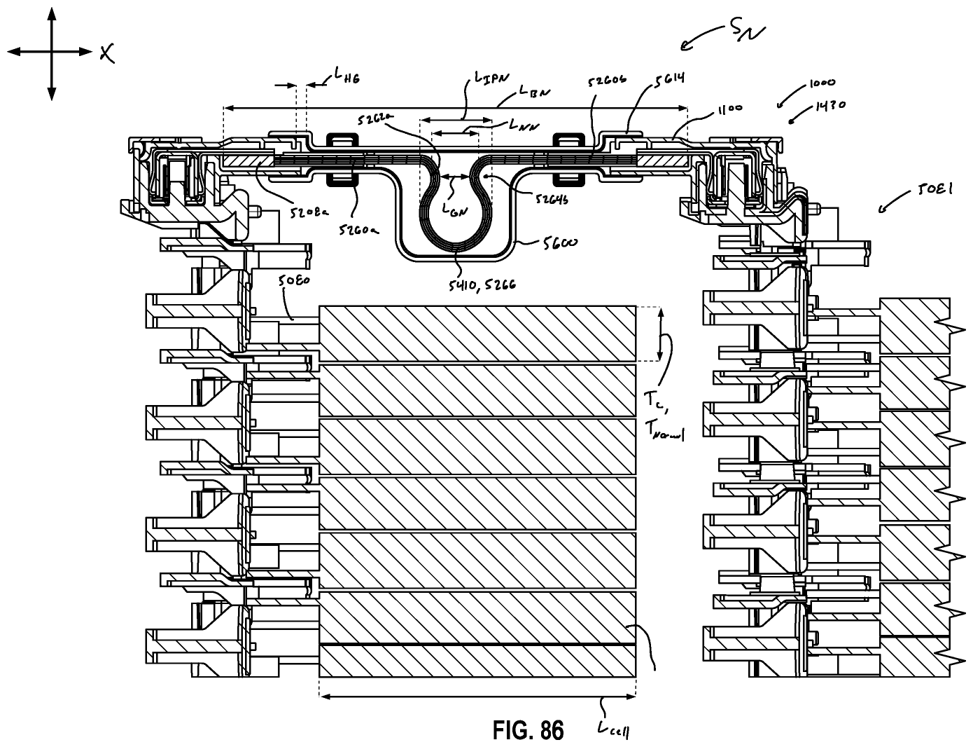

While it is clear from the above disclosure that individual elastically deformable battery module connector system 5100 contained in the battery pack 90 may experience different forces, the general concepts disclosed in connection with the following disclosure in relation to the first system 5102a, the first battery module 5062a, and second battery module 5062b applies to all systems 5100 contained in the battery pack 90. FIGS. 85-86 show the elastically deformable battery module connector system 5100 in a neutral state S_{N}, where neither tension nor compression is applied on the system 5100. In the neutral state S_{N}: (i) the rear wall of each of the male terminal housings 1100 is positioned a housing gap L_{HG} (e.g., approximately 2-4 mm) away from an interior wall of the busbar housing 5600, (ii) the formed length L_{BN} of the busbar 200 is approximately 110-120 mm, preferably 115-117 mm, and most preferably 116 mm (i.e., the length L_{IPN} of the intermediate portion is between 23 mm and 31 mm, and preferably 27 mm), the height H_{BN} of the busbar 200 is 15-30 mm, preferably 20-25 mm (i.e., the height H_{IPN} of the intermediate portion is between 20 mm and 28 mm, and preferably 23 mm), and the width W_{BN} of the busbar 200 is 15-25 mm, preferably 20 mm, (iii) the length L_{SN} of the system 5100 is approximately 150-200 mm, preferably 160-190 mm, and most preferably 182 mm, the height H_{SN} of the system 5100 is 35-40 mm, preferably 37 mm, and the width of the system 5100 is 25-35 mm, preferably 31 mm, (iv) the length of the neck L_{NN} defined between the external recesses 5264a, 5264b of the busbar 5200 in the neutral state is 25-30 mm, preferably 22 mm, (viii) the length of the gap L_{GN} defined between opposed inner surfaces of the external recesses 5264a, 5264b of the busbar 5200 in the neutral state is 14 and 22 mm, preferably 22 mm, (vi) the ratio between the height H_{BN} of the busbar 5200 and the formed length L_{BN} of the busbar 5200 is 20-25%, preferably 21.5%, (vii) the bottom surface 5215b of the peripheral portions 5402a, 5402b are substantially parallel to the X-Y plane and are substantially perpendicular to X-Z and Y-Z planes, (viii) the bottom surface 5215b of the peripheral portions 5402a, 5402b are substantially parallel to the horizontal side surfaces 5078a, 5078b of the battery cells 5076, (ix) intermediate portion 5410 is positioned between a fourth side walls 5068d of a battery module 5062a and a first side wall 5068a of an adjacent battery module 5062b, and (x) the length L_{BN} of the busbar 200 and the length L_{SN} of the system 3100 are substantially perpendicular to the thickness T_{CELL} of the battery cell 5076, but is substantially parallel with the X axis. As such, the system 5100 is installed in the pack 5090 in the nominal material condition, which is between the maximum material condition and minimum material condition.

ii. System in Contracted State

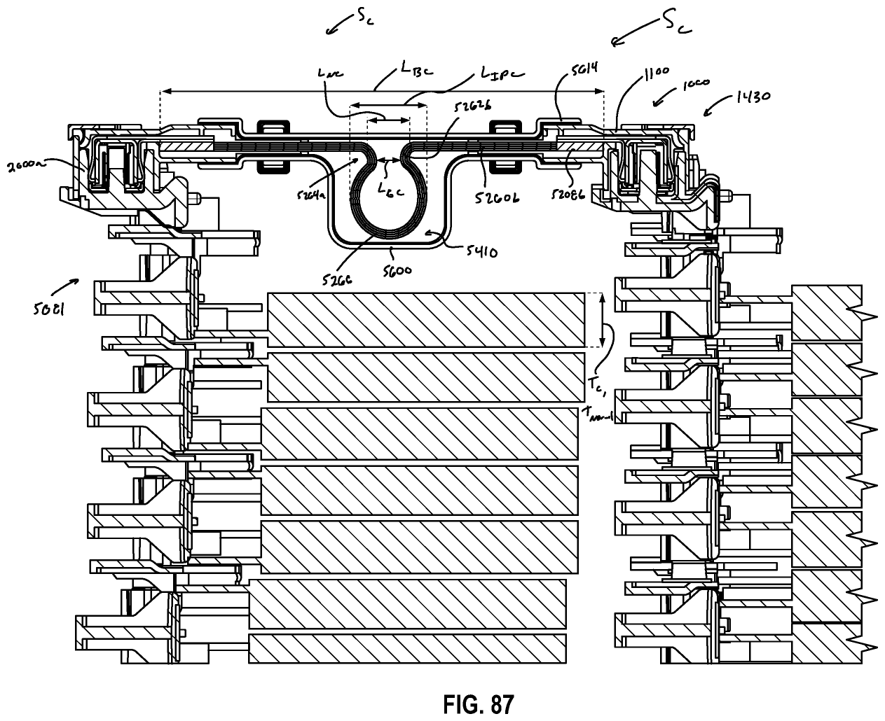

FIG. 87 show the shown components of the battery pack 5090 are in maximum material condition. In particular, this maximum material condition occurs when: (i) the battery modulus 5062a, 5062b are positioned as close as possible to one another, while being within the specified tolerances of the pack 5090, and (ii) the system 5100 has the greatest possible length, while being within the specified tolerances of the pack 5090. To account for this maximum material condition, the elastically deformable battery module connector system 5100 in a compressed state S_{C}, where the busbar 5200 is under a maximum compression Cₘₐₓ force. In this embodiment, the maximum compression Cₘₐₓ force is between 38 and 46 N, and preferably 42 N. This maximum compression Cₘₐₓ force is applied to the system 5100 in the third direction (along the positive (+) X axis) via battery module 5062a and in the first direction (along the negative (−) X axis) via configuration of the battery modulus 5062a, 5062b.

In the compressed state S_{C}: (i) the rear wall of each of the male terminal housings 1100 is positioned a housing gap L_{HG} (e.g., approximately 0-0.05 mm or adjacent) to the interior wall of the busbar housing 5600, (ii) the length L_{BC} of the busbar 200 is approximately 106-116 mm, preferably 111-113 mm, and most preferably 112 mm (i.e., the length L_{IPC} of the intermediate portion is between 23 mm and 31 mm, and preferably 27 mm), the height H_{BC} of the busbar 200 is 15-30 mm, preferably 20-25 mm (i.e., the height H_{IPC} of the intermediate portion is between 20 mm and 28 mm, and preferably 23 mm), and the width W_{BC} of the busbar 200 is 15-25 mm, preferably 20 mm, (iii) the length L_{SC} of the system 5100 is approximately 178 mm, the height of the system 5100 is 37 mm, and the width of the system 5100 is 31 mm, (iv) the length of the neck L_{NC} defined between the external recesses 5264a, 5264b of the busbar 5200 in the compressed state is 21-26 mm, preferably 18 mm, (v) the length of the gap Loc defined between opposed inner surfaces of the external recesses 5264a, 5264b of the busbar 5200 in the compressed state is 10 and 18 mm, preferably 14 mm, (vi) the ratio between the height H_{BC} of the busbar 5200 and the length L_{BC} of the busbar 5200 is 22.3%, (vii) the bottom surface 5215b of the peripheral portions 5402a, 5402b are substantially parallel to the X-Y plane and are substantially perpendicular to X-Z and Y-Z planes, (viii) the bottom surface 5215b of the peripheral portions 5402a, 5402b are substantially parallel to the horizontal side surfaces 5078a, 5078b of the battery cells 5076, (ix) intermediate portion 5410 is positioned between a fourth side walls 5068d of a battery module 5062a and a first side wall 5068a of an adjacent battery module 5062b, and (ix) the length L_{BC} of the busbar 200 and the length L_{SC} of the system 3100 are substantially perpendicular to the thickness T_{C} of the battery cell 5076, but is substantially parallel with the X axis.

iii. System in Extended State

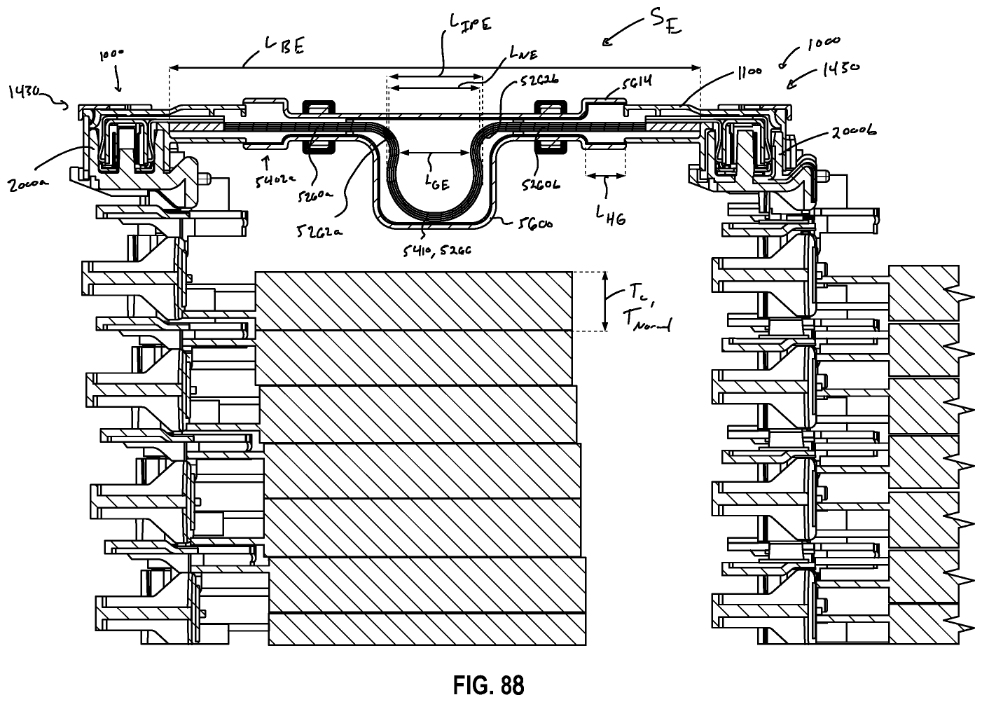

FIG. 88 show the shown components of the battery pack 5090 are in minimum material condition. In particular, this minimum material condition occurs when: (i) the battery modulus 5062a, 5062b are positioned as far away from one another as possible, while being within the specified tolerances of the pack 5090, and (ii) the system 5100 has the smallest possible length, while being within the specified tolerances of the pack 5090. To account for this minimum material condition, the elastically deformable battery module connector system 5100 in an extended state S_{E}, where the busbar 5200 is under a maximum tension TEₘₐₓ force. In this embodiment, the maximum tension TEₘₐₓ force is between 38 and 46 N, and preferably 42 N. This maximum tension TEₘₐₓ force is applied to the system 5100 in the third direction (along the positive (+) X axis) via battery module 5062a and in the first direction (along the negative (−) X axis) via configuration of the battery modulus 5062a, 5062b.

In the extended state S_{E}: (i) the rear wall of each of the male terminal housings 1100 is separated from the interior wall of the busbar housing 5600 by approximately 4-6 mm, (ii) the length L_{BE} of the busbar 200 is approximately 114-124 mm, preferably 119-121 mm, and most preferably 120 mm (i.e., the length L_{IPE} of the intermediate portion is between 23 mm and 31 mm, and preferably 27 mm), the height H_{BE} of the busbar 200 is 15-30 mm, preferably 20-25 mm (i.e., the height H_{IPE} of the intermediate portion is between 20 mm and 28 mm, and preferably 23 mm), and the width W_{BE} of the busbar 200 is 15-25 mm, preferably 20 mm, (iii) the length L_{SE} of the system 5100 is approximately 186 mm, the height H_{SE} of the system 5100 is 37 mm, and the width of the system 5100 is 31 mm, (iv) the length of the neck L_{NE} defined between the external recesses 264a, 264b of the busbar 5200 in the compressed state is 29-34 mm, preferably 22 mm, (v) the length of the gap L_{GE} defined between opposed inner surfaces of the external recesses 5264a, 5264b of the busbar 5200 in the compressed state is 18 and 26 mm, preferably 24 mm, (vi) the ratio between the height H_{BE} of the busbar 5200 and the length L_{BE} of the busbar 5200 is 20.8%, (vii) the bottom surface 5215b of the peripheral portions 5402a, 5402b are substantially parallel to the X-Y plane and are substantially perpendicular to X-Z and Y-Z planes, (viii) the bottom surface 5215b of the peripheral portions 5402a, 5402b are substantially parallel to the horizontal side surfaces 5078a, 5078b of the battery cells 5076, (ix) intermediate portion 5410 is positioned between a fourth side walls 5068d of a battery module 5062a and a first side wall 5068a of an adjacent battery module 5062b, and (x) the length L_{BE} of the busbar 200 and the length L_{SE} of the system 5100 are substantially perpendicular to the thickness T_{C} of the battery cell 5076, but is substantially parallel with the X axis.

### V. Alternative Busbar Configurations

The busbar 200 show in connection with FIGS. 1-83 may be replaced with any of the alternative busbars 200, which include alternative versions of the elastically deformable intermediate portion 412a-412m, that are shown in FIGS. 89-102. Similar to the above discussed busbar 200, each of these alternative designs includes: (i) a first peripheral connecting segment 402a, (ii) a second connecting segment 402b, and (iii) an elastically deformable intermediate segment 412a-412m located between the first and second elastically deformable segments 402a, 402b. In these alternative embodiments, the elastically deformable intermediate segment may include linear portions (see FIGS. 89-90, 92-93), arched portion(s) (see FIGS. 91, 94, 95), parabolic portion(s) (see FIGS. 96-97, 99-101), other shaped portion(s) (see FIG. 98), or multiple discrete shapes that are separated by linear or other shaped segments (see FIG. 102). It should be understood that the disclosed shapes are not limiting and only exemplary in nature. As such, other shapes or combinations of multiple shapes are contemplated by this disclosure.

### VI. Third Embodiment of the System

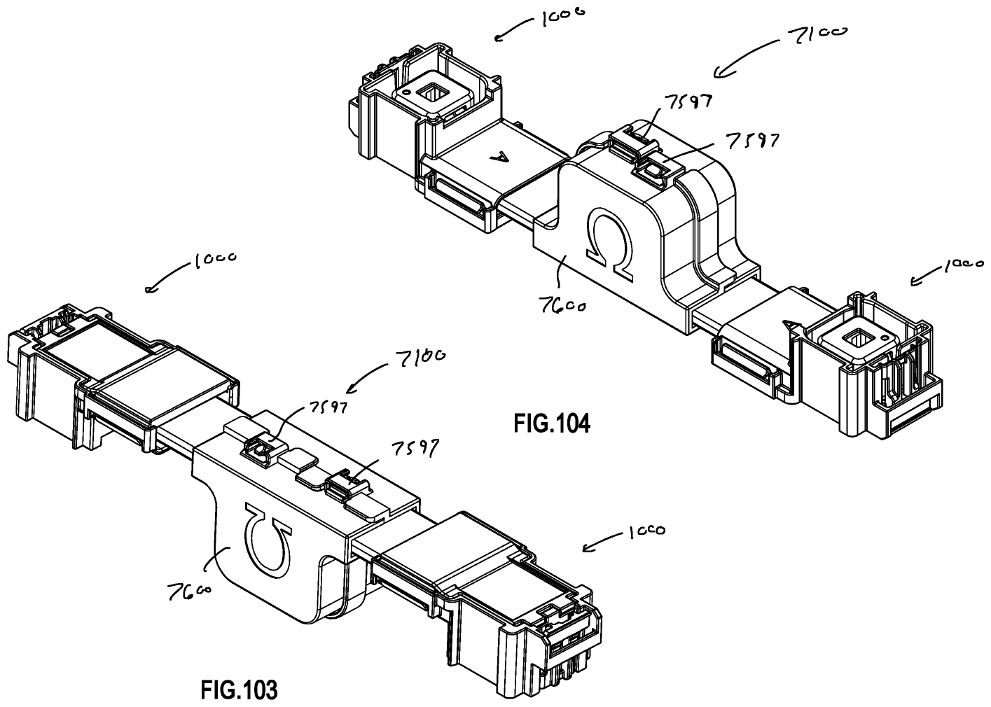

Similar to the system 100 as described above, FIGS. 103-104 show another embodiment of the system 7100. For sake of brevity, the above disclosure in connection with system 100 will not be repeated below, but it should be understood that across embodiments like numbers represent like structures. For example, the disclosure relating to busbar 200 applies in equal force to busbar 7200. Further, it should be understood that the compression and/or extension of the busbar 7200 is similar to, or identical to, those disclosed regarding busbar 200. The only difference in this embodiment of the system 7100 is the fact that the busbar housing 7600: (i) only includes two couplers 7597 on the top extent of the housing 7600 and two couplers 7597 on the bottom extent of the housing 7600, and (ii) first extent 606 and the fifth extent 614 of the housing 600 have been omitted in this embodiment.

### VII. Alternative Male Terminal Configurations

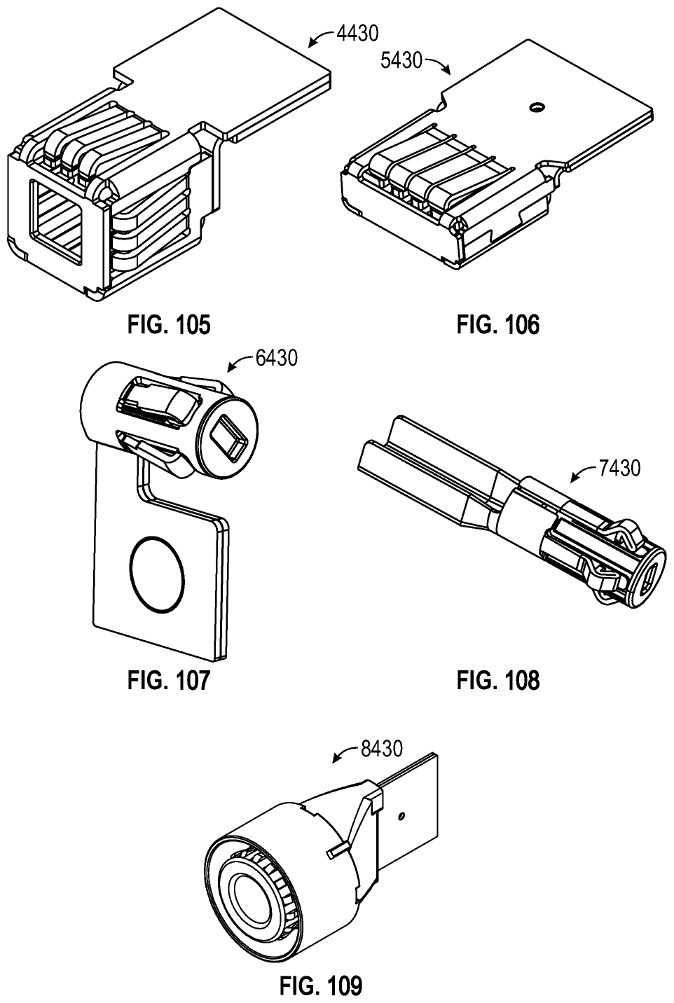

The male terminal assembly 1430 show in connection with FIGS. 1-83 may be replaced with: (i) the openings to accept a threaded connector, (ii) any one of the male terminals 4430 (shown in FIG. 105), 5430 (shown in FIG. 106), 6430 (shown in FIG. 107), 7430 (shown in FIG. 108), or 8430 (shown in FIG. 109), or (iii) any male connector that is disclosed in a patent or patent application that is incorporated herein by reference. Because each of the male terminals 4430, 5430, 6430, 7430, or 8430 have features that are similar to male terminal 1430 and are described in detail in other applications or patents that are incorporated herein by reference, this disclose will not be repeated herein. For example, male terminal 4430 is disclosed in PCT/US2019/036,010, male terminal 5430 is disclosed in PCT/US2019/036,010 and PCT/US2021/043,686, male terminal 6430 is disclosed in PCT/US2021/043,788, male terminal 7430 is disclosed in U.S. Provisional Application 63/286,072, male terminal 8430 is disclosed in PCT/US2021/047,180, each of which are incorporated herein by reference.

The connector systems 100 is T4/V4/D2/M2, wherein the system 100 meets and exceeds: (i) T4 is exposure of the system 100 to 150° C., (ii) V4 is severe vibration, (iii) D2 is 200 k mile durability, and (iv) M2 is less than 45 Newtons of force is required to connect the male terminal assembly 1430 to the female terminal assembly 2430, 3430. In other embodiments, the connector systems 100 may be T4/V4/S3/D2/M2, wherein the system 100 also meets and exceeds the S3 sealed high-pressure spray. In addition to being T4/V4/S3/D2/M2 compliant, 360° compliant, boltless, and PCT compliant, the system 100 may also be scannable and therefor may be PCTS compliant (see PCT/US2020/049870).

The spring member 1440c disclosed herein may be replaced with the spring members shown in PCT/US2019/36010 or U.S. Provisional 63/058,061. Further, it should be understood that alternative configurations for connector assembles 1000 are possible. For example, any number of male terminal assemblies 1430 (e.g., between 2-30, preferably between 2-8, and most preferably between 2-4) may be positioned within a housing 1100 and any number of female terminal assemblies 2430, 3430 (e.g., between 2-30, preferably between 2-8, and most preferably between 2-4) may be positioned within a housing 2100, 3100. Additionally, alternative configurations for connector systems 998 are possible. For example, the female connector assembly 2000a, 2000b may be reconfigured to accept these multiple male terminal assemblies 1430 into a single female terminal assembly 2430.

It should also be understood that the male terminal assemblies may have any number of contact arms 1494 (e.g., between 2-100, preferably between 2-50, and most preferably between 2-8) and any number of spring arms 1452 (e.g., between 2-100, preferably between 2-50, and most preferably between 2-8). As discussed above, the number of contact arms 1494 may not equal the number of spring arms. For example, there may be more contact arms 1494 then spring arms 1452. Alternatively, there may be less contact arms 1494 then spring arms 1452.

### Materials and Disclosure that are Incorporated by Reference

PCT Application Nos. PCT/US2022/037508, PCT/IB2022/057772, PCT/US2021/057959, PCT/US2021/047180, PCT/US2021/043788, PCT/US2021/043686, PCT/US2021/033446, PCT/US2020/050018, PCT/US2020/049870, PCT/US2020/014484, PCT/US2020/013757, PCT/US2019/036127, PCT/US2019/036070, PCT/US2019/036010, and PCT/US2018/019787, U.S. patent application Ser. No. 16/194,891 and U.S. Provisional Applications 62/897,962, 63/051,639, 63/234,320, 63/337,596, and U.S. Design patent application Ser. No. 29/749,813, and 29/749,790, each of which is fully incorporated herein by reference and made a part hereof.

SAE Specifications, including: J1742_201003 entitled, “Connections for High Voltage On-Board Vehicle Electrical Wiring Harnesses—Test Methods and General Performance Requirements,” last revised in March 2010, each of which is fully incorporated herein by reference and made a part hereof.

ASTM Specifications, including: (i) D4935-18, entitled “Standard Test Method for Measuring the Electromagnetic Shielding Effectiveness of Planar Materials,” and (ii) ASTM D257, entitled “Standard Test Methods for DC Resistance or Conductance of Insulating Materials,” each of which are fully incorporated herein by reference and made a part hereof.

American National Standards Institute and/or EOS/ESD Association, Inc Specifications, including: ANSI/ESD STM11.11 Surface Resistance Measurements of Static Dissipative Planar Materials, each of which is fully incorporated herein by reference and made a part hereof.

DIN Specification, including Connectors for electronic equipment—Tests and measurements—Part 5-2: Current-carrying capacity tests; Test 5b: Current-temperature derating (IEC 60512 May 2:2002), each of which are fully incorporated herein by reference and made a part hereof.

USCAR Specifications, including: (i) SAE/USCAR-2, Revision 6, which was last revised in February 2013 and has ISBN: 978-0-7680-7998-2, (ii) SAE/USCAR-12, Revision 5, which was last revised in August 2017 and has ISBN: 978-0-7680-8446-7, (iii) SAE/USCAR-21, Revision 3, which was last revised in December 2014, (iv) SAE/USCAR-25, Revision 3, which was revised on March 2016 and has ISBN: 978-0-7680-8319-4, (v) SAE/USCAR-37, which was revised on August 2008 and has ISBN: 978-0-7680-2098-4, (vi) SAE/USCAR-38, Revision 1, which was revised on May 2016 and has ISBN: 978-0-7680-8350-7, each of which are fully incorporated herein by reference and made a part hereof.

Other standards, including Federal Test Standard 101C and 4046, each of which is fully incorporated herein by reference and made a part hereof. While some implementations have been illustrated and described, numerous modifications come to mind without significantly departing from the spirit of the disclosure; and the scope of protection is only limited by the scope of the accompanying claims. For example, the overall shape of the of the components described above may be changed to: a triangular prism, a pentagonal prism, a hexagonal prism, octagonal prism, sphere, a cone, a tetrahedron, a cuboid, a dodecahedron, an icosahedron, an octahedron, an ellipsoid, or any other similar shape. In another example, all fusions of the busbar 200 may be performed prior to bending said busbar 200. In a further example, the busbar 200 may not be fused and instead the busbar 200 may be 3D printed having the desired configuration or a separate component (e.g., band) may be added to the busbar 200 in order to help prevent the layer for delaminating during the bending process. Moreover, in another embodiment, the female connector assemblies 2000 may be directly coupled to the system 100 and the male connector assemblies 1000 may be coupled to the battery modules 60. Furthermore, the bend height H_{IPN} and the bend length L_{IPN} may not remain substantially constant in all states (compressed, normal, extended); instead, said bend height H_{IPN} and bend length L_{IPN} may change more than 2.5% of their height/length, and possibly between 3% and 25% of their height/length.

Headings and subheadings, if any, are used for convenience only and are not limiting. The word exemplary is used to mean serving as an example or illustration. To the extent that the term includes, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

1. An elastically deformable connector system for use in connecting battery modules in a battery pack, the connector system comprising:
a busbar assembly including:
(i) a busbar having a plurality of individual conductors vertically arranged to provide a first peripheral portion, a second peripheral portion, and an elastically deformable intermediate portion located between the first and second peripheral portions;
(ii) a first male connector assembly coupled to the first peripheral portion of the busbar;
(iii) a second male connector assembly coupled to the second peripheral portion of the busbar;
(iv) a busbar housing that encloses a substantial extent of the busbar; and
wherein after the busbar assembly is electrically connected to a pair of battery modules in the battery pack, the intermediate portion is capable of elastically deforming to compensate for each of compression movement and expansion movement of the pair of battery modules.

2. The elastically deformable connector system of claim 1, wherein: (i) the first peripheral portion is substantially coplanar with the second peripheral portion, and (ii) the majority of the elastically deformable intermediate portion is not coplanar with either of the first or second peripheral portions.

3-4. (canceled)

5. The elastically deformable connector system of claim 2, wherein the elastically deformable intermediate portion includes at least one curvilinear extent.

6. The elastically deformable connector system of claim 5, wherein the interaction between a first portion of the elastically deformable intermediate portion and the first peripheral portion defines a first external recess, wherein the interaction between a second portion of the elastically deformable intermediate portion and the second peripheral portion defines a second external recess, and wherein the first external recess and the second external recess are in an opposed positional relationship.

7. The elastically deformable connector system of claim 6, wherein the first external recess includes an external recess angle defined in a neutral position, wherein the external recess angle is reduced when a compressive activation force is applied on the busbar.

8. The elastically deformable connector system of claim 6, wherein the first external recess includes an external recess angle defined in a neutral position, wherein the external recess angle is increased when an expansion activation force is applied on the busbar.

9. The elastically deformable connector system of claim 1, wherein the elastically deformable intermediate portion has a curvilinear configuration that substantially matches the configuration of the capital letter, Omega, in the Greek alphabet.

10-11. (canceled)

12. The elastically deformable connector system of claim 1, wherein the busbar in the neutral position has an overall formed length after the busbar has been bent and assembled, and wherein the overall length can change with an application of an activation force that is less than 50 Newtons.

13. The elastically deformable connector system of claim 12, wherein the activation force is a compressive force, and wherein the application of said compressive activation force on the busbar can reduce the overall formed length of the busbar by 4 mm.

14. The elastically deformable connector system of claim 12, wherein the activation force is an expansion force, and wherein the application of said expansion activation force on the busbar can increase the overall formed length of the busbar by 4 mm.

15. The elastically deformable connector system of claim 1, wherein the busbar has an overall unbent length, and wherein the busbar in the neutral position has an overall formed length after the busbar has been bent and assembled, and wherein the overall formed length is less than the overall unbent length.

16-17. (canceled)

18. The elastically deformable connector system of claim 1, wherein the elastically deformable busbar includes at least one region that was selectively fused together to form a solid single conductor.

19. (canceled)

20. The elastically deformable connector system of claim 1, wherein the busbar has a bend height, and wherein the bend height remains substantially constant when the intermediate portion of the busbar is elastically deformed to compensate for the compression and expansion of the pair of battery modules.

21-22. (canceled)

23. The elastically deformable connector system of claim 1, wherein the intermediate portion has a bend length, and wherein the bend length remains substantially constant, when the intermediate portion is elastically deformed to compensate for the compression and expansion of the pair of battery modules.

24-32. (canceled)

33. An elastically deformable connector system for use in connecting battery modules in a battery pack, the connector system comprising:
a busbar assembly including:
(i) a busbar having a plurality of individual conductors that have undergone a fusion process to form a solid single conductor in select regions of the busbar, wherein said busbar includes a first peripheral portion, a second peripheral portion, and an elastically deformable intermediate portion located between the first and second peripheral portions;
(ii) a first male connector assembly coupled to the first peripheral portion of the busbar;
(iii) a second male connector assembly coupled to the second peripheral portion of the busbar;
(iv) a busbar housing that encloses a substantial extent of the busbar; and
wherein after the busbar assembly is electrically connected to a pair of battery modules in the battery pack, the intermediate portion is capable of elastically deforming to compensate for each of compression movement and expansion movement of the pair of battery modules.

34. (canceled)

35. The elastically deformable connector system of claim 33, wherein: (i) the first and second peripheral portions substantially reside in a first plane, and (ii) the majority of the elastically deformable intermediate portion resides outside of said first plane.

36-45. (canceled)

46. The elastically deformable connector system of claim 33, wherein the intermediate portion has a bend height that is greater than 10 mm.

47-51. (canceled)

52. The elastically deformable connector system of claim 33, wherein the elastically deformable intermediate portion includes: (i) a pair of fused segments, and (ii) an unfused segment located between the fused segments.

53. The elastically deformable connector system of claim 33, wherein the elastically deformable intermediate portion lacks a region that is fully solidified into a single solid conductor.

54-55. (canceled)

56. An elastically deformable connector system for use in connecting battery modules in a battery pack, the connector system comprising:
a busbar assembly including a busbar with a plurality of individual conductors are vertically arranged to provide:
(i) a first peripheral portion;
(ii) a second peripheral portion;
(iii) an elastically deformable intermediate portion located between the first and second peripheral portions;
(iv) a formed length L_{BN} that extends between opposed end edges of said busbar assembly; and
wherein after the busbar assembly is electrically connected to a pair of battery modules in the battery pack, the intermediate portion is capable of elastically deforming to compensate for each of compression movement and expansion movement of the pair of battery modules.

57-80. (canceled)
